(19) United States
(12) Patent Application Publication
(10) Pub. No.: US 2026/0153162 A1
(43) Pub. Date: Jun. 4, 2026

(54) TECHNIQUES FOR FLUID CONTROL

(71) Applicant: Justin C. Sitz, Bryan, TX (US)

(72) Inventor: Justin C. Sitz, Bryan, TX (US)

(21) Appl. No.: 19/212,648

(22) Filed: May 19, 2025

Related U.S. Application Data
(60) Provisional application No. 63/649,320, filed on May 17, 2024.
(60) Provisional application No. 63/660,133, filed on Jun. 14, 2024.
(60) Provisional application No. 63/738,697, filed on Dec. 24, 2024.
(60) Provisional application No. 63/751,785, filed on Jan. 30, 2025.

(51) Int. Cl. F16K 21/18; A01K 7/02; A01K 7/04; E03D 1/33; G01F 23/72

(52) U.S. Cl. CPC F16K 21/185; G01F 23/72; A01K 7/025; A01K 7/04; E03D 1/33

(57) ABSTRACT

Apparatuses, methods, and systems are disclosed for techniques for fluid control. An apparatus includes a valve configured to control a flow of fluid into a tank, a float operatively connected to the valve and configured to actuate the valve based on fluid level within a container, and an activation lever configured to alter interaction with the float.

### CROSS-REFERENCE TO RELATED APPLICATIONS

This application claims the benefit of U.S. Provisional Patent Application No. 63/649,320 entitled “VALVE” and filed on May 17, 2024, for Justin Sitz, which is incorporated herein by reference. This application claims the benefit of U.S. Provisional Patent Application No. 63/660,133 entitled “VALVE” and filed on Jun. 14, 2024, for Justin Sitz, which is incorporated herein by reference. This application claims the benefit of U.S. Provisional Patent Application No. 63/738,697 entitled “VALVE” and filed on Dec. 24, 2024, for Justin Sitz, which is incorporated herein by reference. This application claims the benefit of U.S. Provisional Patent Application No. 63/751,785 entitled “VALVE” and filed on Jan. 30, 2025, for Justin Sitz, which is incorporated herein by reference.

### FIELD

This invention relates to valves and more particularly relates to valves for controlling fluid flow.

### BACKGROUND

Valves are used to regulate fluid or gas flow in various applications, including industrial tanks, livestock water tanks, toilet tanks, and other types of reservoirs. These valves are capable of controlling different types of fluids and gases. However, in certain failure conditions—such as leaks within a tank or the inability of a valve, flap, or closure mechanism to seal properly—valves may remain open, resulting in unwanted fluid loss.

### BRIEF SUMMARY

Apparatuses, methods, and systems are disclosed for techniques for fluid control. An apparatus, in one embodiment, includes a valve configured to control a flow of fluid into a tank, a float operatively connected to the valve and configured to actuate the valve based on fluid level within a container, and an activation lever configured to alter interaction with the float.

An apparatus, in one embodiment, includes a removable sensor housing configured to be mounted within or adjacent to a fluid-containing vessel, a float disposed within a chamber in the sensor housing, the float comprising a magnet, a magnetic switch positioned within the housing and operatively coupled to a processor, wherein movement of the float in response to fluid level changes causes the float magnet to interact with the magnetic switch, thereby activating or controlling one or more functions of the processor.

A system, in one embodiment, includes an apparatus that includes a valve configured to control a flow of fluid into a tank, a float operatively connected to the valve and configured to actuate the valve based on fluid level within a container, and an activation lever configured to alter interaction with the float. The system, in one embodiment, includes an apparatus that includes a removable sensor housing configured to be mounted within or adjacent to a fluid-containing vessel, a float disposed within a chamber in the sensor housing, the float comprising a magnet, a magnetic switch positioned within the housing and operatively coupled to a processor, wherein movement of the float in response to fluid level changes causes the float magnet to interact with the magnetic switch, thereby activating or controlling one or more functions of the processor.

### BRIEF DESCRIPTION OF THE DRAWINGS

In order that the advantages of the embodiments of the subject disclosure will be readily understood, a more particular description of the embodiments will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIGS. 1A-1B is a top view of a device disclosed herein;

FIGS. 2A-2B depict embodiments of sectional views of the device;

FIGS. 3A-3L depict an embodiment of a removable sensor housing;

FIGS. 4A-4E depict an embodiment the sensor housing;

FIG. 5 depicts a side sectional view of the device;

FIGS. 6A-6B illustrate sectional views of a rear portion of the device;

FIG. 6C depicts one embodiment of the device with included additives;

FIGS. 7A-7I illustrate a simplified version of the fluid control device;

FIGS. 8A-8G show a flush cycle sequence;

FIGS. 9A-9L shows a shut-off cycle sequence;

FIG. 10 depicts one embodiment of a device with adjustable set screws;

FIGS. 11A-11C illustrate an embodiment of the device that includes additional electronic features;

FIGS. 12A-12B illustrates a device with an adjustment knob;

FIG. 13 illustrates an exploded view of the valve assembly used in the disclosed device;

FIG. 14 depicts detailed cross-sectional views of the device from the left and right sides, providing an in-depth illustration of the internal mechanisms and fluid pathways that govern its operation;

FIG. 15 illustrates an embodiment of the device with a sensor float;

FIG. 16 illustrates an alternative configuration for permitting the ingress and egress of fluid within the container of the device;

FIG. 17 illustrates an alternative configuration of the device in which no floating ball or similar mechanism is used to block fluid ingress as the external fluid level rises;

FIGS. 18A-18K illustrate an alternative configuration of the device that features a base-mounted port that permits direct communication between the fluid contained within the device and the external fluid environment;

FIG. 19 illustrates an alternative embodiment of the device that incorporates a cord-actuated mechanism that interfaces with the existing flushing mechanism of a toilet tank;

FIGS. 20A-20B illustrate an alternative embodiment of the device that includes an independent float mechanism positioned at the base of the unit, configured to open and close a port that allows fluid communication between the internal container and the fluid surrounding it;

FIGS. 21A-21G illustrate an alternative configuration of the device that incorporates several features that collectively improve control, sensitivity, and adjustability;

FIGS. 22A-22G illustrates a standard operating sequence for using the device;

FIGS. 23A-D illustrate the operation sequence of the device if the flap doesn't close or there is a mass evacuation of fluid;

FIGS. 24A-D illustrate the operation sequence of the device in the event of a slow leak;

FIGS. 25A-25L illustrate an embodiment of the device where the float and container are configured to cooperatively form a bell siphon structure that facilitates the rapid evacuation of fluid once a predetermined level is reached;

FIGS. 26A-26G illustrates an alternative embodiment where the device incorporates an internal reservoir positioned within the container to facilitate controlled redistribution of fluid into the float chamber;

FIGS. 27A-27F depict a fluid control system that includes a container fitted with a one-way flow-regulating flap valve positioned near or at the fluid intake;

FIGS. 28A-28C illustrates sequence drawings showing the operational cycle of an embodiment utilizing non-floating balls positioned beneath large siphon tubes within the fluid control device;

FIGS. 29A-29E illustrate the operational behavior of the device when buoyant (floating) balls are employed instead of weighted or non-floating variants; and

FIG. 30 illustrates an embodiment of the device with a rotary damper.

### DETAILED DESCRIPTION

Valves are used to regulate fluid or gas flow in various applications, including industrial tanks, livestock water tanks, toilet tanks, and other types of reservoirs. These valves are capable of controlling different types of fluids and gases. However, in certain failure conditions—such as leaks within a tank or the inability of a valve, flap, or closure mechanism to seal properly—valves may remain open, resulting in unwanted fluid loss. In some cases, fluid loss may occur due to failure of a component not directly associated with the valve itself. Various additional failure scenarios may cause the valve to remain open, allowing unintended flow. Furthermore, existing valves typically do not provide alerts to users when such flow loss occurs, resulting in fluid waste and delayed maintenance response.

The subject matter described herein addresses these deficiencies by providing a flow control device that automatically ceases fluid flow under adjustable, predefined conditions and alerts the user when fluid loss is detected. The device is equipped to generate audible, visual, vibrating, or wireless alarms. These alerts may include signals transmitted to and from external receivers or other notification systems. The device is further capable of receiving wireless or wired transmissions that can trigger specific actions, including but not limited to initiating, terminating, or regulating fluid flow, or executing other electronic control functions.

In certain embodiments, the device includes flow rate monitoring and onboard power generation capabilities, such as an integrated generator. The device may be powered through batteries, solar panels, wind energy, direct electrical connection, or other means. The device can also power an electromagnet used to control the state of the valve. In some configurations, the valve assembly may be integrated into the lid of a tank or container, enabling external visual indicators and facilitating user access for resetting the device.

The device is designed to accommodate accessibility needs by providing alerts through multiple sensory modalities—visual, auditory, and tactile—thus supporting users who are visually or hearing impaired. In the event of detected fluid loss, the device will automatically shut off flow, independent of external electrical power. Users may manually reset the device after addressing the cause of fluid loss. If desired, users may override the automatic shutoff function to allow continued operation despite ongoing fluid loss. Additionally, the system permits user-defined fluid loss thresholds, allowing customization according to the acceptable loss level for specific applications.

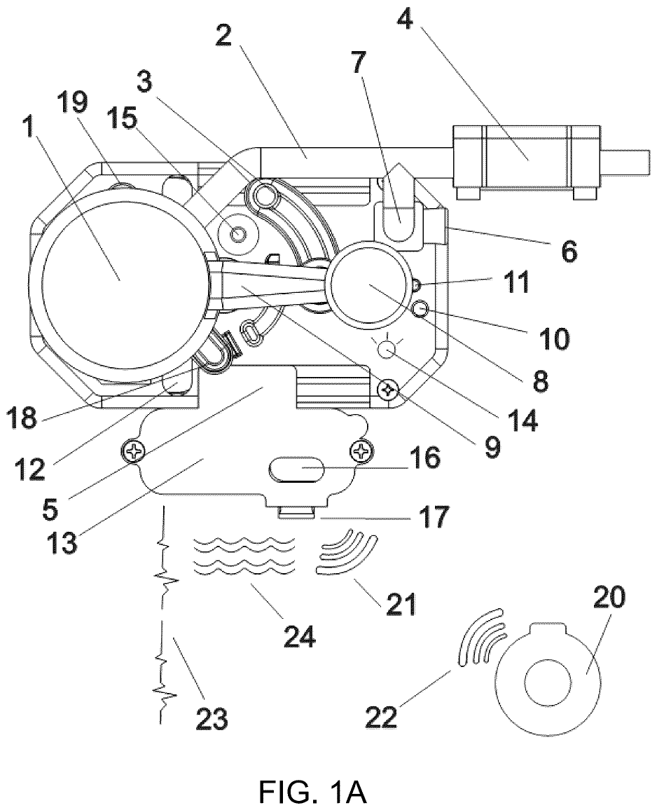

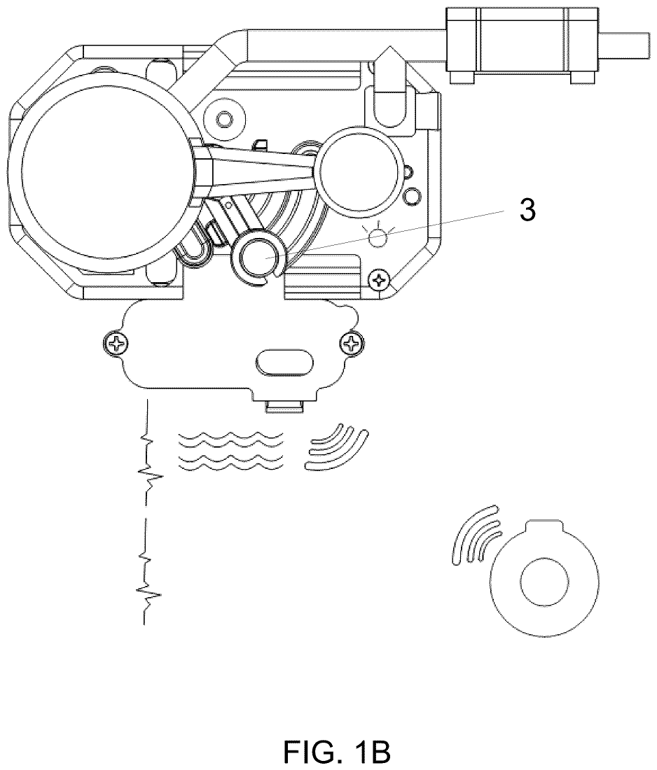

FIG. 1A is a top view of a device disclosed herein with the activation lever in the on position. In this position the device will shut off fluid flow through the valve if there is a leak present in a tank it is submerged in, e.g., a toilet tank.

In one embodiment, the device includes a valve 1 that is activated/actuated to turn fluid flow through the device on and off. The valve 1 may be coupled with a float 75 that controls actuation of the valve based on a position of the float 75, e.g., based on a fluid level.

In one embodiment, the device includes an output line 2 that is configured to carry fluid from the valve 1 when the valve 1 is open. For example, in the case of a toilet, fluid may flow through the valve 1 and the output line 2 and into a toilet bowl.

In one embodiment, the device includes an activation lever 3. Pivoting the activation lever 3 adjusts the magnetic influence exerted on the float 75, enabling the attraction, repulsion, or complete disengagement of the magnetic force acting upon it. The activation lever 3 also actuates the release of a weight (e.g., weight 33, described below) into the float 75, which is normally biased in an upward position by a magnet integrated within the activation lever assembly. When the activation lever 3 is returned to the “on” position, the weight reattaches to the lid, thereby relieving pressure from the float 75.

In one embodiment, the device includes an electronic flow meter 4. The electronic flow meter 4, in one embodiment, is configured to monitor the flow of fluid through the output line 2 and automatically increase or decrease the flow, flow rate, flow volume, or the like. The electronic flow meter 4, in one embodiment, communicates with a processor, or other computing device, e.g., via a wired or wireless network connection (e.g., Bluetooth®, cellular, or other short range wireless network connection) to identify various situations such as excessive run times, and slows down the flow of fluid when required.

In one embodiment, the device includes an attachment clip 5 for a removable sensor and/or battery pack. In such an embodiment, this allows for the battery pack to be removed for service and/or changing out batteries without having to remove the device or open the device to access batteries. In one embodiment, the attachment clip 5 can be assisted by magnetic force to lock into place, or other external lock features (e.g., snap or friction fit).

In one embodiment, the device includes an adjustment knob 6 to control the drip of fluid into the device, e.g., to increase or decrease the volume or rate at which fluid enters the device. Actuating the adjustment knob 6 to increase the rate or speed of the drip may cause the float 75 to be positioned in an upward position quicker (e.g., based on the amount of fluid in the container), and actuating the adjustment knob 6 to decrease the rate or speed of the drip may cause the float 75 to return to the upward position slower.

In one embodiment, a dedicated line 7 supplies a drip feed of fluid to the device once the valve is activated. This line 7 receives fluid via its connection to the output line 2, ensuring that fluid delivery begins immediately upon valve activation and maintains a controlled flow to the device as needed.

In one embodiment, the device features a threaded adjustment knob 8 that connects the float 75 to the lever 9, which actuates the valve. The adjustment knob 8 allows users to control the water level to which the device fills and fine-tune the device's sensitivity. By rotating the adjustment knob 8, the user can vary the float's travel range and influence the valve's position accordingly. When the device is shut down or not activated, e.g., no fluid is moving through the valve 1, and the float 75 is in the upward position, pressing down on the adjustment knob 8 resets the device. In such an embodiment, this action displaces fluid within the container, raising the fluid above the summit height of the internal siphon and triggering siphon action. The resulting expulsion of fluid returns the float 75 to the downward “on” position. The device then remains in this position until the surrounding fluid—such as that in a toilet tank—refills and enters the device through the ports located on the lid, resetting the internal fluid level.

In one embodiment, the device includes a valve lever 9 that serves as the mechanical linkage that initiates the valve's open or closed state, driven by the movement of the connected float 75 and adjustment components.

In one embodiment, the device includes an indicator 10 that is attached to an internal secondary float, which remains in the elevated position when the device shuts off due to a slow leak. This indicator 10, in one embodiment, consists of a small rod extending through the lid, attached to a float 75 housed within the container. In the event of a slow leak, fluid within the float reservoir gradually drains, reducing the float's weight and preventing it from overcoming the magnetic force of one or more magnets (e.g., magnet 31 described below) in the activated lever position. In one embodiment, the indicator float 27 is held magnetically between magnets e.g., magnets 11 and 28, and can be displaced downward by the main float 75. If the main float 75 does not fall, the indicator float 27 remains elevated, signaling that the shutoff was due to a minor leak. During normal operation, the main float 75 falls downward and dislodges the indicator float 27, causing it to settle at the bottom. If the device operates for an extended period and the main float 75 returns to the top, the indicator float 27 will stay at the bottom, indicating a major fluid loss event such as a toilet flapper that is broken or stuck in an open position. Once reset and fluid rises above the device lid, the container refills, restoring buoyancy to the indicator float 27 and lifting it to the “ready” position.

In one embodiment, the device includes an indicator float 27 lid magnet 11, which is a magnet integrated into the lid that interacts with the magnet embedded within the indicator float 27 to facilitate magnetic communication and positioning. At the top of the float assembly, in one embodiment, a spring 11.2 is installed to slow the upward motion of the float 75, thereby delaying valve shutoff. In an alternative implementation, this damping function may be achieved using a rotary damper or compressible material to modulate float response time.

The lid of the device, in one embodiment, includes fluid ports 12 that allow water to enter the internal chamber. These ports 12 may be placed at varying heights to permit staggered filling of internal compartments as fluid rises in the surrounding container.

In one embodiment, the device includes a removable sensor housing 13 that contains the device's electronics, including the battery compartment, processor, memory, network interface, and/or various sensors. In one embodiment, the electronic components, e.g., the processor, can communicate with the valve 1 to transmit and receive signals for various situations such as emergency shutdown signals or other operational data and transmit this data to the end user. Communication may occur via Wi-Fi, Bluetooth®, cellular networks, or any suitable long-or short-range wireless communication method, wired network, and/or the like, and alerts can be received on user devices such as smartphones or computers. The sensor housing 13 may be mounted independently of the valve 1 to monitor fluid levels in containers without integrated valves or installed within the same container but not directly attached to the valve 1. Additionally, this sensor housing 13 can supply or regulate power to electrical components when connected to an external power source, such as a standard 110V power source.

In one embodiment, the device includes a light 14, such as a light emitting diode (LED), that is mounted on the device to visually indicate different states of the device such as normal operations, emergency shutdowns, or the like, and to convey diagnostic information through coded blinking sequences.

The device, in one embodiment, includes an electromagnet 15 that is capable of remotely manipulating the float's position. The electromagnet 15 may attract the float 75 upward to shut off the valve 1 or repel it downward to activate the valve 1. The processor, equipped to send and receive transmissions, can remotely engage the electromagnet in response to user input. In one embodiment, a rheostat allows the user to vary the magnet's strength, offering fine control over the float's behavior.

In one embodiment, the device includes a fluid port 16 in the removable sensor housing 13 that permits fluid ingress and egress, ensuring that the internal chamber fills each time fluid reaches the top of the assembly. Fluid may also enter and exit the housing via a wick 57. A removable filter 16 may be included to prevent debris from entering the device, enhancing operational reliability.

In one embodiment, the device includes a manual switch 17, button, or the like that can be actuated to activate or deactivate the electronic components and/or to initiate system diagnostics. The switch 17 incorporates or is coupled with a magnet that communicates with the internal float's magnet 53. Movement of the float within this magnetic field triggers a switch on the processor board, thereby powering the system.

In one embodiment, the device includes a manual lever 18 that is configured to open or close a port at the bottom of the container. By rotating this lever 18, the user can establish or block fluid communication between the internal container and the surrounding reservoir. The lever 18 is linked to a shaft that can seal the port using a movable closure. This port is typically opened when the device is deactivated, especially when the main float's magnet is not positioned directly above the float's internal magnet, allowing for drainage or fluid equalization as needed. In some embodiments lever 18 can be incorporated into the activation lever 3 causing the port in the base of the container to open when the activation lever 3 is pivoted.

In one embodiment, the device includes a plug 19 that controls the operation of the internal siphon system. By sealing the port 19 located at the top of the siphon, the continuous introduction of air into the siphon's summit is prevented, allowing the siphon to activate and maintain flow. Conversely, removing the plug 19 allows a steady stream of air to enter the summit, rendering the siphon inoperable. Even with the port 19 open, in some embodiments, fluid will continue to drain through the siphon until the fluid level equalizes with the base of the siphon's main summit. However, when the port 19 is closed, siphoning will continue until the fluid level reaches the bottom of the intake leg. This feature enables the user to precisely control internal fluid volumes and adjust the amount of fluid removed during a flush cycle, enhancing operational flexibility and efficiency.

In one embodiment, the device includes a remote leak detection sensor 20, or a plurality or series of sensors 20, that is incorporated to enhance the system's responsiveness to external leaks. This sensor 20 can transmit a signal to the device's processor. Upon receiving the signal, the processor can activate electronic components—such as the electromagnet 15—to stop fluid flow. For example, in the event of a toilet overflow, the sensor can detect the leak and send an alert to the processor. The processor can then engage, activate, or otherwise trigger the electromagnet 15 to cause the float to lift, thereby shutting off the valve 1 and preventing further flooding. This capability allows the device to operate proactively, minimizing water damage and improving safety.

In one embodiment, the device also supports outbound transmission 21 of signals from the device. These transmissions 21 can occur via any available method—such as a wireless network, Bluetooth®, near field communication (NFC), or Wi-Fi—and can be received by multiple external devices, including smartphones, tablets, or centralized monitoring systems. This allows users or automated systems to monitor and respond to real-time conditions remotely.

In one embodiment, in addition to receiving external signals, the device is equipped to accept inbound transmissions 22 at a network interface, e.g., a Bluetooth®, NFC, or Wi-Fi interface. These received signals may trigger specific device actions, such as activating or deactivating components, initiating alerts, or adjusting valve operations, depending on system configuration and user preferences.

To provide clear alerts to the user, the device can emit sounds 23 that indicate various states of the device such as normal operation, an emergency shutdown, or operational fault. These auditory signals serve as warnings that attention is required or that the valve needs to be reset before normal operation can resume.

The device is also capable of generating vibration alerts 24. These tactile signals can be useful for users with hearing impairments and further support multi-modal feedback to ensure all users are adequately notified of system status changes, malfunctions, or shutdown events.

FIG. 1B is a top view of a device disclosed herein with the activation lever 3 in the off position. In this position the device will allow fluid flow through the valve 1 even if there is a leak present in a tank it is submerged in, e.g., a toilet tank or other industrial fluid tank.

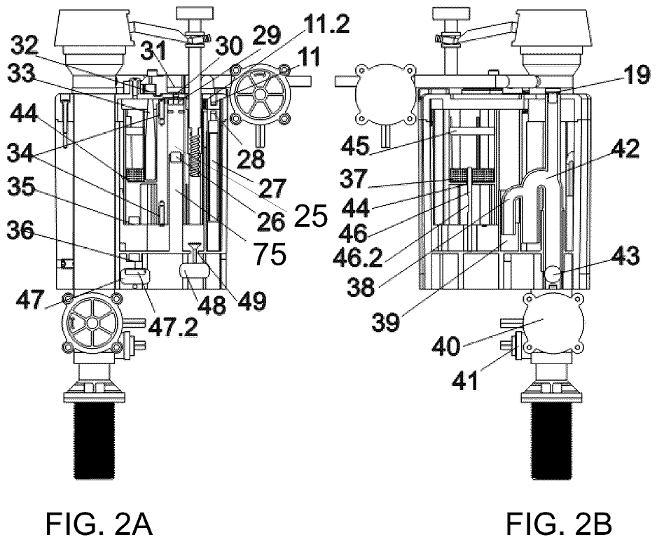

FIGS. 2A and 2B depict embodiments of sectional views of the valve device. In one embodiment, the device includes an internal shaft 25 that serves as a guide for the float's vertical movement within the container. In some embodiments, however, the float is capable of functioning without reliance on this shaft 25. Embedded within the shaft 25 is a magnet 26 that interacts with the float's magnet, affecting the float's rate of ascent and descent by varying magnetic resistance, strength, or attraction. An indicator float 27, also equipped with its own magnet 28, works in conjunction with the magnet 26 housed in the shaft 25. This shaft magnet 26 may be movable, allowing dynamic adjustment of magnetic attraction depending on its position relative to the top magnet, although in some variations it can be fixed. In one embodiment, the indicator float 27 is housed separately from the main float and the indicator's magnets 28, 11 work independently from other magnets such that the only influence given to the indicator is by the main float when it drops, physically contacting the indicator float 27 and breaking its magnetic connection between the magnets 28, 11.

In one embodiment, the device includes a magnet 30 embedded in the lid that provides a minimal magnetic influence on the float when the top lever 3 is pivoted to the “off” position. When the lever 3 is pivoted to the “on” position, a separate lever magnet 31 aligns with and attracts the float magnet, effectively engaging the valve mechanism to activate the valve 1. The lever 3 also contains a secondary magnet 32 that retains a deployable weight in the “on” position. When the lever 3 is moved to the “off” position, this secondary magnet 32 disengages, allowing the weight 33 to drop into the float, increasing its density and affecting its buoyancy characteristics. Adjustment screws 34 may be provided to fine-tune the float's travel range and response behavior.

At the bottom of the container, in one embodiment, a float magnet 35 interacts with a corresponding bottom container magnet 36 to create a delay in the float's return to the top position. This interaction helps in timing fluid flow control events. A spongy or mesh material 37 may be integrated near a small float port and serves both as a filter and a damping element, slowing the fluid transfer between the float and the main container. This controlled transfer of fluid is critical to the timing mechanism, as the float gradually loses weight and regains buoyancy through a compounding release and redistribution of fluid.

The device, in one embodiment, incorporates a siphon system with a secondary intake 38 attached, which is designed to terminate siphon action at a predetermined point by introducing air into the system. Siphons are known for their difficulty in stopping once activated, so this method ensures that once the fluid level drops below a set threshold, air enters through a dedicated siphon cavity 39—effectively a cylindrical void at the container floor—halting the siphon process. This ensures that sufficient fluid remains in the reservoir for the float to return to the upward position.

A hydro generator 40, in one embodiment, may be integrated into the device to produce power with each activation of the valve 1. This generator 40 serves to charge onboard batteries and power electronic components, effectively converting fluid motion into usable electrical energy as a byproduct. A fluid pressure sensor 41 may also be present to detect drops in system pressure, which could indicate leaks, and communicate this data to the device's processor for automated response.

In one embodiment, the siphon system 42 includes a movable ball 43 that may or may not be buoyant. This ball 43, in one embodiment, acts as a flow restrictor, initially allowing fluid to pass through the siphon exit. As fluid pressure increases from rising external water levels, the ball 43 becomes biased toward sealing the exit port, thereby limiting fluid entry into the container. This feature allows minimal fluid flow to prime the siphon 42 while preventing excess fluid from prematurely lifting the float before the surrounding tank reaches operational levels.

In one embodiment, ports 44 are provided in the float reservoir walls or floor to allow fluid to exit at controlled rates. A foam float layer 45 is incorporated to modulate the float's buoyancy depending on fluid levels. This layer increases buoyancy when submerged but provides no lifting force when the float is below the fluid line.

The float port shaft 46, in one embodiment, guides the vertical movement of the float port, serving not only as structural support but also as a regulator for fluid egress. The shaft's varying diameter 46.2 creates zones of different fluid flow resistance, allowing more or less fluid to pass depending on the float's vertical position, thereby controlling timing and responsiveness.

An additional float 47 located beneath the container influences the magnetic hold on the primary float during low-fluid conditions. As the external fluid level rises, this auxiliary float lifts and, via an embedded magnet 47.2, shortens the distance to the bottom container magnet, increasing its magnetic force. This added force delays the primary float's return to the upper position, offering finer control over system reset behavior. However, the inclusion of this auxiliary float and magnet is optional and not required for all configurations of the device.

In one embodiment, a separate float 48 operates a bottom seal 49 that opens or closes based on the external fluid level. This float adjusts the seal engagement, either allowing or restricting fluid entry and exit through the base of the container, further enhancing the system's precision control over internal fluid dynamics.

In one embodiment, the device is coupled to or integrated with a mechanism that allows the height, position, or the like of the device to be adjusted, e.g., to account for different sized tanks or other applications.

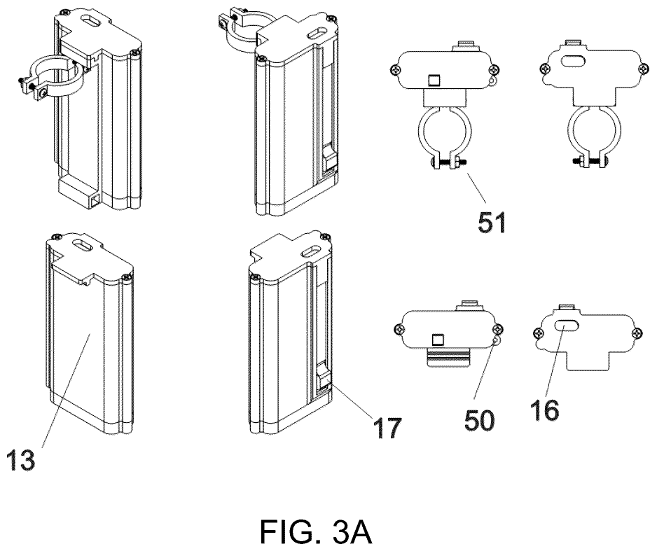

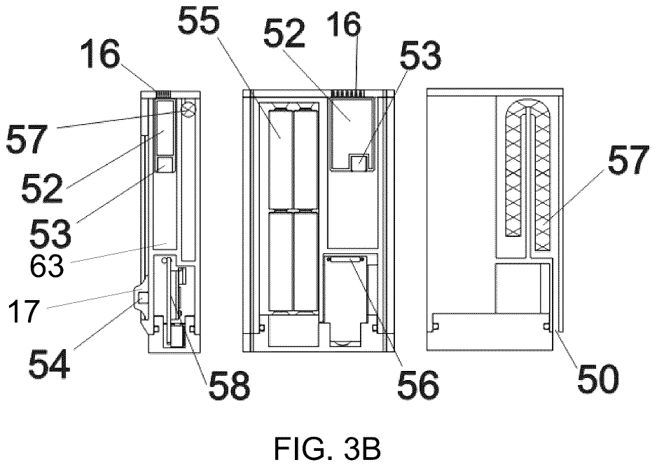

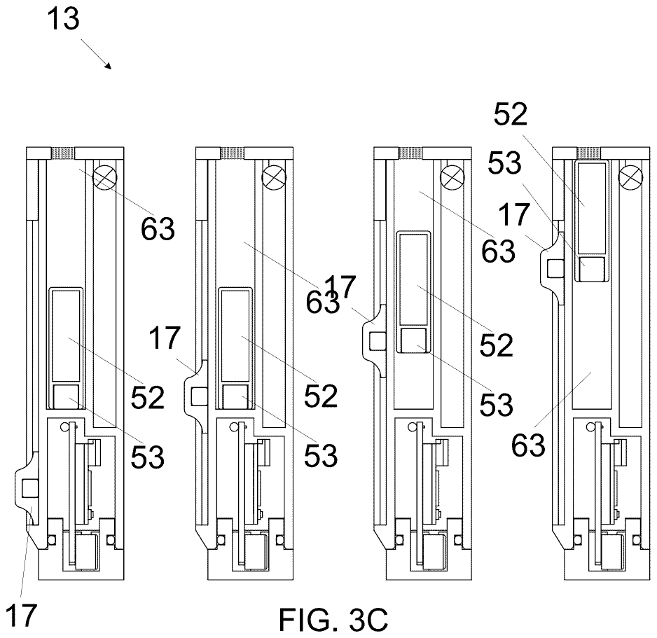

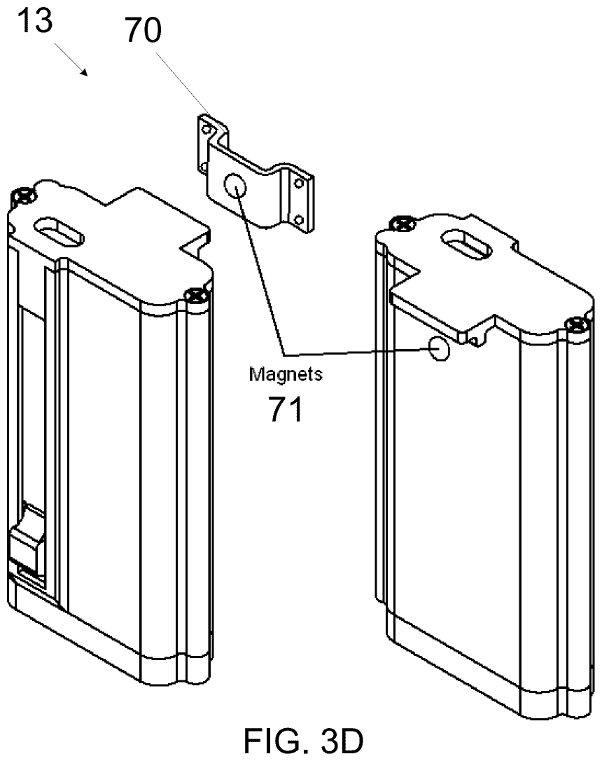

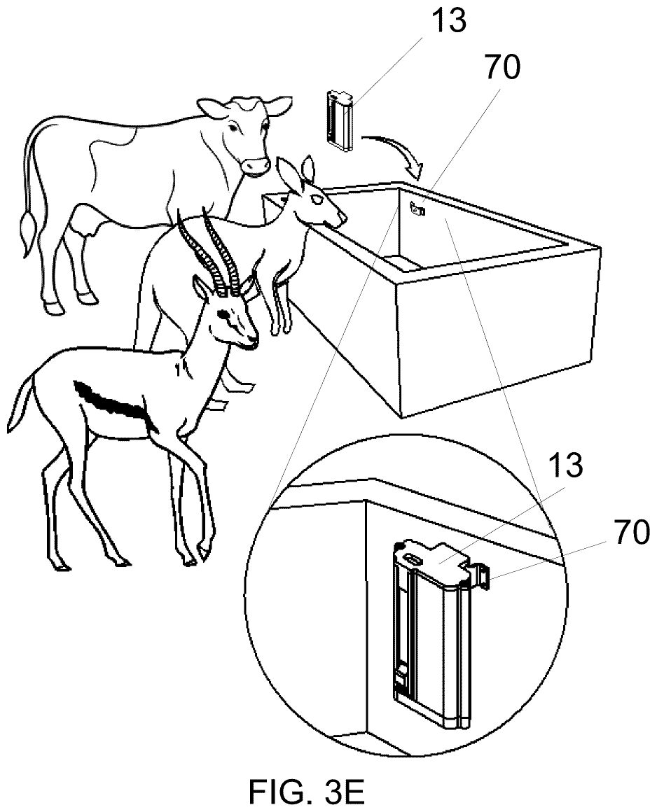

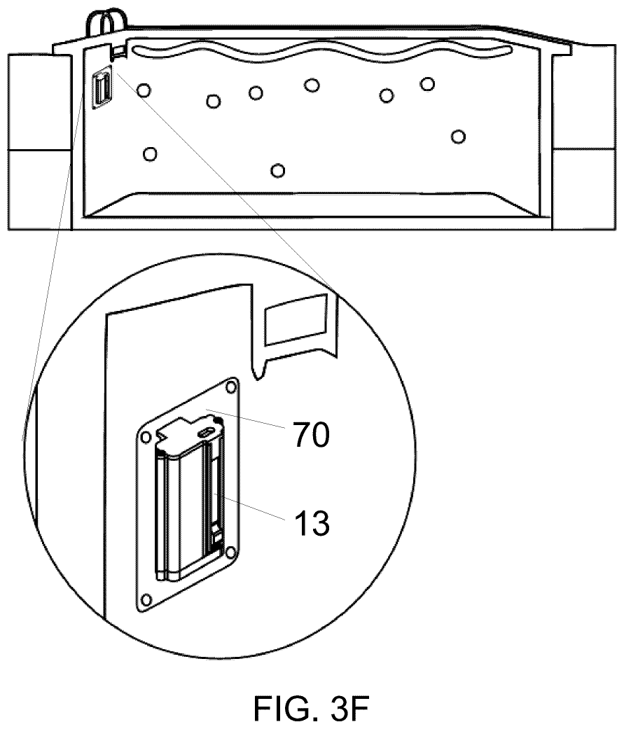

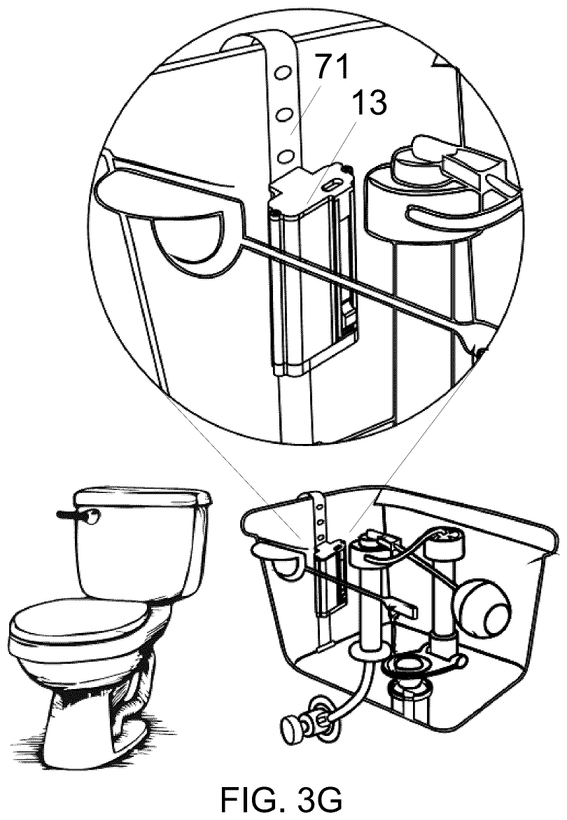

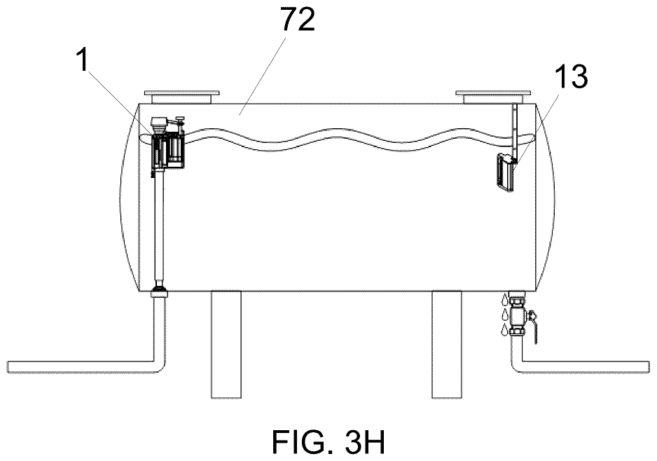

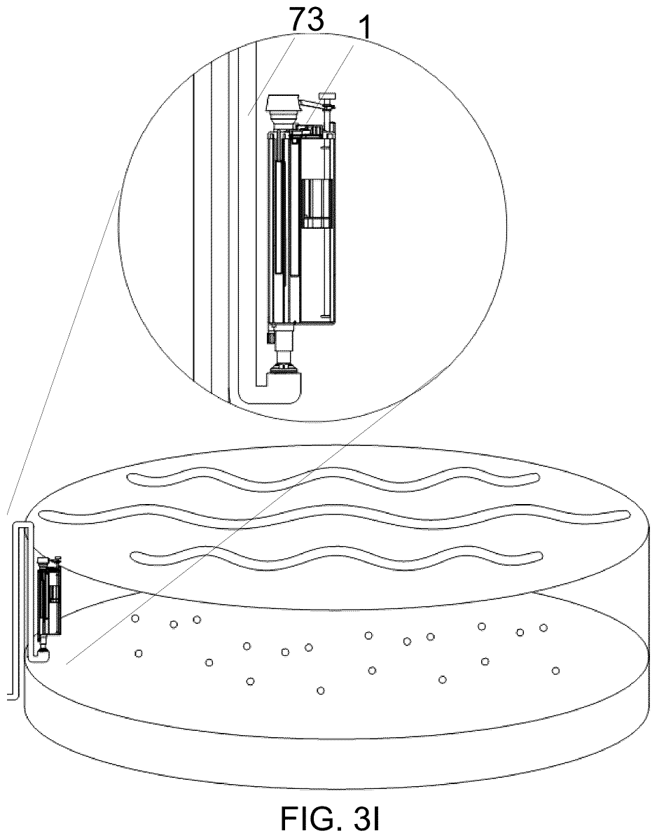

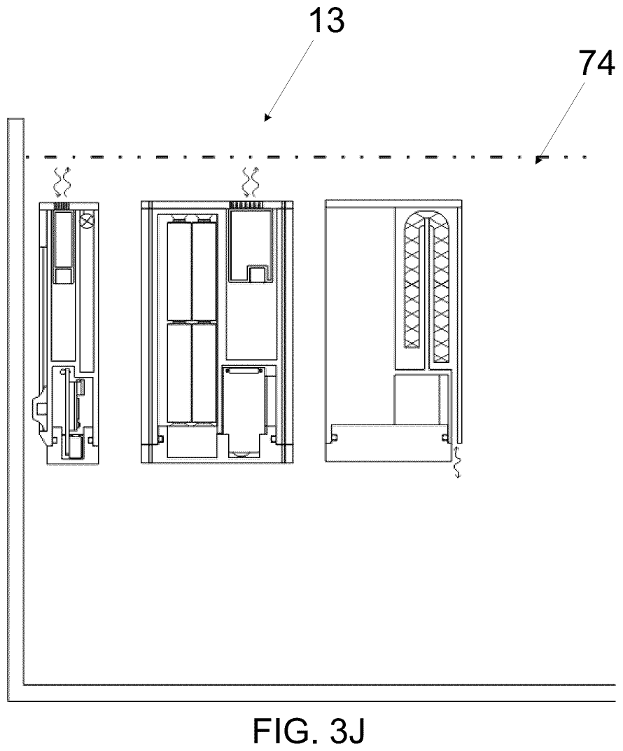

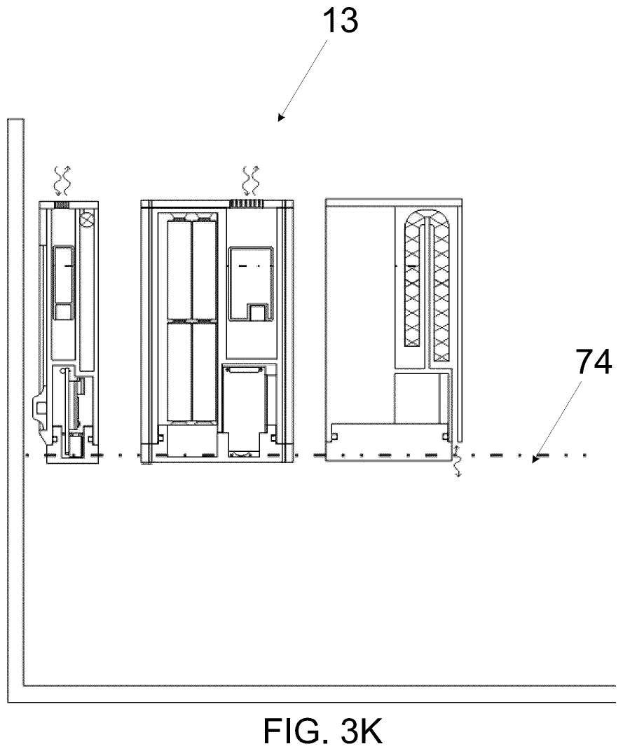

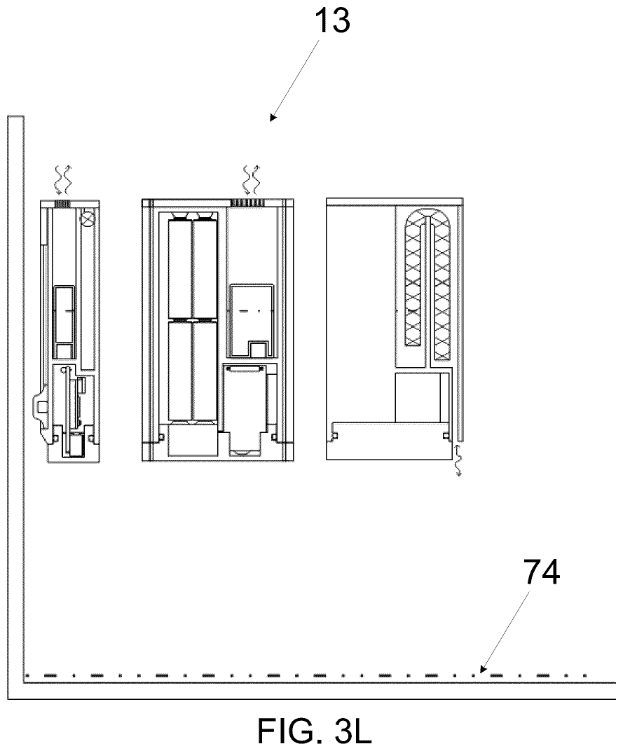

FIG. 3A depicts an embodiment of a removable sensor housing 13. As described above, the removable sensor housing 13 contains the device's electronics, including the battery compartment, processor, memory, network interface, and/or various sensors. Further, the housing 13 includes a manual switch 17, button, or the like that can be actuated to activate or deactivate the electronic components and/or to initiate system diagnostics. The switch 17 incorporates or is coupled with a magnet that communicates with the internal float's magnet 53.

In one embodiment, a port 50 located at the bottom of the housing 13 enables fluid to enter and exit the housing 13. Positioned directly beneath the wicking material 57, this port 50 allows for effective fluid exchange. The wicking material 57 draws moisture away from the float assembly, facilitating accurate float movement and maintaining proper function of the fluid level detection system.

Additionally, the device features an alternative mounting bracket 51 for the sensor housing 13, designed to provide flexible installation options across a variety of fluid-holding tanks. This bracket 51 may take the form of a ring-shaped clamp or any other type of mechanical attachment that can secure the sensor in place. The bracket 51 may also be affixed to a surface to position the sensor at the appropriate depth within a fluid body. This versatility ensures that the sensor can operate as a standalone unit and be adapted for use in a wide range of environments and container types, making it broadly applicable for fluid monitoring across diverse applications.

FIG. 3B depicts a cross-sectional view of the removable sensor housing 13. In one embodiment, an internal float 52 is housed within the sensor assembly and moves vertically in response to fluid levels entering or exiting the chamber 63. This float 52 contains an embedded magnet 53 that, as the float 52 descends, comes into contact with a magnetic switch 17 located on the processor board. This interaction forms a key component of the device's fluid detection and activation mechanism.

The switch magnet 54, in one embodiment, interacts with the float's magnet 53 to control the float's position, enabling various operational modes such as activating or deactivating the device or initiating test sequences. In its lower position, the switch 17 allows the float 52 to move freely with fluid level changes. However, when the switch 17 is slid upward, the magnetic field from the switch magnet 54 repels or holds the float magnet 53, preventing the float 52 from descending and disabling its interaction with the magnetic switch. During communication between the float and switch magnets 53, 54, specific float movements—such as lowering the float 52 for ten seconds, raising it for five to ten seconds, then lowering it again—can trigger a test mode on the processor.

The device includes a battery compartment 55 that houses batteries that power the electronic components, though it can also be configured for hardwired operation using standard 110-volt electrical connections. This dual-power capability increases installation flexibility across a range of use cases.

In one embodiment, a magnetically operated switch 56 is positioned within the processor housing to respond to the internal float magnet's 53 movement. Surrounding the float 52 is a wicking material 57 designed to transfer fluid into and out of the float chamber 63 gradually. Fluid enters this chamber 63 through a lower port and exits via the same route (e.g., the fluid can enter and exit through port 16 and port 50), with the wicking material 57 delaying fluid displacement. This creates a built-in delay between changes in external fluid levels and internal float movement, which is particularly useful in fluid tank applications, such as toilet tanks, industrial tanks, or other tanks where fluid level deviations are normal and an instantiations warning would be impractical—allowing sufficient time for tank refilling before any alert is triggered.

In one embodiment, the device includes a processor 58, which integrates the speaker, relay, haptic motor, and other electronics. The processor 58 is responsible for managing communication and control functions, including sending alerts when fluid is no longer detected around the housing or when the device enters a shutdown state. It is also capable of receiving remote signals, which may command the device to activate components such as the electromagnet, thereby manipulating the float's position. The processor 58 includes an integrated antenna, though an extended antenna may be used to enhance communication range. In some configurations, cellular or other long-range communication technologies may be employed for remote monitoring and control.

In one embodiment, the removable sensor housing 13 incorporates a float 52 embedded with a magnet 53 that interacts with a magnetic switch 17 located on a circuit board at the base of the housing 13. This interaction activates a battery-powered processor 58 when the float 52 descends to a predefined lower position. The float 52 is positioned within a chamber 63 that is in direct contact with surrounding fluid. Integrated into this chamber 63 is a wick material 57 that arches over an internal wall—one end of the wick 57 is submerged in the fluid alongside the float 52, while the opposite end drapes over the wall and extends toward a fluid exit port located at the base of the unit.

In certain embodiments, this design enables fluid to be gradually drawn from the float chamber 63 through capillary action in the wicking material 57, allowing fluid to exit the housing 13 over time. As fluid is wicked away, the float 52 slowly descends toward the magnetic switch 17, ultimately triggering the processor 58 to wake from deep sleep mode and execute programmed functions. The use of the wick 57 creates a built-in delay mechanism, preventing the device from responding to brief or transient losses of fluid contact—such as those occurring during toilet flush cycles or minor splashing—thereby avoiding false activations.

This delayed response system is particularly advantageous in applications like toilet tanks, where temporary fluid level fluctuations are common. As the surrounding fluid level recovers, the chamber 63 refills through an upper port (e.g., ports 16, 50), resetting the float 52 before activation occurs. This approach is energy-efficient, minimizing unnecessary processor wake-ups and conserving battery life, and represents a novel method for integrating mechanical fluid sensing with timed electronic activation.

In one embodiment, the valve 1 and the sensor housing 13 with its associated electronic components operate independently. However, when combined via their integrated mounting system, the valve 1 can automatically shut off to prevent excessive fluid loss, while the sensor housing 13 initiates a delayed response after detecting a drop in surrounding fluid. This response includes the processor sending notifications via email and text message to alert the user of the stoppage. Additionally, the processor can activate an audible alarm, an LED indicator, and a vibrating motor to provide multiple forms of notification. It also continuously monitors battery life and issues alerts accordingly.

The processor's functionality described above, in one embodiment, represents only a fraction of its potential capabilities. The processor 58 may be configured to collect and analyze data on flow rate, water pressure, and other critical parameters. Based on this data, the system could activate additional components—for example, triggering an electromagnet to pull the float 52 into the upward, “off” position in response to a detected pressure drop.

In one embodiment, the processor 58 is powered by batteries 55 enclosed in a waterproof housing. However, hardwired power for continuous operation could also be employed. To support energy efficiency and sustainability, a hydroelectric generator may be mounted at the valve base, capturing energy from fluid flow to recharge the onboard batteries.

The device is also well-suited for standalone applications, such as use in large tanks or reservoirs. In these cases, it is often advantageous to introduce a delay before issuing alerts, allowing sufficient time for the system to naturally refill. This is easily accomplished by adjusting the volume of the float chamber and the properties of the wicking material to tailor the delay interval.

For example, in a livestock watering tank fitted with a conventional automatic fill valve, large animals could quickly deplete 50% of the tank's volume, and refilling might take 20 minutes. It would be undesirable for the system to send an alert during this normal recovery period. While other sensors might delay alerts through programmed timers, such systems must remain powered during the delay period—consuming energy even when no action is necessary. By contrast, this sensor remains in a low-power “sleep” state and only activates the processor when the internal float reaches the bottom of its chamber, regardless of the external fluid level. This design dramatically reduces unnecessary power consumption while ensuring reliable performance.

FIG. 3C depicts a cross-sectional view of the removable sensor housing 13. In particular, as shown in FIG. 3C, the removable sensor housing 13 includes a magnetic switch 17 operatively coupled to a float 52disposed within a fluid-containing chamber 63. The magnetic switch 17 is configured to selectively position the float 52 by magnetic interaction, thereby enabling or restricting the float's vertical movement in response to fluid level changes.

In a first position, wherein the magnetic switch 17 is in its fully lowered state, the float 52 is not magnetically restrained and is free to move vertically within the chamber 63 in accordance with the surrounding fluid level. In this position, movement of the float 52 may bring an integrated magnet into proximity with a magnetic switch located on a circuit board. Detection of the float magnet 53 by the magnetic switch initiates activation of a processor. The processor may enter various operational states—including active, off, test mode, or other predefined settings-based on a programmed sequence of magnetic switch activations.

In a second position, wherein the magnetic switch 17 is raised, the float 52 is magnetically retained in an upper position, regardless of fluid level. In this configuration, the magnetic switch is not triggered, and the processor remains in a powered-down or low-power “deep sleep” state to conserve energy.

Transitioning the magnetic switch 17 from the raised to the lowered position re-enables float movement and reestablishes the potential for processor activation. Specific operational modes of the processor may be selectively accessed by performing a predetermined sequence of magnetic switch movements and corresponding float displacements.

FIG. 3D depicts an embodiment of the sensor housing 13 with an alternative mounting bracket 70. In one embodiment, the sensor housing 13 includes an alternative mounting bracket 70 equipped with a magnet 71 to ensure secure attachment to fluid containers or device housings. This magnet-enhanced bracket 70 is designed to prevent accidental dislodgement or movement of the sensor during operation, transport, or maintenance. The magnetic bracket 70 provides a reliable and stable mounting solution that complements the mechanical clamp or fastener, adding redundancy to prevent sensor misalignment or detachment—especially in environments subject to vibration, water surge, or animal interaction.

FIGS. 3E-3G illustrate different embodiments of mounting the sensor housing. In FIG. 3E, in one embodiment, the sensor housing 13 includes an alternative mounting bracket 70 equipped with a magnet to provide a secure yet easily removable attachment to fluid containers, particularly useful in livestock watering systems. This magnetic bracket 70 prevents unwanted dislodging due to animal contact, vibration, or water surge while allowing the sensor housing 13 to be quickly detached for servicing or battery replacement. The design balances stability during operation with user-friendly access for maintenance, making it ideal for rugged environments where reliable function and ease of upkeep are critical.

FIG. 3F illustrates one embodiment where the sensor housing 13 includes an alternative mounting bracket equipped with a magnet to securely attach the unit to various fluid containers or surfaces, including the interior wall of a swimming pool or the side of a livestock watering tank. This magnetic mounting system 70 is designed to prevent unwanted dislodging caused by water movement, animal contact, or environmental vibrations. Despite its secure hold, the bracket 70 allows for easy removal of the sensor housing for servicing, diagnostics, or battery replacement. This flexible and robust attachment method ensures dependable operation in both rugged agricultural environments and aquatic applications where stability and accessibility are essential.

FIG. 3G illustrates an embodiment of the sensor housing 13 that is mounted to a punched metal or plastic bracket 71 affixed to the interior wall of a toilet tank. The bracket 71 features a series of pre-formed holes or slots that allow for adjustable vertical positioning of the housing to suit varying tank depths and flush cycle profiles. The housing 13 includes integrated tabs or a slotted back plate that align with the bracket holes, enabling the user to securely fasten the unit using a clip, screw, or snap-fit mechanism. This mounting method provides a stable and repeatable position within the tank while allowing for easy removal of the housing for battery replacement, diagnostics, or service. The bracket's 71 perforated design also minimizes disruption to water flow within the tank and resists buildup of sediment or mineral deposits, ensuring long-term reliability and consistent fluid sensing performance.

FIG. 3H depicts an embodiment of the valve system installed in an industrial fluid tank 72 application, illustrating both integrated and standalone sensor 13 configurations. On one side of the tank 72, the valve 1 is shown with its sensor housing mounted directly to the valve body, enabling local control and monitoring. On the opposite side, a standalone sensor 13 is positioned independently, capable of communicating wirelessly with the valve unit and/or of acting independently of the valve sending transmissions and/or signals that don't impact the valve, but give the user insight into the fluid conditions within the tank. This dual arrangement allows for enhanced fluid level detection and redundancy in system feedback, particularly useful in large tanks or distributed installations.

In remote installations—such as field storage tanks, agricultural tanks, or chemical containment vessels—this system offers critical protection against fluid loss. If the tank 72 were to develop a leak, the valve 1 would detect the resulting drop in internal fluid level and prevent further filling, thereby avoiding waste or environmental contamination. Additionally, the device can be configured with a delayed shutoff mechanism via a variable drip feed into the float's container. This drip-controlled timing function ensures the valve shuts off automatically if fluid continues to drain at an abnormal rate—such as when a downstream outlet valve is accidentally left open by personnel. The result is an intelligent, self-regulating safety feature that mitigates human error and supports unattended operation in industrial or remote settings.

FIG. 3I depicts an embodiment of the valve that includes a float disposed on a vertically sliding shaft 73, configured to introduce a delay in valve activation. Conventional fluid control valves typically respond to minor decreases in fluid level within a holding tank, resulting in frequent activation and deactivation cycles. Such repetitive cycling increases mechanical wear on the valve's internal components. By delaying valve activation until a greater volume of fluid has been depleted from the tank, the described embodiment minimizes cycling frequency and thereby extends the operational lifespan of the valve assembly.

FIGS. 3J-3L depict an example of the sensor housing submerged in a body of fluid. FIG. 3J depicts an embodiment of the sensor housing 13 submerged in a body of fluid 74. In this configuration, the housing 13 is shown actively monitoring the fluid level through vertical float movement within its internal chamber. The surrounding fluid 74 enters the housing chamber through the upper and lower port, allowing the internal float to respond gradually due to the action of the integrated wicking material. In one embodiment the wicking material 57 self-balances the surrounding fluid level with the internal float chamber fluid level. In other words, if the fluid level isn't higher than the internal wall, the wick will carry fluid back into the float chamber and will equalize the fluid levels. This embodiment illustrates the housing 13 in a fully operational state, with the float freely rising and falling in response to fluid level changes. The submerged condition ensures accurate fluid detection, and the housing remains sealed against moisture intrusion, enabling consistent performance in long-term submerged applications such as livestock tanks, pools, and industrial reservoirs.

FIGS. 3K and 3L depict embodiments where the body of fluid 74 has dropped significantly in a short period of time. Despite this rapid fluid loss, the sensor housing 13 continues to retain fluid within its internal chamber. This behavior results from the delayed fluid displacement caused by the wicking material, which gradually draws liquid from the float chamber over time. This mechanical delay ensures that transient or turbulent fluid fluctuations—such as those caused by rapid evacuations, temporary draining, or surface disturbances in environments like swimming pools—do not prematurely trigger the device's activation sequence.

In one embodiment, an advantage of this design is its mechanical approach to implementing a delay feature. Unlike electronic timers, the float does not immediately contact the internal magnetic switch until the wicking material has sufficiently depleted the chamber's fluid. This delay ensures a true reflection of sustained fluid loss, avoiding false positives due to splashing or bouncing fluid levels.

In another embodiment, the device may be configured to operate in reverse—activating upon fluid rising rather than falling. In such a configuration, the float begins at the bottom of the chamber in a resting “off” position. As fluid enters and lifts the float, it eventually breaks magnetic contact with a switch positioned below, triggering the processor to enter an active state. This reversed operational mode enables use cases such as detecting flooding, tank refills, or return of fluid following maintenance or drought conditions.

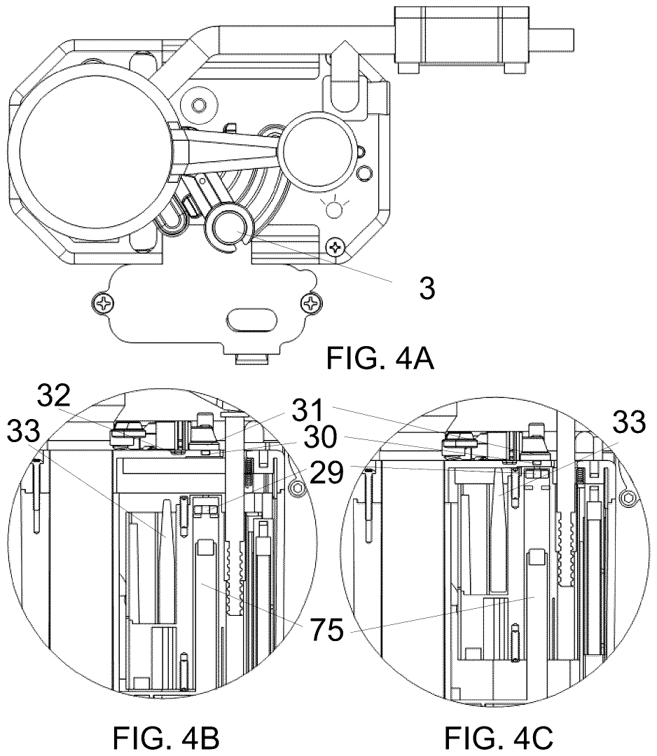

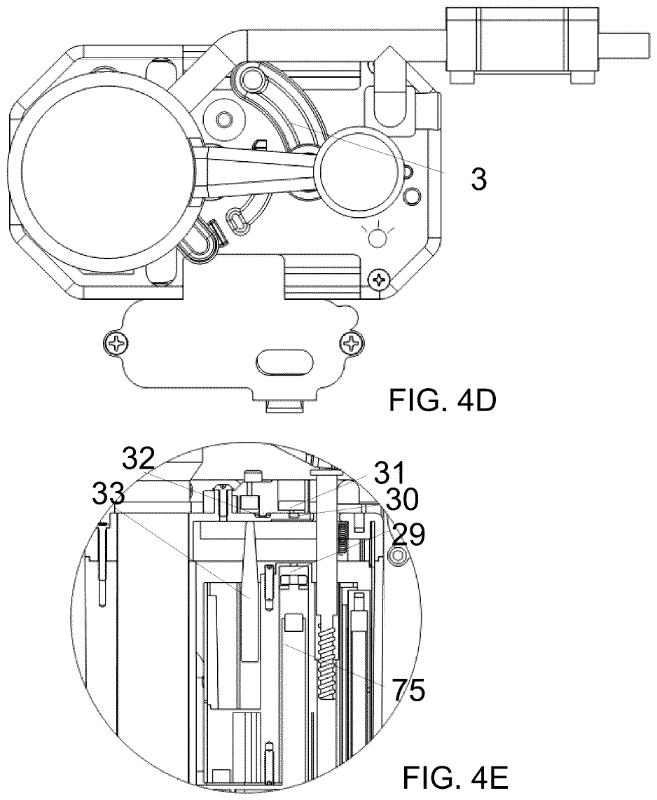

FIG. 4A depicts an embodiment the sensor housing affixed to the main assembly of the device and the actuation lever 3 positioned in the off configuration. In this position, magnet 31 is pivoted away from a location directly above float magnet 29, thereby reducing the net magnetic retention force acting on the float when it is in its uppermost position.

The float 75, in some embodiments, is subject to a slight upward bias provided by magnet 30, which is embedded in the lid of the housing. In the configuration shown, magnet 30 exerts a continuous but minimal magnetic force on the float. Although magnet 30 alone is insufficient to suspend the float if all surrounding fluid is absent (i.e., in a “slow leak” condition), the combination of magnets 30 and 31 is sufficient to retain the float 75 in the raised, suspended position even in the absence of fluid. In an alternative embodiment, magnet 30 may be positioned within the lever itself and configured to move into or out of alignment with the float 75 depending on lever position.

Pivoting the lever 3 to the off position also repositions magnet 32 away from a location directly above the deployable weight 33, which is disposed within a cavity of the float. When magnet 32 is disengaged, the weight 33 is free to move vertically in response to float movement. This deployable weight 33 acts to reduce the net buoyancy of the float 75, thereby allowing it to move more responsively to changes in fluid level.

When the lever 3 is pivoted to the on position, magnet 32 becomes aligned above the deployable weight 33, which makes the float act more like a typical float when in deactivated mode. The float is quicker to start descending downward with slighter changes in fluid levels as opposed to its normal operation which is delayed in movement. In this state, the weight 33 is magnetically retained in its uppermost position, suspended independently from the float 75, and does not contribute to the float's net mass. This permits normal buoyant operation of the float 75.

In one embodiment, a feature of the disclosed float design is the ability to vary effective weight dynamically. This can be achieved either through controlled shedding or accumulation of fluid, or, as illustrated in this embodiment, through magnetic control of internal movable masses such as weight 33.

In one embodiment, a feature of the device is the controlled shedding of fluid from the float reservoir and its subsequent effect of supporting and elevating the float 75. This compound operation is fundamental to the timing and functionality of the system. An important feature includes the use of deployable weight, which may be selectively added to the float 75 to influence its buoyancy and response time.

Additionally, the device provides for the regulation of the float's upward movement through magnetic interaction. This magnetic force functions similarly to an adjustable weight, wherein the attractive force between opposing magnets increases or decreases based on their relative distance. As the magnets draw closer, the force strengthens; as they separate, the force weakens. This variability allows for dynamic control over the float's ascent.

Another critical feature involves the ability to pivot the top lever, thereby displacing the upper magnets 30, 31 from axial alignment. As the alignment is progressively offset, the magnetic attraction exerted on the float diminishes. Reduced magnetic force results in a functionally heavier float when submerged in fluid and containing a full ballast (or float) reservoir, thereby slowing its ascent and prolonging the fluid-shedding process.

Furthermore, the use of an absorbent material 37 such as a sponge can modulate this shedding behavior. The sponge retains fluid and gradually releases it over time, delaying the loss of ballast weight. This extended shedding profile emulates the behavior of a fluid-saturated sponge resting on a surface, which ultimately releases its contents but does so gradually, allowing the float to maintain added weight for an extended duration.

FIG. 4B depicts an embodiment of the device where the weight 33 descends within its float cavity as the float 75 itself moves downward. FIG. 4C depicts an embodiment of the device where the float 75 returns to the top position with the weight 33 re-engaged in the upper cavity. If the lever is again pivoted to the on position, the magnet 32 magnetically biases the weight 33 upward toward the lid, where it remains suspended. In one embodiment, the float magnet is allowed to move, which allows fine-tuning of the float speed and force as it ascends.

FIG. 4D depicts an embodiment the sensor housing affixed to the main assembly of the device and the actuation lever 3 positioned in the on position. In this state, magnet 31 is aligned directly above float magnet 29, increasing the magnetic field strength exerted on the float. This configuration enables full magnetic coupling between magnets 30 and 31 and the float 75, thereby maximizing the ability to retain the float 75 in a suspended state when fluid is present.

Magnet 32, now repositioned above the deployable weight 33, magnetically attracts and retains the weight in an elevated position within the housing lid. As a result, weight 33 is no longer mechanically coupled to the float 75, and its mass does not influence the float's buoyancy or movement characteristics. This enables the float 75 to operate with reduced effective weight, increasing its responsiveness to fluid level changes.

FIG. 4E depicts an embodiment of the float operation of the device. As the float 75 descends in response to a reduction in fluid level, weight 33 remains adhered to the lid, magnetically suspended by magnet 32, and does not travel with the float. This separation ensures that the float's buoyant response remains unaffected by the deployable mass during the activated mode.

This magnetically controlled decoupling of weight 33 from the float 75 provides a mechanism to selectively modify the float's effective weight, offering an alternative to fluid-shedding mechanisms for mass variation. Such a configuration allows the device to be tuned for specific operational characteristics across multiple modes (e.g., high-sensitivity vs. damped-response).

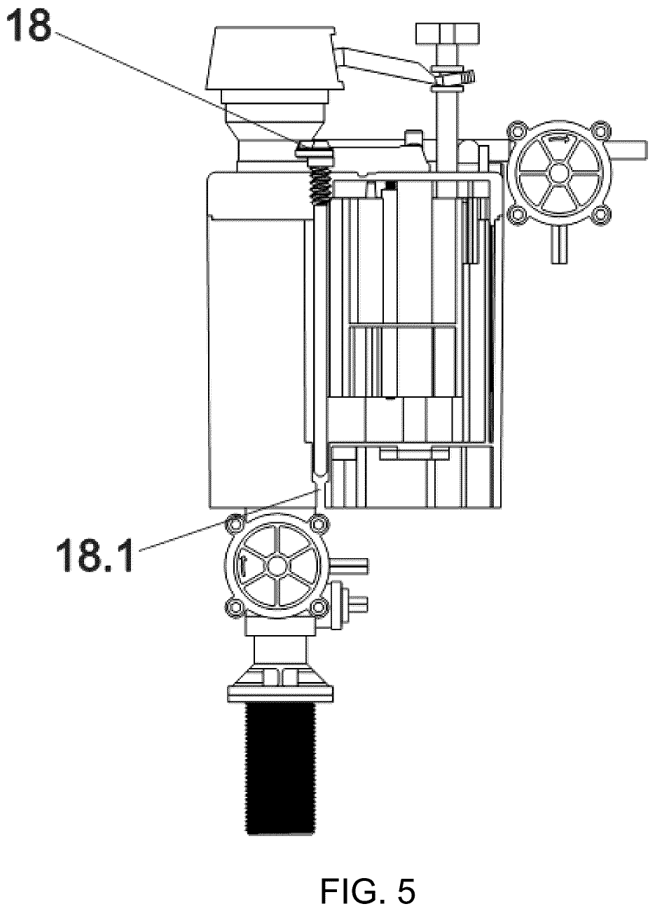

FIG. 5 depicts a side sectional view of the device. In one embodiment, the device includes a threaded rod 18 mechanism operatively connected to a port 18.1 located at the base of the fluid container. Rotation of the threaded rod 18 actuates the port 18.1, enabling it to transition between an open and closed state. In one embodiment, the rod 18 is incorporated into the activation lever so that a magnet was pivoted and a port opened simultaneously.

In the open position, the port 18.1 establishes direct fluid communication between the internal volume of the container and the surrounding fluid environment. This configuration allows external fluid to influence the fluid level inside the container in real time, providing a roughly 1:1 response ratio between changes in the surrounding body of fluid and corresponding movement within the container.

In contrast, when fluid communication occurs via siphon action or a wicking mechanism, there is an inherent delay in fluid transfer due to flow resistance and capillary limitations. The inclusion of an openable port 18.1 provides the option to bypass these passive systems, allowing for immediate equilibration and enhanced responsiveness of the internal float system to environmental changes.

This adjustable feature enables the device to be configured for fast or damped response times, depending on operational needs, and provides flexibility for use in a range of fluid monitoring or control applications.

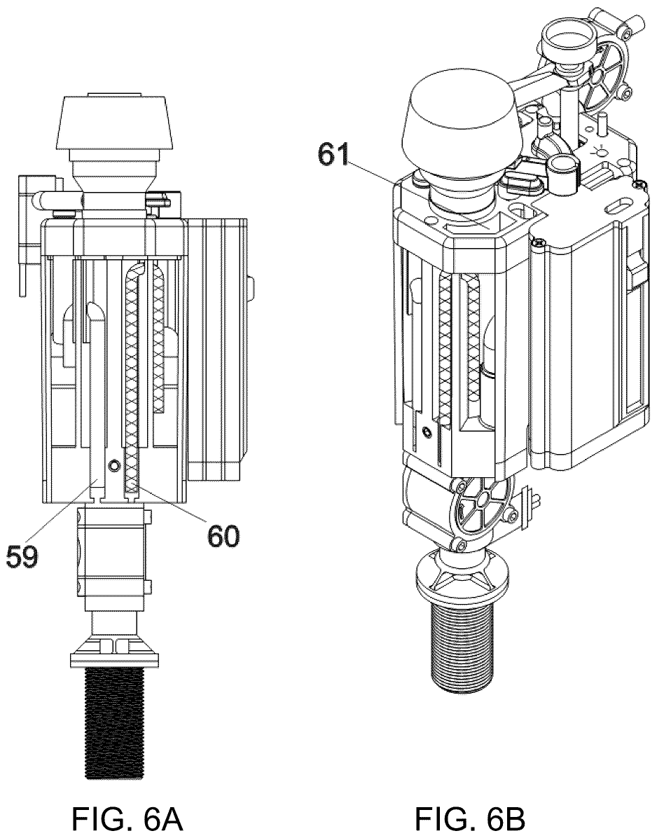

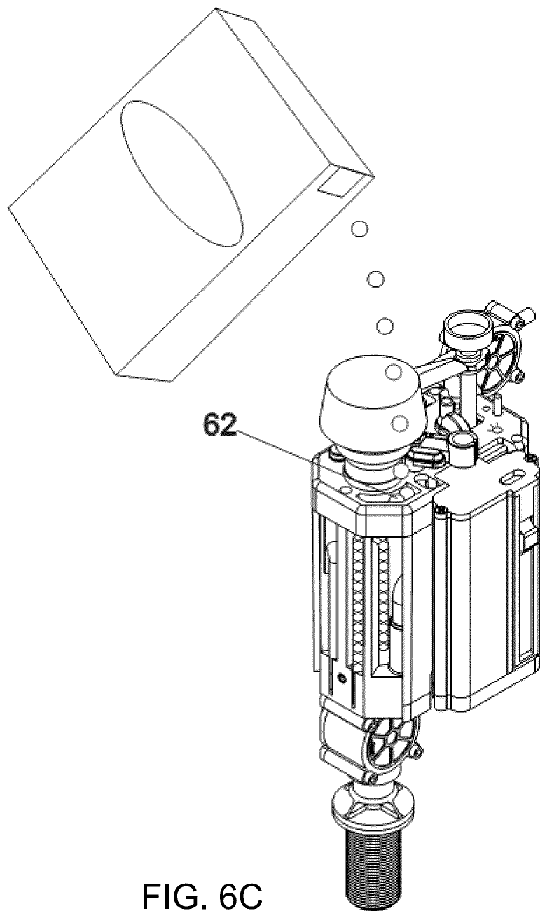

FIGS. 6A and 6B illustrate sectional views of a rear portion of the device, which may be an embodiment of the device described above. In one embodiment, the device includes a small siphon 59 that is configured to remain in continuous fluid communication with the surrounding external fluid environment. Unlike other siphons that include a check valve or floatable ball element—which interrupts fluid transfer at certain fluid levels—this siphon 59 is designed without such flow-restricting elements, thereby maintaining uninterrupted fluid connectivity. This design ensures that the siphon 59 remains primed and capable of immediate response to changes in external water level, particularly under low-flow or slow-leak conditions.

In the depicted embodiment, the siphon 59 is configured to facilitate fluid transfer between the surrounding body of water (e.g., a toilet tank) and the internal fluid container. This siphon 59 is notably designed without a check valve or “ball” that would otherwise inhibit reverse flow, thereby allowing fluid to enter from the exit side of the siphon.

Such an embodiment enables priming of the siphon 59 by allowing external fluid to displace air trapped in the siphon summit, ensuring that the siphon 59 becomes fully active once the surrounding water level rises and spills into the lid area of the device. Upon activation, the siphon 59 maintains an immediate and continuous fluid path between the external environment and the internal container.

In certain embodiments, this is advantageous in scenarios such as slow leaks in a toilet tank. Because the siphon 59 is already primed, even a small drop in external fluid level results in immediate drawdown of the container's fluid via the siphon 59, eliminating the delayed response typically associated with unprimed siphon systems.

In embodiments where the siphon 59 is not primed—i.e., if air remains trapped in the summit and fluid is present on both sides—activation requires a drop in the surrounding water level. This drop must be sufficient to generate gravitational force capable of displacing the trapped air column and initiating siphon flow.

FIGS. 6A and 6B illustrate also show an integrated wick 60 positioned within the device, which may be employed as an alternative or supplementary means of transferring fluid into or out of the container. A section of wicking material is positioned within the tank or container and serves to transfer fluid in and out of the container via capillary action. This transfer occurs independent of siphon activation and provides a passive means of fluid exchange. The wicking material enables slow, consistent movement of fluid into or out of the internal volume, enhancing sensitivity to gradual changes in fluid level and allowing additional design flexibility for timed or buffered responses. In one embodiment, both wicking and siphoning mechanisms can be used either independently or in tandem to control fluid movement, offering flexible design options for tailored response rates.

Additionally, FIGS. 6A and 6B illustrate a reservoir 61, which is located near the upper region of the device. In one embodiment, the reservoir 61 automatically fills with fluid once the surrounding water reaches the top of the housing. Once filled, it can serve two primary purposes—(1) fluid redistribution where the reservoir delivers water back into the internal container, aiding in raising the float to its intended position; and (2) additive dispensing where the reservoir 61 is capable of housing cleaning agents or additive tablets, which are dissolved and dispensed into the surrounding environment—such as a toilet tank—on a per-flush cycle basis.

In one embodiment, the reservoir 61 is configured to receive and temporarily retain fluid as the surrounding fluid level reaches the upper limit of the device. The base of the reservoir 61 includes a calibrated opening through which the fluid slowly drains into the internal container, thereby increasing the local fluid level around the float.

FIG. 6C depicts one embodiment of the device with included additives 62. In one embodiment, the reservoir 61 is further adapted to hold cleaning agents or chemical additives, such as tablets or dissolvable solids. Upon partial dissolution, a portion of the additive-laden fluid is gradually delivered into the container. During a flush cycle, the siphon system carries this treated fluid from the container and distributes it into the surrounding water supply (e.g., a toilet tank), enabling controlled, per-cycle additive delivery. In one embodiment, the additives 62 may include vitamins and medicines for animals. This multifunctional fluid handling system enhances both the sensitivity and utility of the device across various operational states.

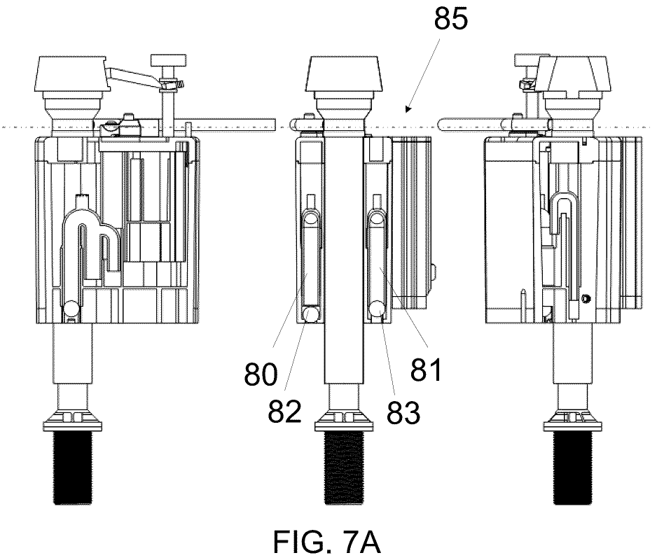

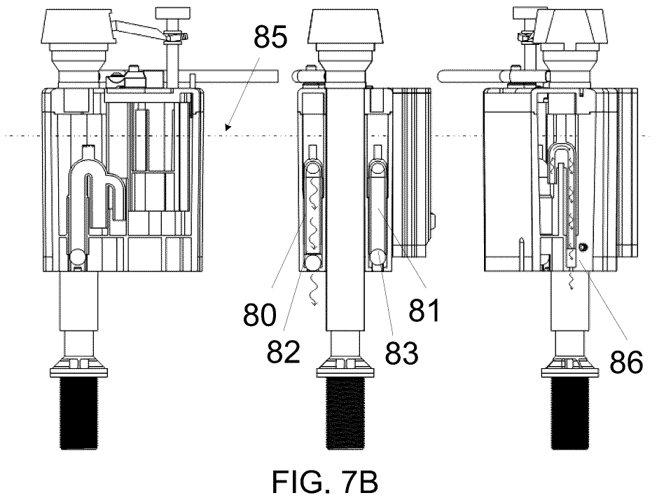

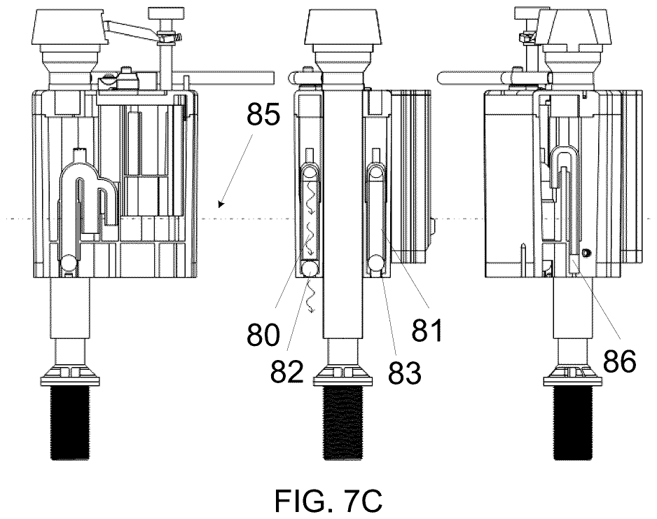

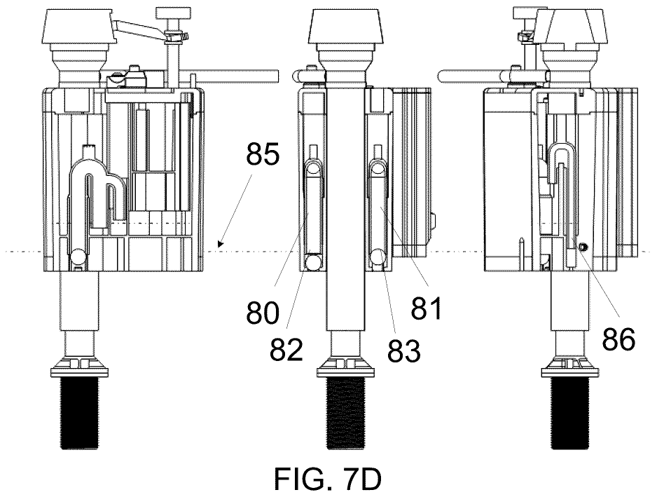

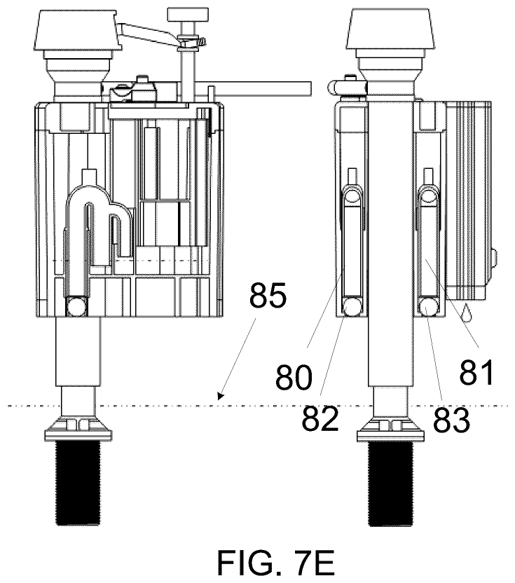

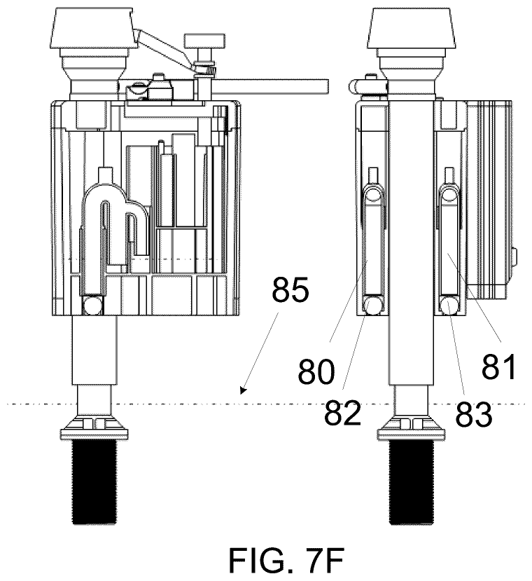

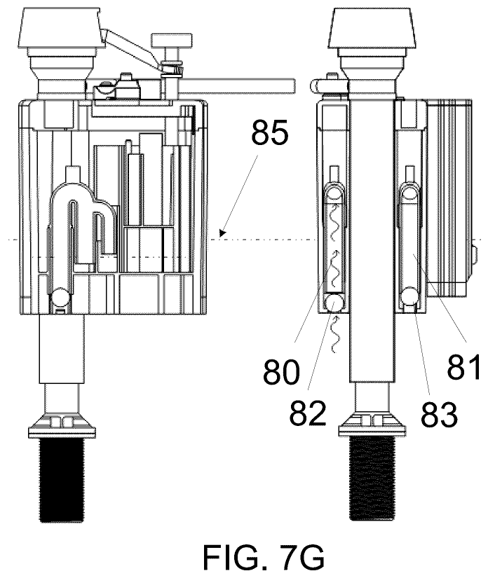

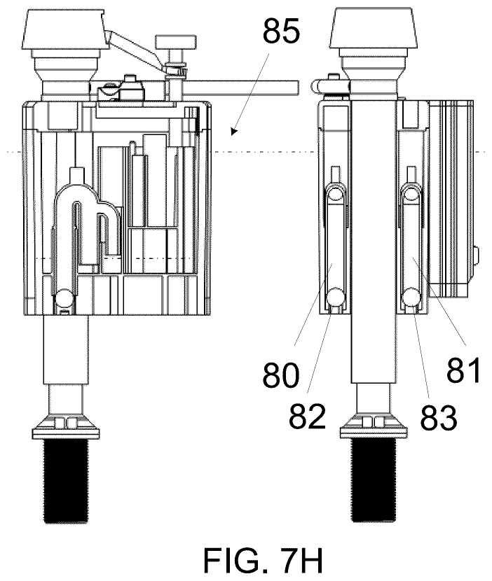

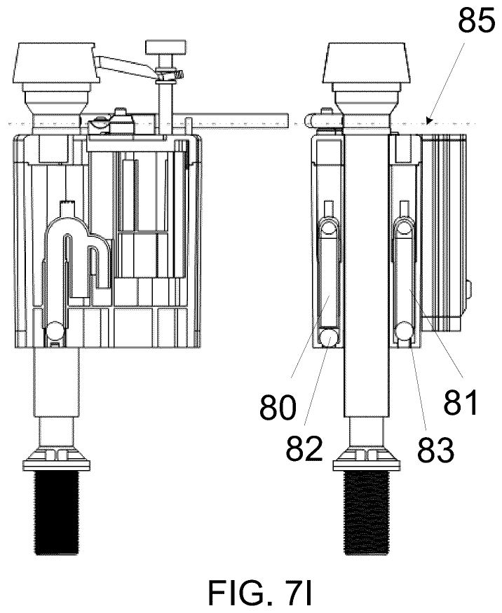

FIGS. 7A-7I illustrate a simplified version of the fluid control device that maintains the core principles of operation described in prior embodiments. The depicted sequence corresponds to a slow leak condition, with the dotted line indicating the level of the surrounding body of fluid (e.g., water within a toilet tank).

In FIG. 7A, the valve is in the off position while the activation lever 3 is in the on position, and the main float 75 is retained in the uppermost position, suspended by magnetic interaction (e.g., between magnets 29 and 31). The system includes dual siphons 80, 81, each employing a different type of ball 82, 83 or float valve located at the exit port of the siphon to control fluid ingress and siphon priming behavior.

In the left siphon 80, the ball 82 is non-buoyant and remains seated at the base under gravitational force. As the external fluid level rises 85, water pressure builds at the siphon's exit port, displacing air from the summit of the siphon. Once the air is cleared and vacuum pressure is achieved, the non-buoyant ball 82 is drawn upward into a sealing position, thereby blocking additional fluid from prematurely entering the siphon exit and preventing early filling of the container. This process primes the siphon while maintaining a controlled fluid entry rate.

In the right siphon 81, the ball 83 is buoyant and rises with the external fluid level. As it ascends, it makes contact with the siphon's exit port, effectively sealing it at an earlier stage in the fluid rise. Like the left siphon 80, this prevents fluid from prematurely entering the container via the siphon exit and keeps the siphon in an un-primed state with air trapped in its summit.

Both siphon configurations prevent uncontrolled fluid transfer into the internal container, which would otherwise raise the float prematurely-before the surrounding fluid reaches the overflow level and enters the lid area. Without this delayed float rise, the reservoir (noted in prior sections) would not fill, and the subsequent flush would fail to generate enough force to disengage the float from the magnetic hold.

In one embodiment, each siphon uses a different mechanical principle to achieve the same functional outcome—namely, exit port sealing that does not prematurely fill the container. The siphon on the left can begin reacting to small fluid level drops from the surrounding body of fluid, but the right siphon will remain inactive with air trapped in its summit until there is a rapid drop in the surrounding fluid level. This precise control ensures the float drop sequence is properly synchronized with the surrounding fluid level changes, enabling consistent post-flush operation.

An indicator float and rod assembly 11 is shown in the raised position, signaling that the internal float is also in the upper position and the system remains in an inactive or standby state.

In one embodiment, the siphons are designed to prime themselves automatically, employing exit-side air clearance and vacuum-driven sealing. Additionally, the device may include a secondary intake or air path for breaking siphon action, thereby enabling a controlled and repeatable siphon reset.

FIG. 7B depicts the behavior of the system during a slow and progressive drop in the surrounding fluid level, such as may occur due to a small leak in a toilet tank. As the external fluid level 85 begins to decline, multiple internal mechanisms respond according to their priming status from the previous refill cycle.

The small siphon 86 located at the rear of the device, as shown in the rightmost portion of the figure, was already primed during the last refill. As a result, it begins to actively transfer fluid from the container to the external environment immediately as the surrounding fluid level falls. The wick, also present within the device, concurrently draws fluid via capillary action, offering a passive and continuous transfer path that further contributes to maintaining fluid level balance.

The larger siphon 80 shown in the center of the figure, featuring a non-buoyant weighted ball 82, was likewise primed during the refill phase. The ball's mass allows external fluid pressure to displace air from the siphon summit, thereby forming a vacuum that initiates siphon action. This siphon becomes active during the leak event and contributes to fluid movement.

By contrast, the adjacent siphon 81 equipped with a buoyant ball 83 remains inactive during this phase. Its design causes the ball to rise early in the refill process, prematurely sealing the exit port and trapping air in the siphon summit. Because this siphon was not primed, it does not participate in fluid transfer until either a significant pressure differential forces air from the summit or a subsequent flush cycle resets the system.

Due to the coordinated action of the primed siphons and wick, the fluid levels within the internal container, float reservoir, and surrounding environment remain substantially synchronized during slow drainage events. This allows for consistent float behavior and reliable activation sequences. In contrast, during a rapid evacuation—such as a full flush—the water levels within each component may shift at different rates, depending on the activation thresholds and flow capacities of the individual siphons and the wick. In one embodiment, this is further controlled by port sizes and secondary materials slowing fluid movement out of the float reservoir. In such an embodiment, the port size of the float reservoir is a factor in how fast or slow the float returns to the top position.

As shown in FIG. 7C, as the fluid level surrounding the device continues to drop, the internal fluid level within the device also declines proportionally. At this stage, the fluid has descended below the intake of the small rear siphon (shown on the right). Once the fluid level 85 falls beneath the siphon intake point, air enters the siphon, thereby terminating its activation and interrupting further siphon-driven fluid movement through that path. This mechanism serves as a natural shutoff, preventing air from passing beyond the siphon's summit.

Despite the deactivation of the rear siphon 86, the larger siphon 80 located on the left side of the center image continues to operate. Having been previously primed and equipped with a weighted, non-buoyant ball 82, this siphon 80 maintains an active vacuum and continues to extract fluid from the internal container, supporting continued fluid level drop within the device.

At this point, the float reservoir is empty, and the main float remains in the uppermost suspended position, held in place by the magnetic attraction between the magnets 31, 29. As the float did not descend, the indicator float assembly 27 remains raised as well, magnetically retained between the magnets 11, 28. This provides a visual or mechanical indication that the system has not yet cycled into the active refill state.

In one embodiment, if the activation lever 3 had been positioned in the “off” state, the magnetic restraint on the float would have been disengaged. In such a case, the float would have descended as fluid was withdrawn from the container, triggering the valve mechanism and initiating a refill sequence for the surrounding fluid holding tank.

As shown in FIG. 7D, as the surrounding fluid level 85 continues its gradual descent, the fluid contained within the internal chamber of the device is drawn down to its lowest operational level. At this stage, fluid transfer through the remaining active siphon has ceased or significantly slowed, indicating the end of the siphon-driven evacuation process. The container is effectively empty of fluid, with only residual amounts potentially remaining below the siphon intake threshold.

In the center image, one of the siphon float balls 83 remains in the elevated position, despite the near-complete drainage. This is due to the residual upward fluid pressure still acting on the float from the surrounding fluid. The float remains biased upward momentarily, demonstrating the sensitive responsiveness of the system to even small variations in fluid level and internal pressure.

This stage underscores the fine balance achieved by the system in regulating fluid levels and float behavior, ensuring that the valve activation sequence is only triggered under well-defined fluid conditions and that premature activation is avoided through both mechanical and fluidic design considerations.

As shown in FIG. 7E, as the surrounding fluid level continues to fall, the buoyant ball 83 within the right-side siphon 81 ultimately descends as well, no longer supported by fluid beneath it. This indicates the complete evacuation of usable fluid from both the surrounding tank and the internal container. At this point, the device enters a passive or “off” state, in which no further fluid is supplied to the leaking holding tank. This termination condition is a function of the system's self-regulating safety behavior, designed to prevent continuous water loss.

This embodiment, while illustrated in the context of a toilet tank, has broad applicability. The concept—a controlled holding chamber with a float assembly, siphons, wicks, and magnetic biasing mechanisms—can be applied to a wide range of fluid systems. Any environment utilizing a float-actuated valve can benefit from this design's fail-safe shutoff, leak response, and diagnostic capability. This includes, but is not limited to, HVAC condensate pumps, sump systems, industrial fluid tanks, aquariums, irrigation systems, and potable water holding devices.

At this point in the cycle, the sensor housing may still be releasing fluid, depending on the rate of leakage and the behavior of the fluid path. It is possible that the alarm module associated with the sensor has not yet been triggered if the leakage rate is slow enough to delay the fluid drop across the alarm threshold. This nuance is essential when considering how the system communicates failure modes to the user.

Upon hearing the alarm and inspecting the device, the user may find the toilet tank empty with no immediate visual evidence of the cause—whether it was a gradual leak or a sudden evacuation event such as a flapper valve failing to close. For example, in response to an audible alarm or toilet failure, a user may instinctively “jiggle the handle”, which can inadvertently dislodge a stuck flapper and obscure the true root cause.

For this reason, the indicator float 27 plays a diagnostic role. If the indicator float 27 remains in the upward visible position, magnetically held between magnets 11, 28, it confirms that the main float did not fall, indicating a slow leak scenario. Conversely, if the indicator float 27 is not visible, it implies the float did descend—consistent with a large or rapid fluid loss such as a flapper valve malfunction or a sudden rapid fluid loss that could be related to an industrial valve being left open, or a storage tank failure resulting in a mass evacuation of fluid. This diagnostic feature enhances the system's utility by allowing users or technicians to quickly and accurately determine the nature of the failure without relying solely on visible water levels or assumptions.

As shown in FIG. 7F, to reset the valve following correction of a leak condition, or to override the automatic shutdown for immediate use, the user may depress knob 8, which mechanically forces the main float downward to the base of the internal container. This manual action disengages the magnetic suspension and positions the float in its valve activation position, thereby re-enabling fluid flow and resuming normal system operation.

Simultaneously, this float displacement is detected by the magnetic switch or sensor array. Once the float is in close proximity to the magnetic switch, a signal is sent to the processor or control unit, indicating that the system has been manually overridden. The processor exits its sleep or shutdown state and enters an active monitoring mode, thereby restoring normal valve operation.

In embodiments incorporating programmable logic, the processor may log the reset event and resume regular cycle tracking, optionally performing a brief test sequence to verify float mobility and fluid responsiveness. In some versions, a visual or audible indicator may briefly activate to confirm a successful reset.

This reset mechanism allows for immediate reactivation of the device without requiring full drainage or disassembly and is particularly useful in emergency or time-sensitive scenarios where restoring water flow is critical.

As shown in FIG. 7G, as fluid begins to rise around the external housing of the device, the float ball 83 within the right-side siphon 81 responds to the increasing fluid level 85 by moving upward into position, effectively sealing the siphon's exit port. This action prevents the siphon from priming such that the air will not be dislodged from its summit unless there is a vast drop in external fluid level surrounding the device. In contrast, the weighted ball 82 within the left-side siphon 80 remains in a lowered position, allowing fluid to enter the siphon's exit port and clearing the air trapped in the siphon's summit priming the siphon at which point the weighted ball is trust upward closing the exit port due to a combination of a vacuum formed by the primed siphon and the fluid pressure of the surrounding body of fluid rising. This difference in ball behavior facilitates a controlled priming sequence between the two siphons, ensuring that fluid entry and exit occur in a deliberate and staged manner.

The differentiated behavior of the two siphon mechanisms—one using a buoyant float ball (right-side siphon) and the other using a weighted, non-buoyant ball (left-side siphon)—creates a sequenced fluid interaction system that manages both the timing of fluid entry into the container and the priming of siphon action.

As fluid rises and surrounds the device, the right-side siphon is sealed early by the buoyant float ball, which rises quickly with the fluid and blocks the exit port. This prevents fluid from prematurely entering the internal container through that siphon path and leaves air trapped in the siphon's summit, rendering it in an un-primed state. Meanwhile, the left-side siphon, equipped with a weighted ball that resists buoyant lift, remains open, allowing fluid to slowly fill around the siphon intake. As the fluid level continues to rise, pressure builds in the left siphon, displacing air from the summit and eventually priming the siphon. Once fully primed, the weighted ball is biased upward against the siphon's exit port sealing it and preventing additional fluid entry into the container. It is biased upward through fluid pressure from the surrounding rising body of fluid and from the primed siphon creating a vacuum once the trapped air was cleared from the summit.

This staggered priming behavior ensures that the float reservoir fills appropriately, helping to overcome the magnetic hold between magnets 31, 29 if a leak condition is not present. By regulating when and how fluid enters the container, the system promotes consistent valve behavior across a range of fill rates and environmental conditions.

The cooperative behavior of the siphons also allows the system to distinguish between normal flush events and abnormal fluid level drops, contributing to the diagnostic accuracy of the float and indicator assemblies.

As shown in FIG. 7H, as the surrounding fluid continues to rise, hydrostatic pressure at the exit port of the left-side siphon 80 increases accordingly. Once sufficient pressure is reached, fluid begins to force the trapped air within the siphon summit upward and out through the intake port into the internal container. This evacuation of air results in the creation of a partial vacuum within the siphon, which in turn draws the weighted float ball upward. As the float ball 82 rises, it moves into a sealing position against the exit port, effectively terminating fluid flow into the container through that siphon. This completes the siphon's priming cycle, enabling it to respond rapidly to subsequent fluid level changes.

At this stage, it is also noted that the indicator float is no longer visible in the assembly. This absence is due to the mechanical interaction between the main float and the indicator float. Specifically, the main float includes a shelf or ledge structure that, during its descent, makes physical contact with the indicator float. This contact forcibly breaks the magnetic connection (e.g., between magnets 11, 28) that had been suspending the indicator float in its upper position. Once the magnetic hold is disrupted, the indicator float falls to the bottom of the chamber, signaling that the main float has dropped—a condition typically associated with a fluid loss event, e.g., a flush cycle, or a system reset.

This interaction ensures that the indicator float serves as a reliable visual diagnostic tool, accurately reflecting the most recent float activity and fluid level dynamics within the container.

As shown in FIG. 7I, following restoration of normal fluid levels—such as after a flush cycle or resolution of a leak—the fluid surrounding the device rises and reestablishes equilibrium with the fluid inside the internal container. As the container refills, the main float is buoyantly lifted back to its upper position, re-engaging any relevant magnetic coupling mechanisms (e.g., between magnets 31, 29). Concurrently, the indicator float also rises, returning to its visible, elevated position as it magnetically reattaches to its corresponding magnet (e.g., magnet 11). This reattachment serves as a visual confirmation that the system has returned to a ready state.

Additionally, the float reservoir is refilled during this process via overflow or directed fluid pathways. The reservoir now contains sufficient fluid to assist in future float activation events and is ready to distribute additives or cleaning agents, if equipped to do so. With all components restored to their default operational positions, the system is fully reset and primed for the next activation sequence.

As shown in FIGS. 7A-7I, the described device utilizes a coordinated system of siphons, floats, magnetic couplings, and reservoirs to manage fluid detection, flow control, and diagnostic signaling with high reliability and minimal energy consumption. Upon a rise in fluid level, the system gradually primes selected siphons through a combination of weighted and buoyant float balls, carefully controlling the timing of fluid entry into the internal container. As the container fills, the main float rises, activating or deactivating the valve accordingly and engaging magnetic indicators for visual status feedback. Once the fluid is restored, the entire assembly resets automatically: siphons re-prime, floats return to their upper positions, magnetic couplings reengage, and the float reservoir is refilled. This closed-loop system provides a self-regulating, low-maintenance solution adaptable to a wide range of fluid management applications beyond toilet tanks, including any environment where float-actuated valves are used.

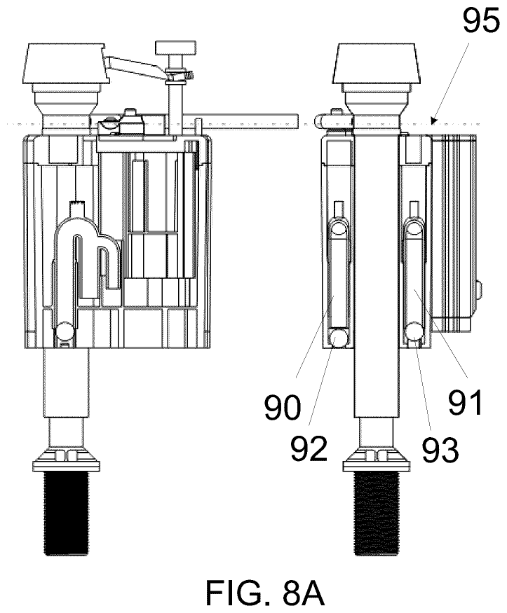

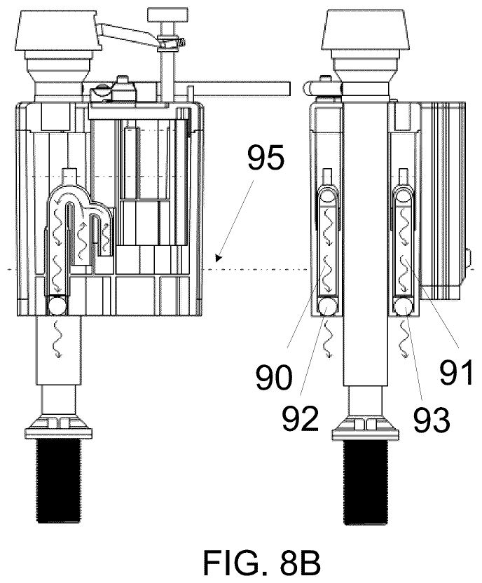

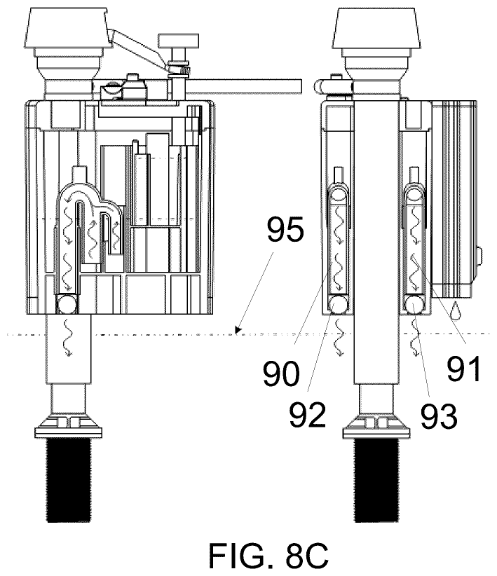

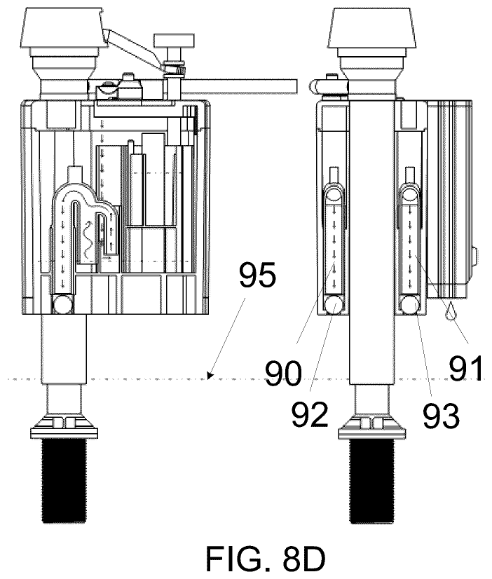

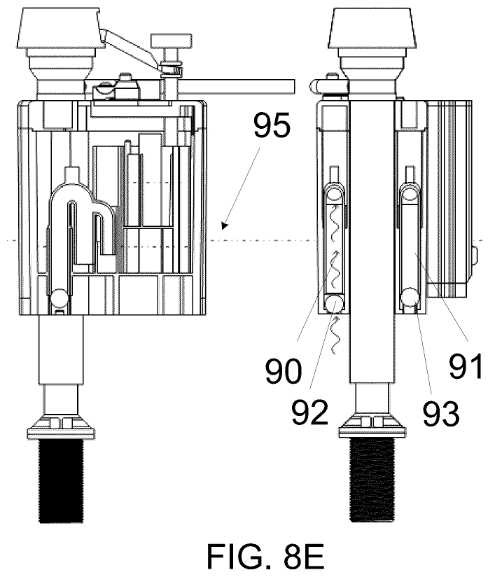

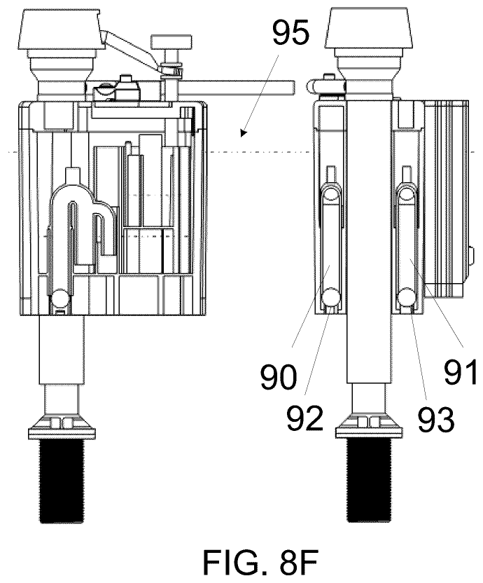

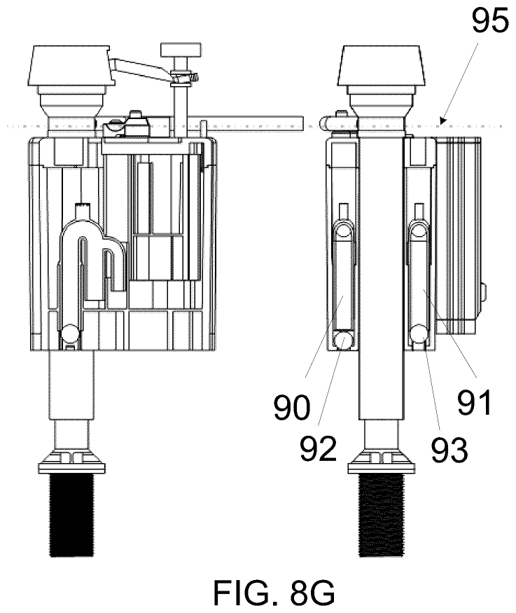

FIGS. 8A-8G show a flush cycle sequence. FIG. 8A shows the state of the device and the water level at the start of a normal flush cycle. At the start of a normal flush cycle, the fluid level 95 within the surrounding tank or body of water is at its maximum, having been fully restored following the previous cycle. The activation lever is in the on position, the valve assembly is in the off position, with the main float held in the upper position due to buoyant force and, if applicable, magnetic retention (e.g., between magnets 31, 29). The indicator float, if present, is likewise held in the elevated position by magnetic engagement and buoyant forces. The left siphon 90 is in a primed or standby state, and the float reservoir is full, prepared to deliver any additive agents if configured to do so.

The cycle is initiated by the actuation of the toilet's flush mechanism, which causes a rapid drop in the surrounding water level. As the fluid begins to evacuate the surrounding tank, a differential pressure develops between the interior and exterior of the container, and this initiates a cascading sequence of mechanical and hydraulic events within the device, as detailed in the following sections.

As shown in FIG. 8B, as the surrounding fluid level 95 drops during a standard flush cycle, the fluid within the internal container begins to evacuate through both the left and right siphons 90, 91. The rapid decline in external fluid level creates a pressure differential that activates the siphons 90, 91. In this scenario, the weight of the fluid inside the container is sufficient to displace any trapped air in the summit of the right-side siphon, allowing it to prime and begin fluid transfer into the surrounding tank. This contrasts with slower leak conditions, where the right siphon typically remains inactive due to retained air.

Simultaneously, a staged rate of evacuation is observed across the three distinct fluid bodies within the system. The surrounding fluid exits most rapidly, driven directly by the flush event. The fluid within the internal container follows at a moderate pace, regulated by siphon geometry and internal flow paths. Lastly, the float reservoir drains at the slowest rate due to flow-restrictive features and its limited cross-sectional area. These varied rates of fluid movement are integral to the proper timing of float activation and overall system responsiveness, ensuring reliable operation under both normal and abnormal fluid level changes. In various embodiments, the various port sizes and materials impeding fluid flow can be altered or adjusted to increase and decrease these various rates.

As shown in FIG. 8C, the surrounding fluid level undergoes a rapid drop, representative of a full evacuation event such as a toilet flush. As this occurs, the fluid level within the internal container begins to fall, though at a delayed rate relative to the external environment. This delay is a designed feature that enhances water conservation in toilet tank applications. By maintaining the container's fluid level longer than the surrounding tank, the system allows the toilet tank to empty more completely before triggering valve actuation. Depending on design settings, the float may be held suspended until the tank is nearly or entirely drained, thereby preventing the valve from opening prematurely and minimizing unnecessary water replenishment during the flush cycle. This ensures that water is only reintroduced once the toilet flap has closed, maximizing efficiency by avoiding redundant fluid entry while the tank is still discharging.

Concurrently, the float reservoir within the device also experiences a drop in fluid level, though at an even slower rate than the internal container. This multi-stage drainage provides stability and sequencing critical to system function. As the main float descends, it makes mechanical contact with the indicator float, disengaging its magnetic hold and causing the indicator to fall to its lower position. This interaction serves as a historical indicator of float movement, aiding in post-event diagnostics.

Additionally, the sensor housing begins releasing fluid during this process. However, the float within the sensor housing remains buoyantly supported for an extended duration, due to the housing's controlled release design. This ensures that the processor remains in an inactive or sleep state during routine flush cycles, preventing false alarms or unnecessary power consumption. Only when fluid has been lost for an abnormal duration—such as in a slow leak scenario—will the sensor float drop sufficiently to activate the processor and trigger an alert.

As shown in FIG. 8D, following complete drainage of fluid from the internal container through the siphons, the fluid level within the container falls below the level of a siphon cavity-identified as a cylindrical chamber located off the floor of the container. This configuration permits air to enter a secondary intake port situated on the siphon, while the primary intake remains submerged in fluid. The introduction of air through the secondary intake into the siphon's summit disrupts and terminates the siphon action. In one embodiment, the height of the cylindrical chamber can be altered to leave more or less fluid in the container when the siphon action stops. It is an internal adjustment used for fine tuning.

The design leverages fluid flow dynamics wherein fluid movement through the primary intake generates a strong draft effect, effectively pulling air from the secondary intake into the siphon's summit with considerable force—analogous to the merging of two lanes of traffic into one. This unique air ingress method ensures a rapid and reliable cessation of siphon action once fluid levels reach a critical low.

This siphon configuration addresses a significant drawback of conventional siphons, which typically continue to draw fluid indiscriminately once activated, thereby preventing the main float from ascending to the upper “off” position and prematurely ending the flush cycle. By employing this dual-intake siphon with an air admission cavity, the siphon action is actively “killed,” allowing the float to reset and the valve system to fully close.

The siphon cavity acts as a physical barrier, isolating the surrounding fluid from the secondary intake while simultaneously providing a passage for air ingress into the siphon. This design element is novel and may constitute a patentable feature. Detailed drawings of this siphon assembly can be provided to further illustrate the unique construction and operation.

As shown in FIG. 8E, as the surrounding fluid begins to refill around the device, the right-side siphon, equipped with a floating ball, moves into position to block its exit port. Meanwhile, the left-side siphon 90, which utilizes a weighted ball 92, remains in the downward position, permitting fluid pressure to build at the exit port and allowing fluid to continue entering the siphon 90. This differential behavior between the two siphons 90, 91 facilitates controlled fluid movement within the device during the refill phase.

As shown in FIG. 8F, fluid surrounding the device has risen sufficiently to generate enough pressure to expel the air trapped in the summit of the left siphon 90. This pressure differential creates a vacuum effect that draws the weighted ball 92 into the exit port, thereby blocking further fluid flow into the container. Concurrently, fluid levels within both the main container and the float reservoir are observed to be changing. This change results from fluid draining from the float reservoir into the main container, a process that occurs independently of the fluid level fluctuations in the surrounding toilet tank. This controlled fluid transfer contributes to the precise regulation of the float's buoyancy and overall device operation.

As shown in FIG. 8G, the cycle is complete, with the surrounding fluid level having returned to its initial starting position, thereby restoring the system to its ready state.

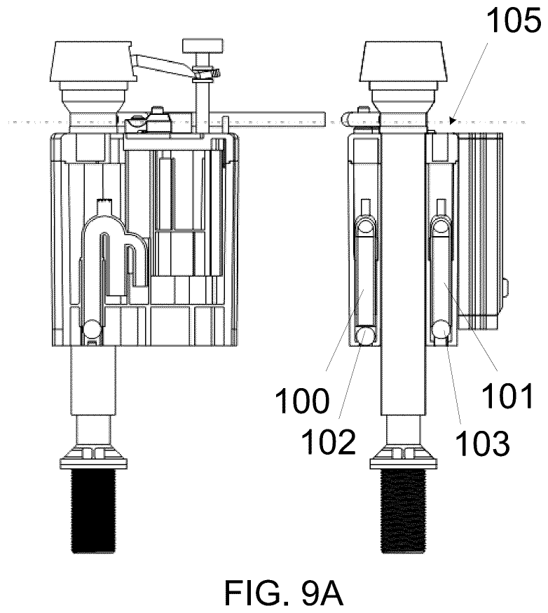

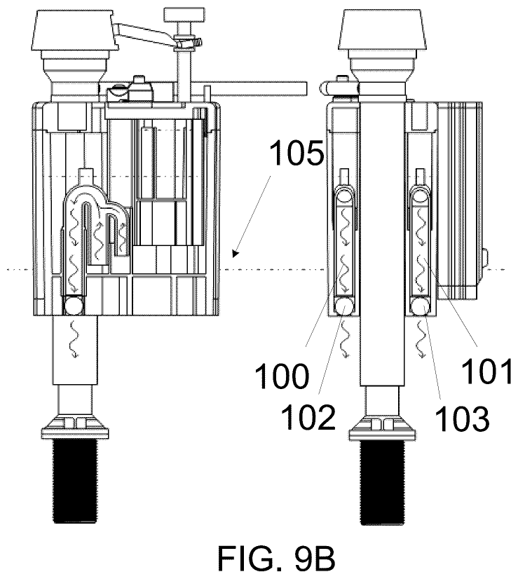

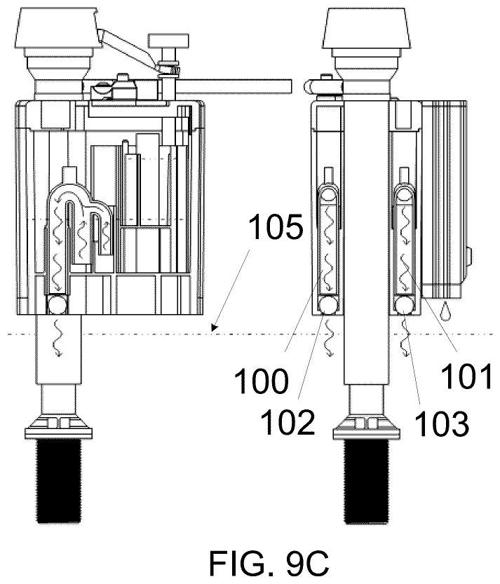

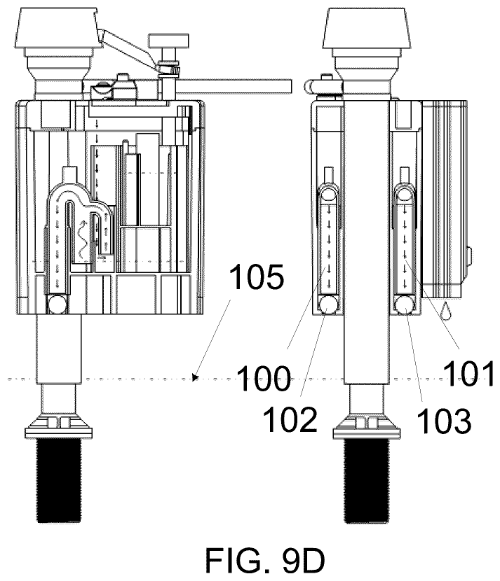

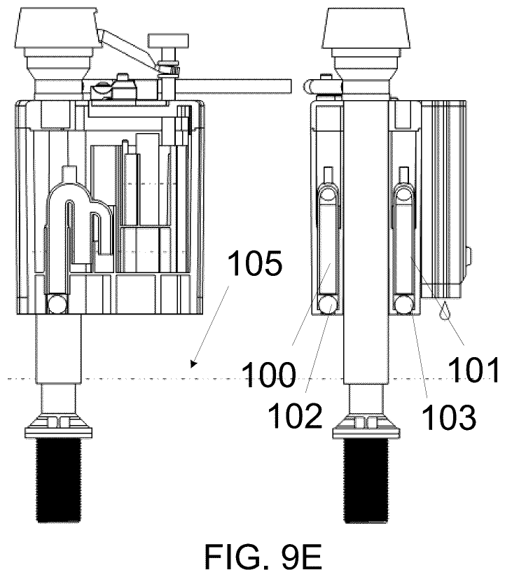

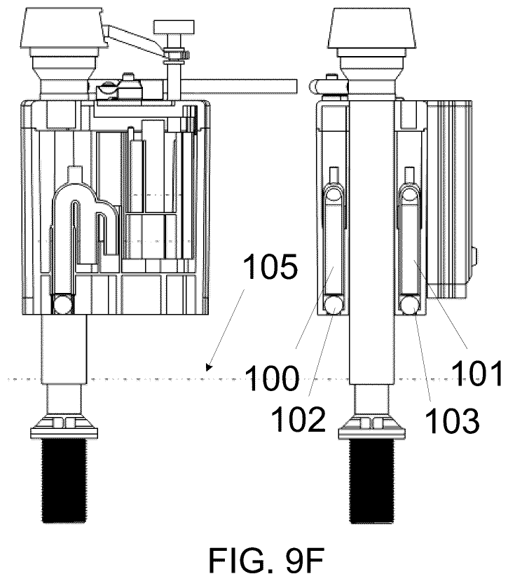

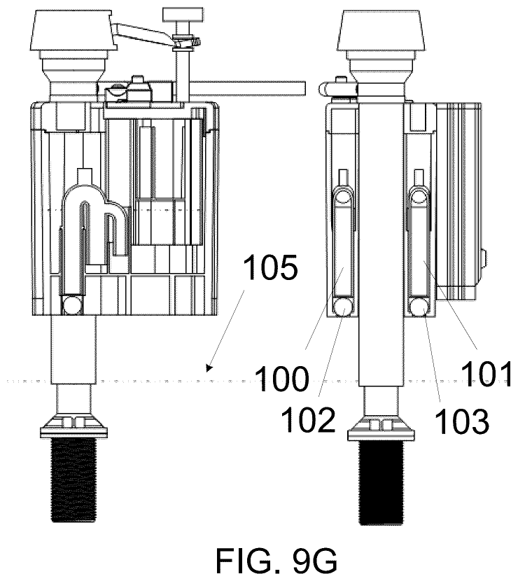

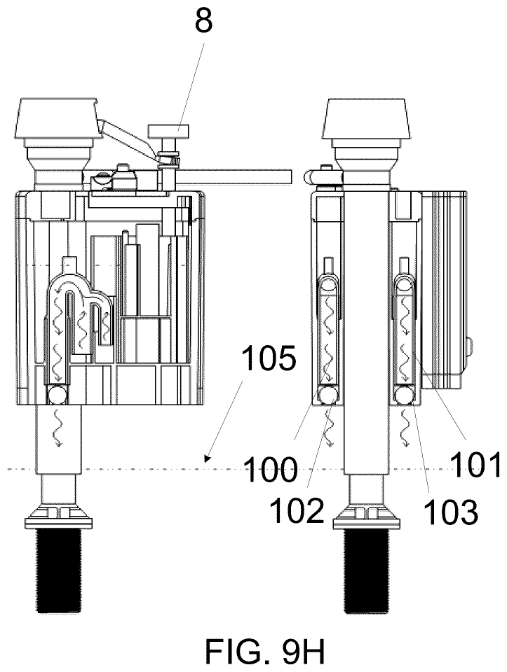

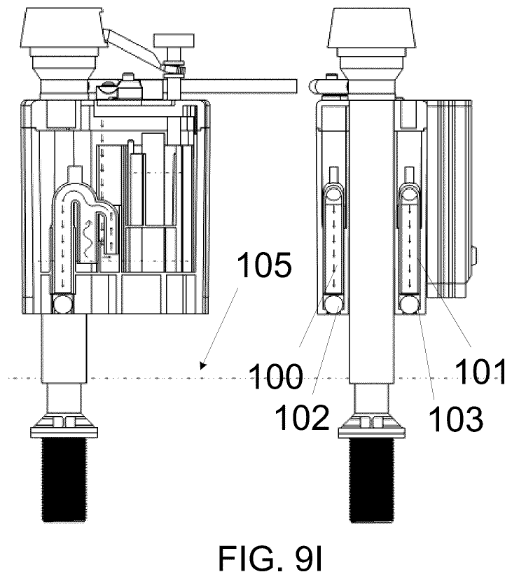

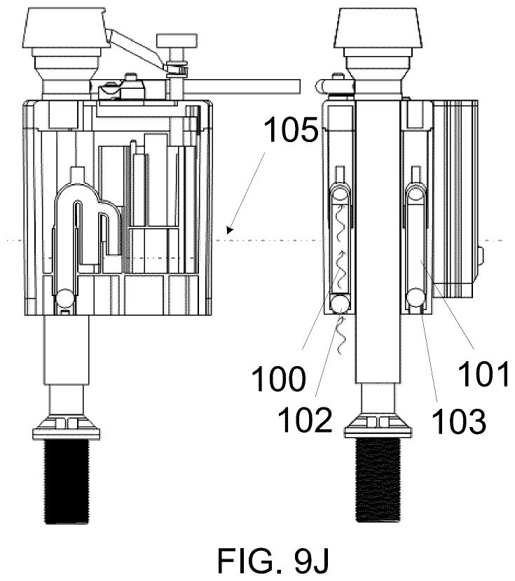

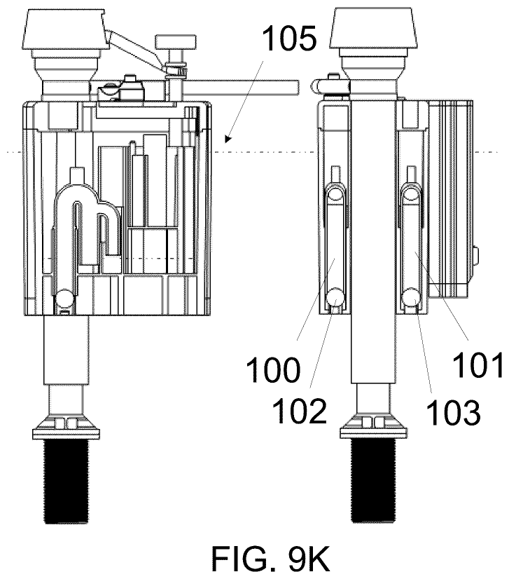

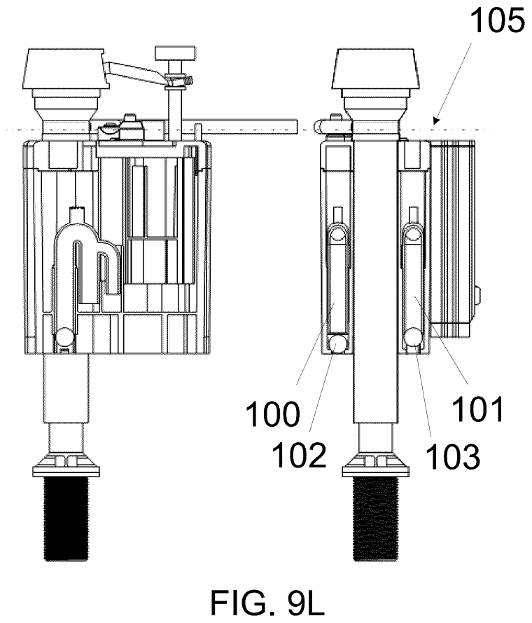

FIGS. 9A-9L shows a shut-off cycle sequence. In particular, FIGS. 9A-9L demonstrate the device's automatic shutoff function in the event of a failure of the flap to close, resulting in a sustained and substantial evacuation of the surrounding fluid without subsequent refilling. This feature is particularly relevant for use in holding tanks and similar fluid management systems, where uninterrupted fluid loss must be detected and controlled to prevent overflow or system malfunction.

FIG. 9A depicts the initial state of the device and the surrounding fluid level prior to the onset of fluid evacuation. The main float and associated components are positioned in their default, fully reset positions, and the fluid within the container, float reservoir, and surrounding body are at equilibrium

As shown in FIG. 9B, the surrounding fluid level 105 begins to drop rapidly, initiating activation of the siphons 100, 101 and resulting in the expulsion of fluid from the internal container. During this process, all float balls 102, 103—including those designed to be buoyant—are forced downward by the force of fluid evacuation and pressure differentials, enabling continuous fluid flow through the siphon paths.

As illustrated in FIG. 9C, the surrounding fluid level 105 continues to decline, resulting in sufficient fluid evacuation from the internal container to cause the main float to descend. The float is only capable of overcoming the magnetic connection between magnets when it is filled with fluid and has acquired adequate weight. Once this threshold is met, the float breaks free from the magnetic hold and moves downward, initiating the valve's activation sequence.

As shown in FIG. 9D, the surrounding fluid level 105 continues to decline, and the fluid within the container has been fully evacuated. At this stage, air is drawn into the siphon intakes, particularly at the summits, effectively breaking the siphon action and terminating further fluid transfer. This siphon deactivation prevents continued draw from the container once it is emptied, stabilizing the system in preparation for the next fluid event or operational cycle.

As shown in FIG. 9E, following siphon deactivation, fluid begins to transfer incrementally from the float reservoir into the internal container. Each small transfer incrementally reduces the weight of the float while simultaneously increasing the fluid volume surrounding it, thereby enhancing its buoyancy. This gradual change facilitates the float's return toward its original raised position. Concurrently, the sensor housing continues to expel fluid; over time, the absence of fluid surrounding the sensor activates the processor, which in turn issues a notification to the user and may initiate one or more associated alert mechanisms.

As depicted in FIG. 9F, the float reservoir continues to discharge fluid into the container, further reducing the mass of the main float and enhancing its buoyancy. Combined with the influence of magnetic forces acting upon it, the float begins to rise within the container. At this stage, the sensor housing has fully expelled its fluid contents and is now in a dry state. This condition triggers the activation of the onboard processor, which transmits alerts to the user via a digital interface and initiates various audible or visual alarm mechanisms integrated into the device. These alerts serve to inform the user of a prolonged fluid loss event indicative of a flap failure or other system fault

As shown in FIG. 9G, the main float has returned to its uppermost position within the container, thereby re-establishing the magnetic hold between magnets 31, 29 and rendering the valve in the “off” state. Notably, the indicator float remains at the bottom of the tank and has not returned to its elevated position. As a result, the visual indicator associated with the indicator float is not visible, signifying that an emergency event—such as a prolonged or abnormal fluid evacuation—occurred. This visual discrepancy provides diagnostic information to the user upon inspection, differentiating between normal and fault conditions.

In FIG. 9H, the knob 8 has been manually depressed by the user. This action exerts downward force on the float, displacing fluid from beneath it and causing the internal water level within the container to rise. Once the fluid level exceeds the summit height of the siphons, the increased hydrostatic pressure initiates siphon activation. As a result, fluid begins to drain from the container through the siphon pathways. This manual reset procedure facilitates system reactivation following an emergency shutoff, allowing the valve to re-engage normal operational cycles.

As shown in FIG. 9I, as fluid continues to evacuate from the internal container through the siphons, the fluid level 105 progressively declines. Once the fluid level falls below the siphon cavity intake threshold, air is introduced into the siphon system 90, 91, specifically at the summit region. The entrainment of air into the siphon pathways disrupts the vacuum pressure required to sustain flow, thereby terminating the siphon action and halting further fluid transfer from the container.

As illustrated in FIG. 9J, the surrounding fluid level 105 begins to rise, initiating the refilling process of the toilet tank or associated fluid-holding chamber. This increase in ambient water level exerts hydrostatic pressure on the exterior of the container, setting the stage for reactivation of the left siphon and refilling of the internal float reservoir, as fluid communication pathways are gradually reestablished.

In FIG. 9K, the surrounding fluid level 105 continues to rise, further increasing hydrostatic pressure on the container and associated components. As the water level ascends fluid pressure has cleared the air in the left siphon summit and has propelled the weighted float ball upward against the exit preventing further fluid entry ..

As depicted in FIG. 9L, the surrounding fluid level 105 has fully returned to its initial position, completing the refilling cycle. The internal container and float reservoir are refilled, allowing the main float to return to its upper position and the valve to be rendered ready for normal operation. Additionally, the sensor housing has replenished its fluid content, effectively resetting the sensor and preparing the system for subsequent leak detection and monitoring.

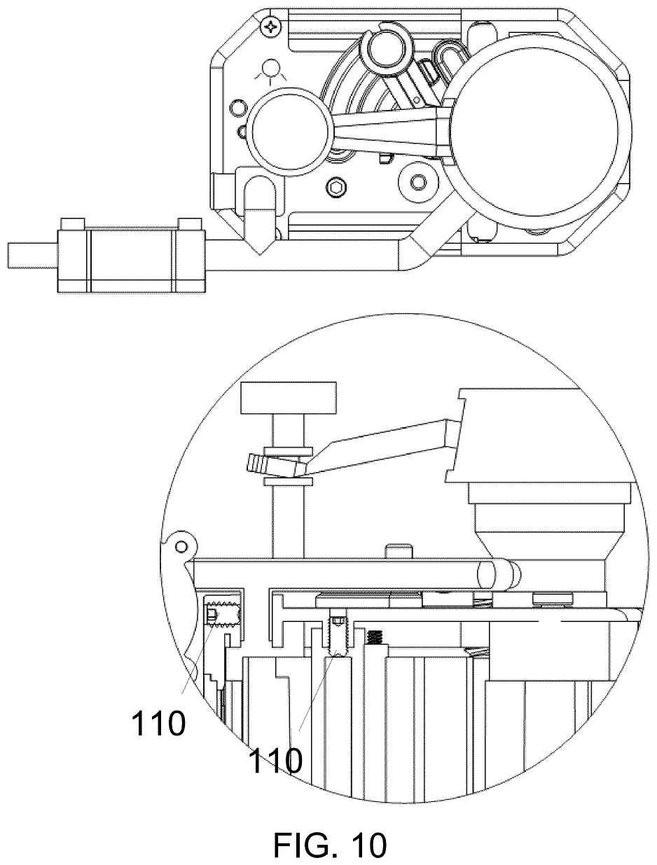

FIG. 10 depicts one embodiment of a device with adjustable set screws. In certain embodiments, the device may include set screws 110 to enable user adjustment and to secure various adjustable components in place after calibration. The incorporation of set screws 110 allows for precise mechanical tuning of system parameters such as fluid level, float position, and flow rate, while ensuring that these parameters remain fixed during normal operation. This design feature enhances stability, repeatability, and user control, particularly in environments subject to vibration, pressure fluctuations, or mechanical movement.

For instance, the setscrew shown in FIG. 10 may be configured for adjusting the final upward resting position of the float. By moving the float further away from the magnet in the activation lever, it requires less weight to break the magnetic connection. For example, if the float is in the top-most position possible, it might require its full weight to break the connection which means the float can't suffer any fluid loss; however, if the set screw pushed the float further away from the top lever magnet it might only need half its fluid weight to break the connection allowing two inches of fluid loss while still being able to operate.

In another example, a set screw 110 may be incorporated into the mounting collar or base associated with the adjustable shaft, which is used to set the overall height of the device relative to the fluid tank. This configuration allows the user to select a desired fluid activation level and then lock the shaft in position, thereby maintaining the operational height of the valve mechanism regardless of external disturbances. Similarly, a set screw 110 may be used to secure the adjustable float shaft, which influences the initial position and movement range of the internal float. By locking the float shaft, the activation threshold of the valve can be precisely maintained over repeated cycles.

Additionally, set screws 110 may be utilized in flow control components, including the fluid tube adjustment and the container drip tube adjustment. These components regulate the flow of fluid into various parts of the system. Incorporating set screws into these adjustable mechanisms permits the user to calibrate flow rates to a desired level and then lock the adjustment to prevent unintended changes caused by vibration or handling. In systems requiring consistent fluid delivery or timed refill cycles, this configuration enhances performance reliability without reliance on electronic monitoring.

Further embodiments may include set screws 110 within the siphon guide track, which is used to position and align siphon tubes responsible for regulating fluid ingress and egress. By locking the siphon assemblies in place with set screws 110, variations in siphon height and orientation can be prevented, preserving the designed delay or fluid transfer profile during operation. This is particularly advantageous in systems utilizing multiple siphons or requiring precise timing of siphon cutoff.

To ensure long-term durability and compatibility with fluid environments, the set screws may be constructed of corrosion-resistant materials such as stainless steel or engineered polymers. In configurations where set screws 110 intersect with fluid-contacting surfaces, sealing mechanisms such as O-rings or gaskets may be employed to prevent fluid leakage. The set screws are positioned in accessible locations to facilitate easy adjustment and locking by the user, typically using standard tools such as Allen wrenches.

The inclusion of set screws 110 in these adjustable features provides a mechanically simple yet highly effective means of enhancing the configurability and robustness of the device. It supports both manual and semi-automated operation modes and is particularly beneficial in embodiments where electrical components are limited or omitted.

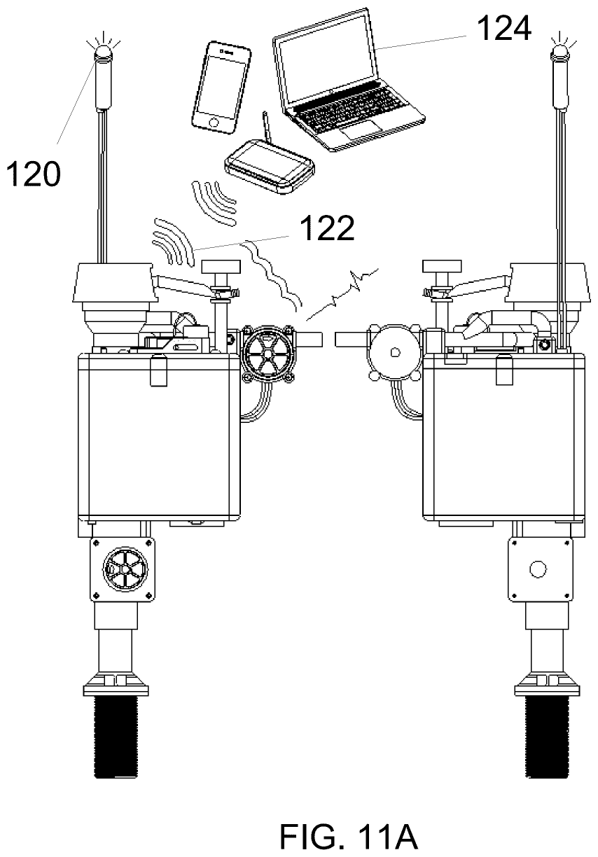

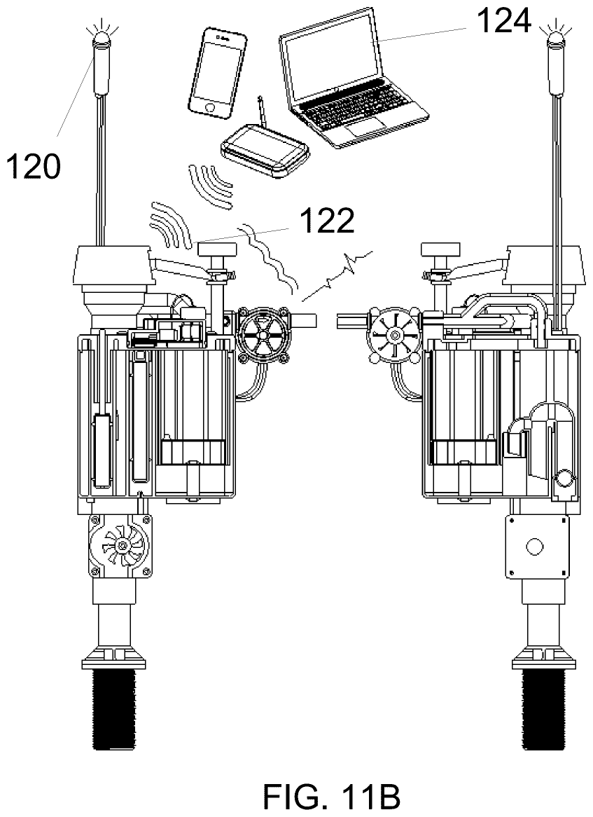

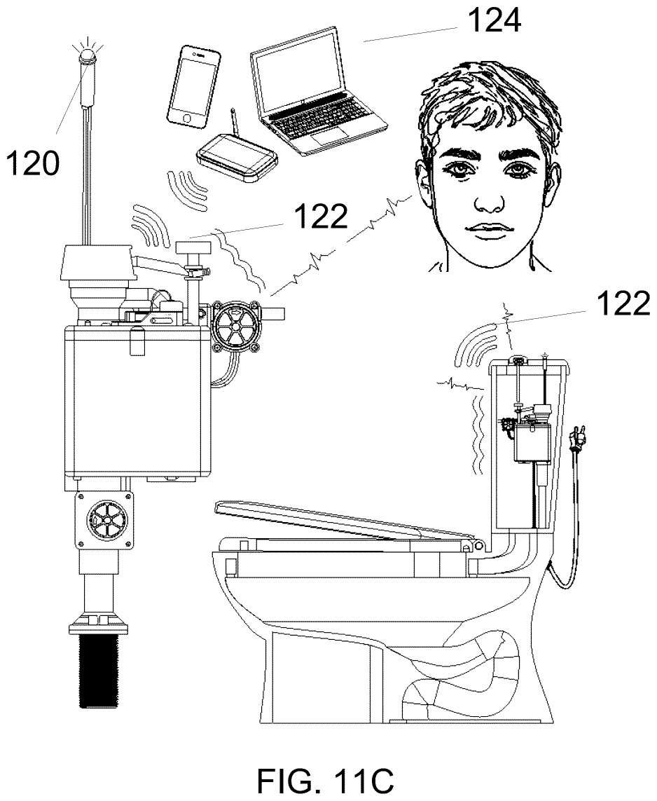

FIGS. 11A-11C illustrate an embodiment of the device that includes additional electronic features. The additional electronic features are integrated or built into the device to enhance functionality, monitoring, and user interaction. These features include, but are not limited to, a computer processor, signal transmission and reception components, an indicator light, an alarm system with audible and vibration output, an electromagnet, an on/off switch, a generator, a flow meter, a hard-wired power source, and an external reset mechanism, e.g., built into the toilet tank lid. This embodiment illustrates an enhanced, electronically integrated system without limiting the device to only the features described herein.

Upon activation of the electronic components, typically triggered by the movement of the sensor float, electrical current is distributed to the various integrated systems. When the sensor float reaches a defined fluid level, it actuates a magnetically activated switch, which in turn activates the indicator light 120 to visually signal that a specific fluid level has been reached. In addition to the visual cue, an audible signal may be emitted from the alarm, enabling local users to be notified of the fluid status.

For remote notification, the device is capable of transmitting signals 122 to an external electronic device 124, allowing users to receive alerts or data regarding fluid levels even when physically distant from the device. The alarm system can also emit vibration signals, which serve dual purposes: first, to alert users through tactile feedback, particularly beneficial for individuals with hearing impairments; and second, to mechanically assist in dislodging stuck components or to help initiate an activation cycle, especially in cases where the float may be temporarily magnetically suspended.

The computer processor acts as the central control unit, capable of executing a range of programmed instructions based on fluid levels or user input. For example, the processor may be configured to activate the electromagnet, causing it to either attract or repel the float magnet to move the float into the top or bottom position, effectively controlling the valve state. The electromagnet may be used in an attracting configuration to pull the float upward, or in a repelling configuration to push the float downward, thereby enabling automatic or user-triggered activation/deactivation of fluid flow.

The flow meter continuously monitors the volume and rate of fluid passing through the system. This data can be processed, stored, and transmitted by the processor to external devices for user analysis, record-keeping, or further automated control. Conversely, incoming transmissions can be received by the processor to change the operational state of the system based on user commands, allowing remote control over the device's activation or deactivation.

An on/off switch is provided to allow the user to manually enable or disable the electronic components of the device as desired. This is particularly beneficial in cases where users may wish to operate the device in a non-electronic, purely mechanical mode, or to conserve power.

Power for the electronic features may be supplied through batteries, a hard-wired electrical connection, or a generator. These power sources may function independently or in conjunction, providing operational redundancy. In addition, the device may be equipped to operate using alternative energy sources, such as solar or wind power, enabling usage in off-grid or remote environments where conventional power is not available.

An external reset mechanism may be incorporated, e.g., into a tank lid, allowing the user to reset the device without opening or directly accessing the internal components. This feature is particularly useful in sealed or difficult-to-access installations, improving user convenience and maintaining system integrity.

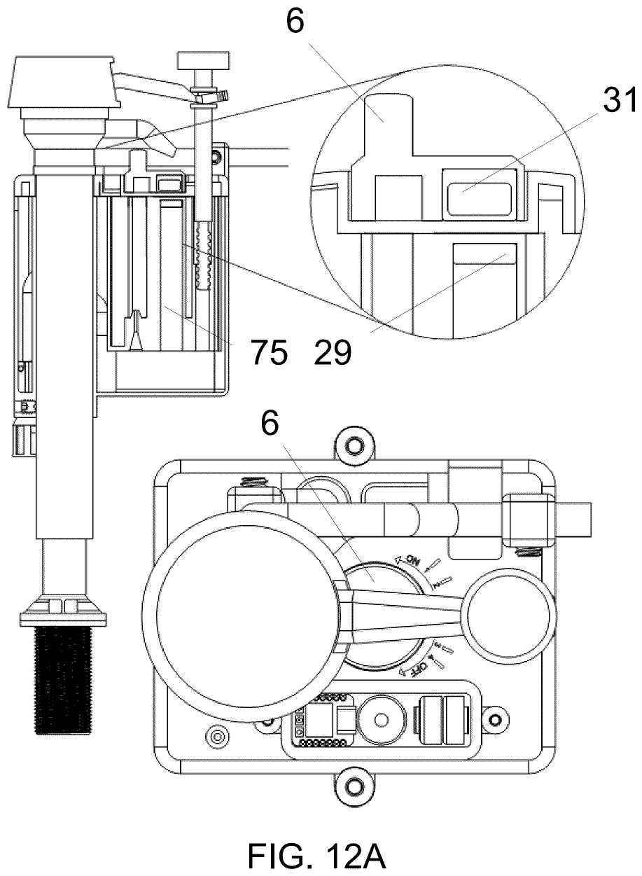

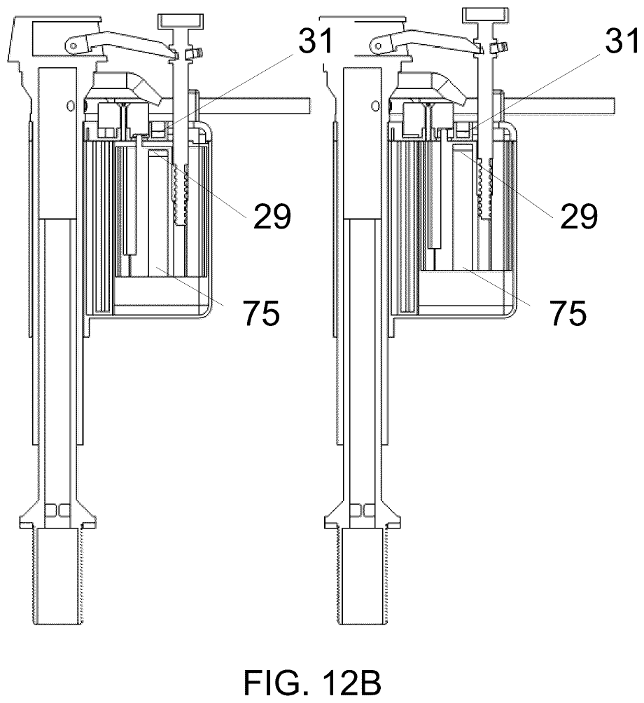

FIG. 12A illustrates an embodiment of the device that includes an adjustment knob. In one embodiment, the adjustment knob 6 is configured to modulate the magnetic interaction between magnets 29, 31, which are respectively affixed to a fixed structure and the float. The user-adjustable knob 6 permits manual rotation that alters the alignment of the magnets. By adjusting this alignment, the user can increase or decrease the magnetic holding force between magnets 29 and 31, thereby directly influencing the float's movement and the fluid level at which the valve is actuated.

When the magnets 29, 31 are aligned for maximum magnetic attraction, a greater weight or fluid displacement is required to overcome the magnetic bond and permit the float 75 to descend. This setting delays the activation of the valve until a larger volume of fluid has been lost from the surrounding environment. Specifically, as the fluid surrounding the container begins to recede, fluid within container is displaced through its ports, causing a drop in the internal fluid level. Concurrently, fluid from the internal float reservoir drains into the main container, reducing the weight of the float 75. Even under conditions of rapid fluid evacuation from around container, the float 75 may remain suspended in the upper position due to the strong magnetic attraction, preventing premature valve activation.

Conversely, when the user rotates the knob 6 to reduce the magnetic force, the magnetic bond between the magnets 29, 31 becomes easier to overcome. In this configuration, less weight is needed to cause the float to disengage from its held position, allowing it to descend and trigger the valve at an earlier stage of fluid loss. This adjustability enables the user to customize the response threshold of the float mechanism, ensuring that the system activates appropriately under varying environmental or operational conditions.

Additionally, in certain applications, it may be desirable to completely eliminate or minimize the magnetic influence between the magnets, 29, 31 such that the float 75 moves freely with the fluid level inside container, unimpeded by magnetic attraction or repulsion. This mode of operation allows for real-time tracking of fluid changes, independent of magnetic intervention.

Moreover, the alignment of the magnets 29, 31 not only affects the magnetic hold at the upper position but also influences the dynamics of float return. Specifically, when transitioning from the downward to the upward position, the magnetic attraction or repulsion can assist or resist the float's ascent. In configurations where magnetic assistance is reduced or eliminated, greater buoyant force (i.e., more fluid in the container) is required to return the float 75 to its upper position, providing further tunability of the system's response characteristics.

This adjustable feature thus allows for fine calibration of the device's operational parameters, enhancing its versatility across a range of applications and fluid dynamics scenarios.

FIG. 12B illustrates a device with a variation of the adjustment knob. In one embodiment, rotational movement of the adjustment knob 6 results in a change in the vertical distance between the magnets 29, 31 when the float 75 is in its upper or rest position. By altering this distance, the user can modulate the magnetic force exerted between the two magnets, which directly affects the amount of combined weight—that of the float 75 and the fluid within the internal reservoir—required to overcome the magnetic hold and initiate downward movement of the float.

As the distance between the magnets 29, 31 is increased through rotation of knob 6, the magnetic force weakens, thereby reducing the total mass required to break the magnetic bond. This enables the device to activate the valve even when the surrounding fluid level has fallen to a relatively lower point, provided that the fluid retained in the float's reservoir is still sufficient to create the necessary downward force. This is especially useful during fluid evacuation scenarios, where external water levels may drop rapidly, but internal reservoir retention enables accurate system triggering.

Conversely, by rotating the knob 6 to decrease the distance between the magnets 29, 31, the magnetic attraction is maximized, requiring the greatest amount of combined weight to disengage the float from the top position. This configuration doesn't allow the float to fall if minor fluid loss is suffered as it needs a majority of its combined fluid weight to break the increased magnetic hold. Such adjustability allows for custom tuning of the system's sensitivity to changes in surrounding fluid levels.

In configurations where the distance between magnets 29, 31 is set to the maximum, the magnetic force may become negligible or effectively absent, allowing the float 75 to freely rise and fall with the water level in container and around the float 75, uninhibited by magnetic retention. This mode may be particularly advantageous in circumstances where a known or temporary leak is present and it is desirable for the system to continue operating despite the presence of low fluid levels. In such a scenario, maintaining valve operation until repair can be performed may prevent undesired interruption of system function.

This adjustable mechanism offers a precise and flexible means of controlling float behavior, enabling the user to tailor device response to match specific operational requirements or fluid management strategies.

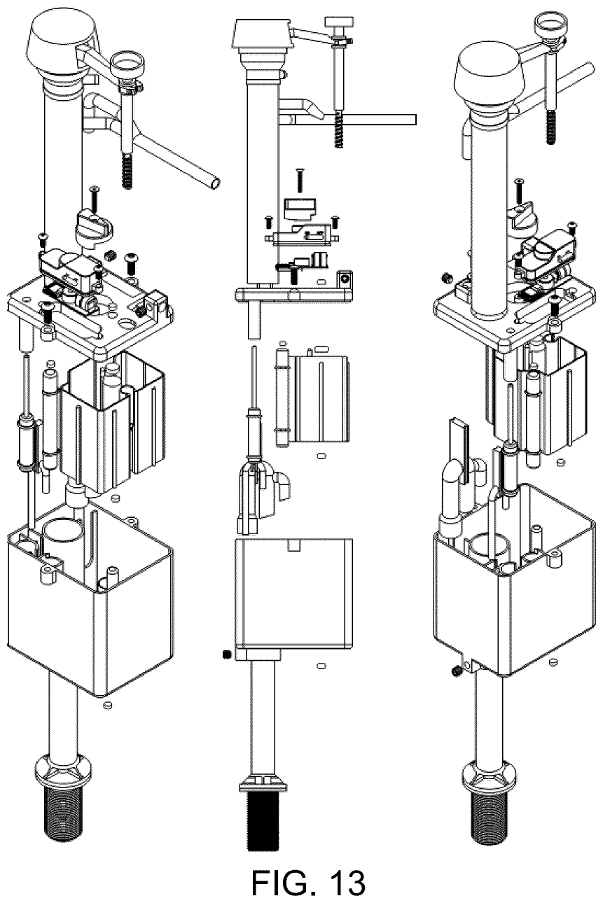

FIG. 13 illustrates an exploded view of the valve assembly used in the disclosed device, e.g., as described above with references to the previous figures, revealing the internal mechanical components and their functional relationships. This breakdown highlights how individual elements work together to regulate fluid flow in response to float position, magnetic influence, and manual or electronic inputs.

At the center of the exploded view is the valve body, which serves as the main structural component through which fluid flows. This housing includes internal inlet and outlet channels, seating surfaces, and seals that manage the passage and shutoff of fluid. Attached to this body is the valve lever, which acts as a mechanical actuator. It toggles the valve open or closed based on input from the float assembly, which rises or falls with changes in fluid level.

Above the valve lever, the float linkage assembly connects the float to the valve mechanism. This includes a threaded adjustment knob, which enables users to fine-tune the float's travel distance and sensitivity. Motion from the float is transferred through this linkage to trigger the lever, which in turn actuates the valve. Embedded magnets may also be present within this linkage, providing magnetic attraction or repulsion that either aids or resists float movement.

In some embodiments, the exploded view will include parts of the drip adjustment system, including a dedicated drip line and adjustment knob. These components regulate the controlled inflow of fluid into the device after activation, influencing how quickly the float fills and thereby affecting the device's timing and sensitivity. Additionally, the assembly may show openings or interfaces for the removable sensor housing, allowing for monitoring electronics to be integrated without interfering directly with valve mechanics.

Overall, the exploded view in FIG. 13 provides a clear depiction of how each mechanical and magnetic component fits together within the valve system. It supports understanding of serviceability, assembly, and user-adjustable features for applications ranging from toilet tanks to animal waterers and swimming pools.

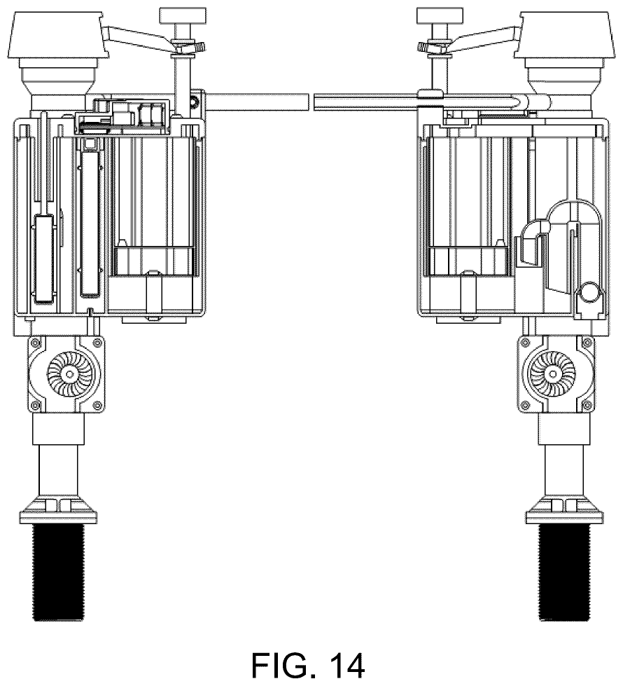

FIG. 14 depicts detailed cross-sectional views of the device from the left and right sides, providing an in-depth illustration of the internal mechanisms and fluid pathways that govern its operation. The illustrated device may be substantially similar to the devices described above, with reference to the previous figures.

The left cross-sectional view prominently displays the vertical alignment and interaction between the float assembly, activation lever, and valve lever within the housing. The float, positioned inside the internal fluid chamber, responds to changes in fluid level by moving vertically. This movement is transferred mechanically through the adjustment knob, which connects the float to the activation lever and valve body. The adjustment knob allows users to fine-tune the float's travel range and sensitivity, directly influencing when the valve opens or closes.

The activation lever itself is depicted with its magnetic components and shows how pivoting the lever adjusts the magnetic force acting on the float-enabling attraction, repulsion, or disengagement. This magnetic control modifies the float's position and the subsequent mechanical linkage to the valve lever, which ultimately actuates the valve (1) to control fluid flow through the device.

Additionally, this view shows the weight mechanism within the float assembly that can be released or reattached by the activation lever to influence the buoyancy of the float. When the activation lever is returned to the “on” position, the weight is secured to the lid, relieving pressure on the float to allow normal operation.

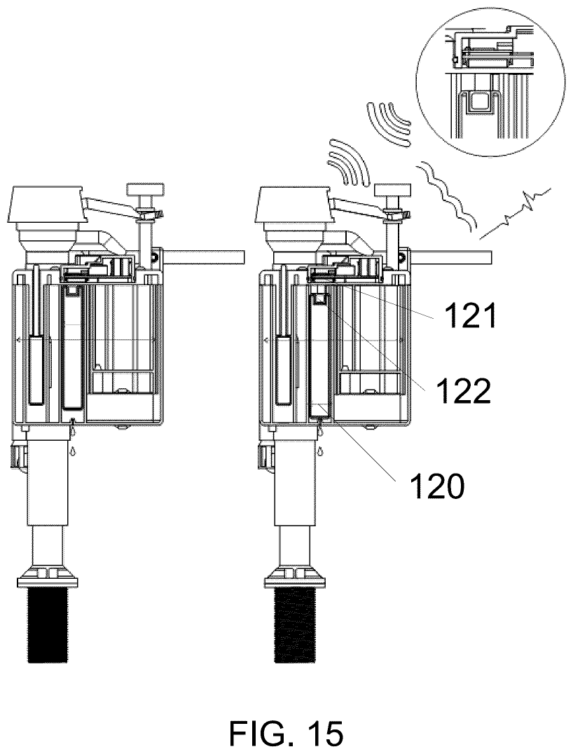

FIG. 15 illustrates an embodiment of the device with a sensor float. In one embodiment, the sensor float 120 in its activated, downward position, triggers the operation of various electrical components of the device. Notably, the fluid contained within the sensor float chamber is isolated from the main fluid volume within the container. This isolation permits the fluid inside the sensor float chamber to continue draining even when fluid flow from the container has ceased. A port located at the top of the sensor float chamber allows for entry of fluid once the surrounding fluid level has risen sufficiently to overflow into the container.

Upon reaching the lower position, the sensor float activates electrical features such as alarms, indicator lights, or data transmission components. These features are designed to deactivate automatically when the float returns to the top position. Additionally, the system includes a manual on/off switch enabling user control over the activation of electronic elements.

As shown in FIG. 15, this sensor design is configured to activate upon the separation of two magnetic components: the float magnet 122 and the magnetic switch 121 located on the processor board. Specifically, the sensor is triggered when the float 120 descends, thereby breaking magnetic contact between these two elements. In one embodiment, this operational logic is the inverse of the configuration employed in the removable model described above, in which activation occurs when the float magnet and the processor's magnetic switch come into contact. In contrast, the present variation relies on disengagement to initiate sensor activity, resulting in a distinct activation sequence that may offer advantages in certain applications where detection of float displacement is more critical than confirmation of float engagement.

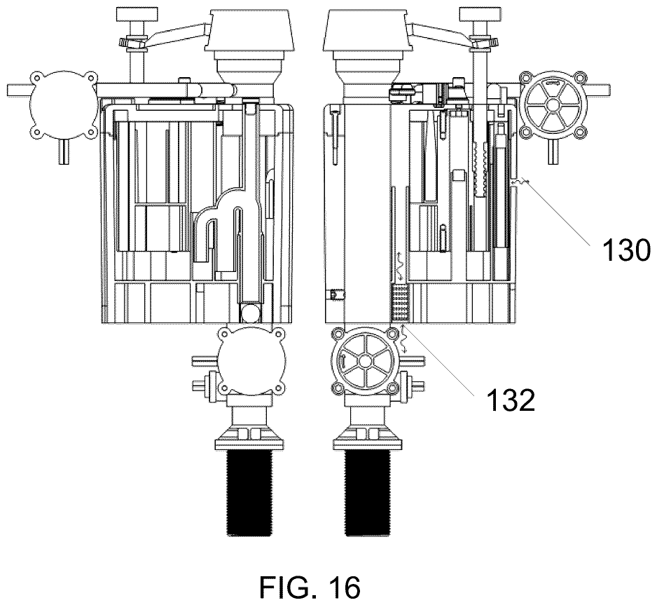

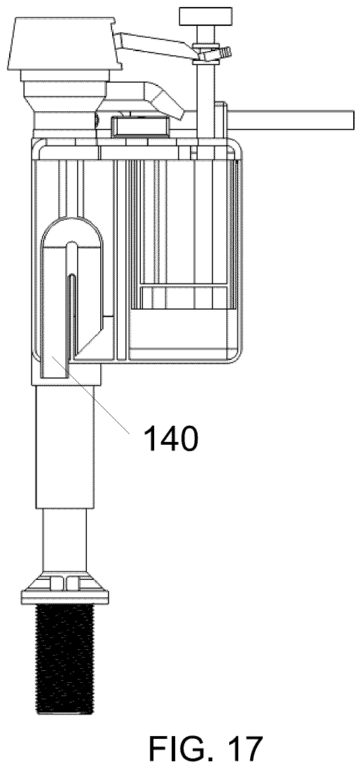

FIG. 16 illustrates an alternative configuration for permitting the ingress and egress of fluid within the container of the device. In one embodiment, a side-mounted port 130 is positioned along the wall of the container. In another embodiment, a tube port 132 is installed at or near the floor of the container. Each of these ports may optionally incorporate filter material, which can serve dual purposes: functioning as a conventional fluid filter or as a means to modulate the rate of fluid flow through the port.

Under normal operational conditions, such as during a flush cycle, fluid exits the container rapidly via siphon mechanisms. Due to the high velocity of evacuation in such instances, the presence of these additional ports has minimal impact on the total fluid volume displaced during the cycle. However, in scenarios involving slow fluid leaks, these auxiliary ports become significantly more functional. Even when partially obstructed by filter media, the ports are still capable of gradual fluid evacuation, which can result in the depletion of fluid weight required to maintain the float in its elevated position. As the fluid drains from the container, the float eventually descends, thereby triggering the flush mechanism and completing the cycle.

Additionally, filtering or flow-restricting materials may be introduced into the ports. Such materials can serve to filter particulates from the fluid and/or to intentionally slow the rate of fluid transfer, thereby modifying the operational timing or sensitivity of the device in response to fluid level changes.

FIG. 17 illustrates an alternative configuration of the device in which no floating ball or similar mechanism is used to block fluid ingress 140 as the external fluid level rises. In this embodiment, the device is designed to allow unrestricted fluid entry into the container or chamber as the fluid level surrounding the device increases. This configuration may be advantageous in applications where it is desirable for the internal fluid level to mirror the external fluid level without delay or obstruction, thereby allowing for more immediate or accurate activation of internal components, such as floats or sensors, based on the surrounding environmental fluid conditions.

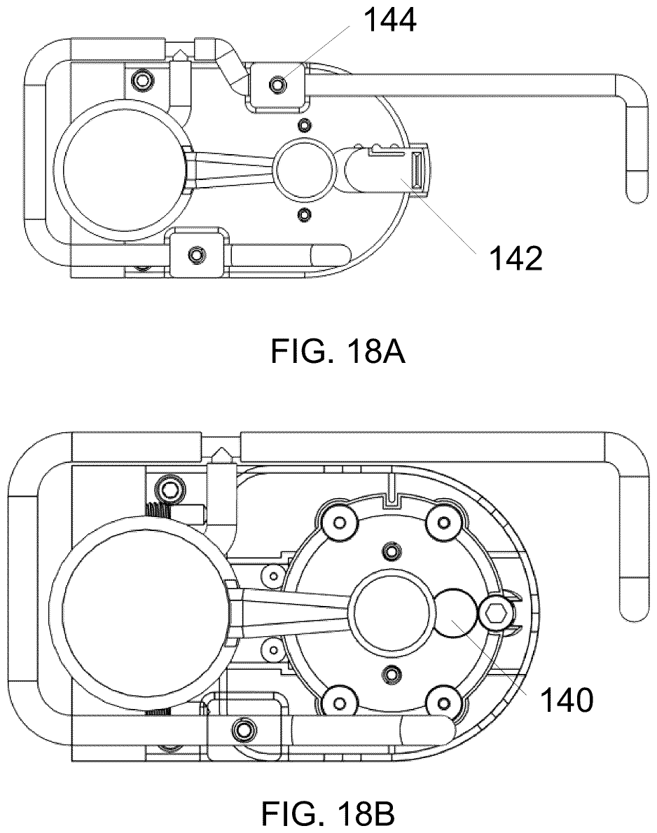

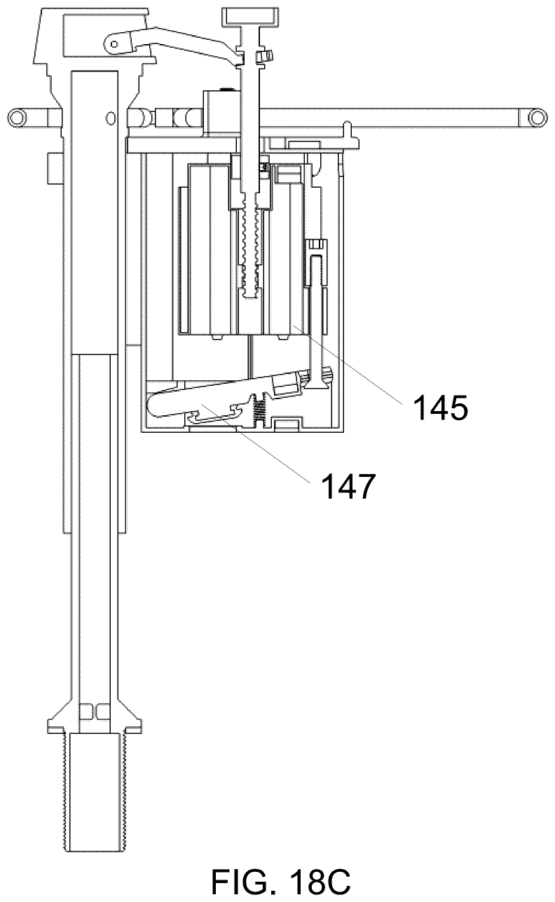

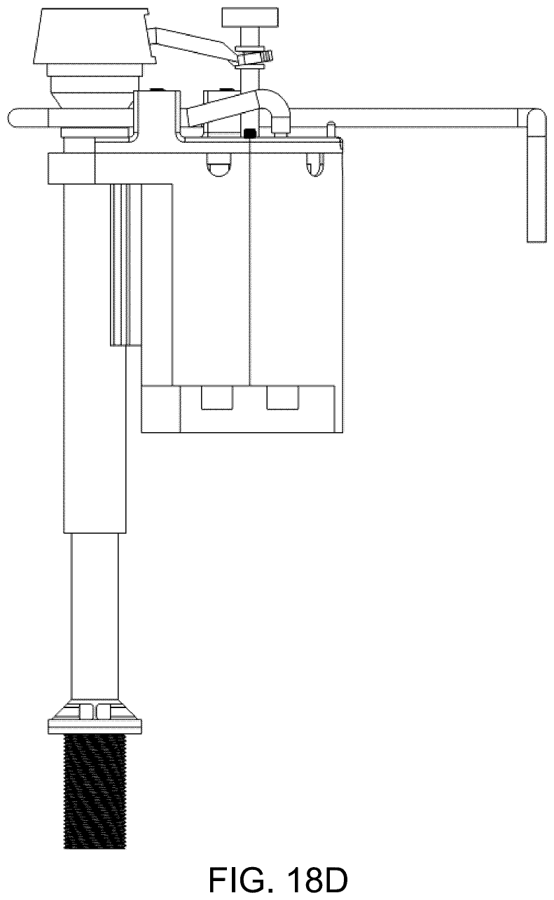

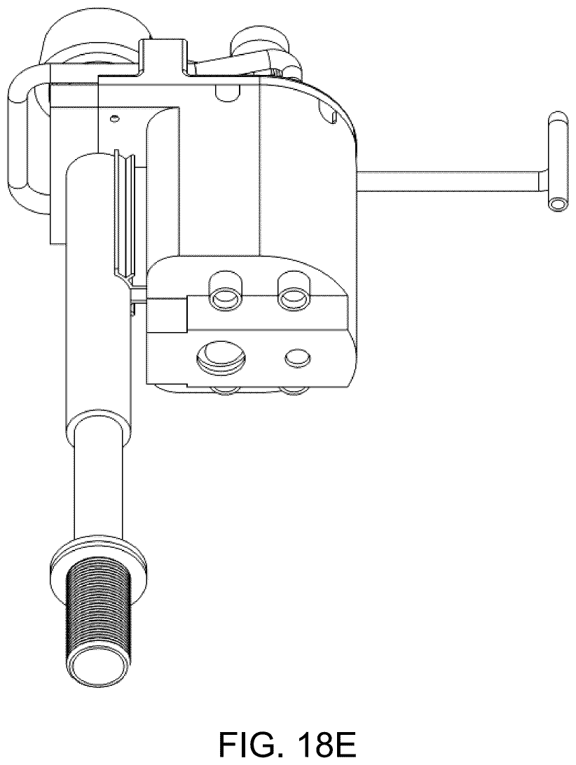

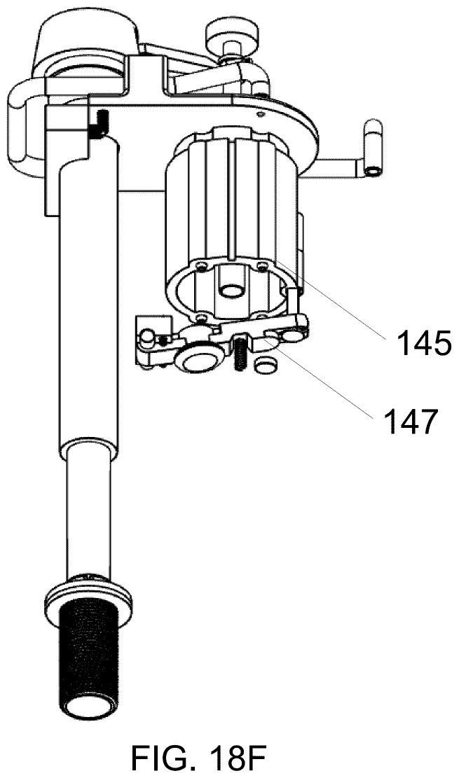

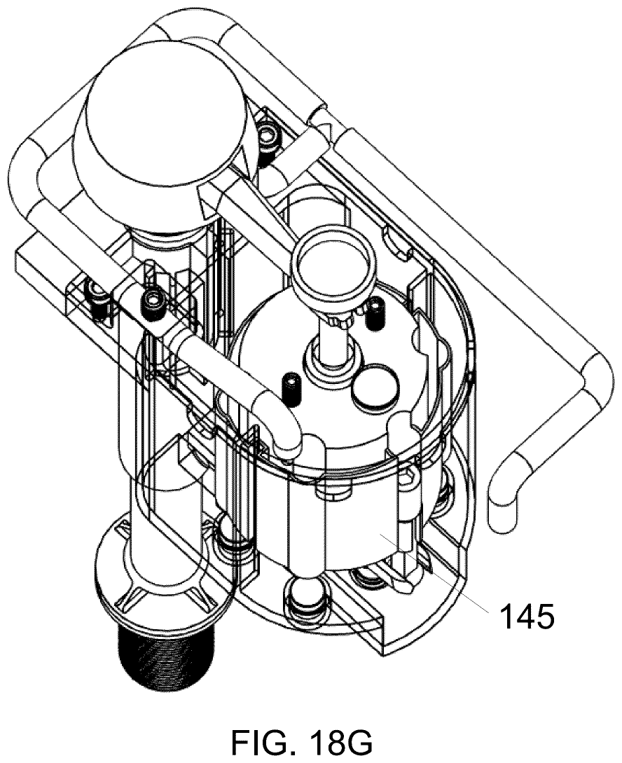

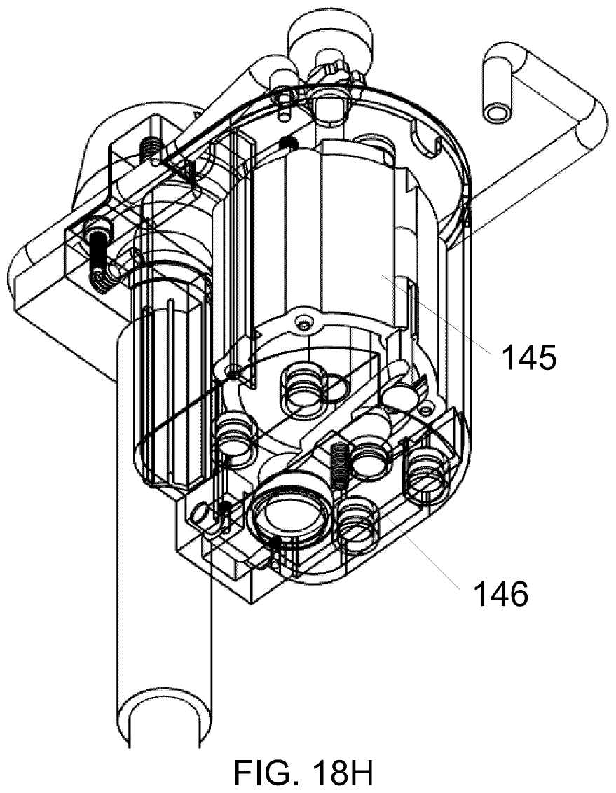

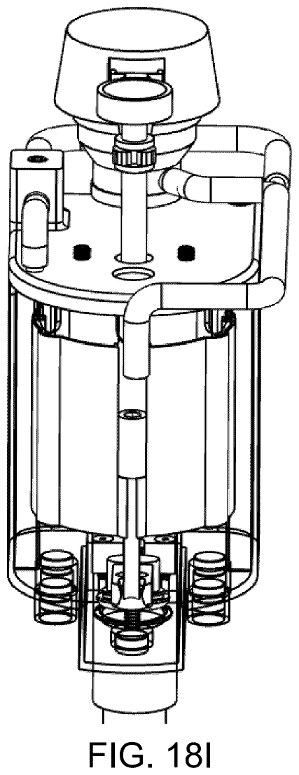

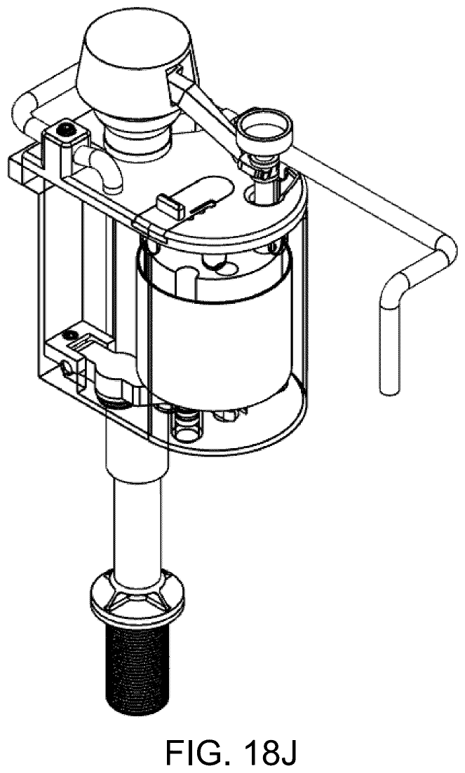

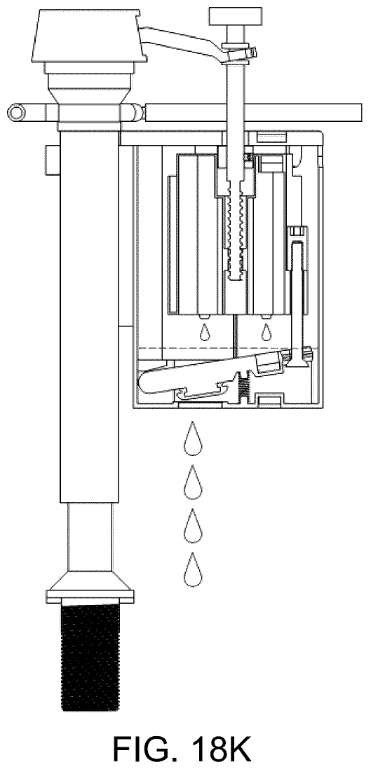

FIGS. 18A-18K illustrate an alternative configuration of the device that features a base-mounted port 140 that permits direct communication between the fluid contained within the device and the external fluid environment. In one embodiment, this configuration eliminates the need for secondary floats, siphons, or wicking materials to regulate fluid entry. The embodiment further includes a top-mounted deactivation switch 142 that may be manually retracted to disengage magnetic coupling between internal components, thereby disabling activation functions. Additionally, a fluid control setscrew 144 is positioned along the outlet tube to enable precise regulation of fluid flow exiting the chamber.

The float 145 in this embodiment is equipped with four circumferential inlet/outlet ports 146 located near its base, each aligned with a corresponding magnetic assembly within the float. These internal magnets interact with magnets embedded at the base of the float chamber to retain the float 145 in a lower position until the surrounding fluid level rises sufficiently to overcome the magnetic force and buoyantly lift the float 145. The base of the float chamber includes resilient rubber sealing pads against which the float's ports seat when in the lowered position, thereby forming a seal that prevents premature fluid exchange.

The float 145 is operatively connected to a bottom-mounted lever 147 through an adjustable mechanical linkage. This linkage enables tuning of the port opening point at various positions along the float's upward travel, providing customizable activation thresholds. A spring is also integrated into the lever assembly to assist in opening the base port once the upward force generated by the rising float exceeds the holding force of the magnetic coupling. This configuration provides an entirely mechanical, magnetically-governed delay mechanism for fluid control without requiring electronic or capillary-based timing elements.

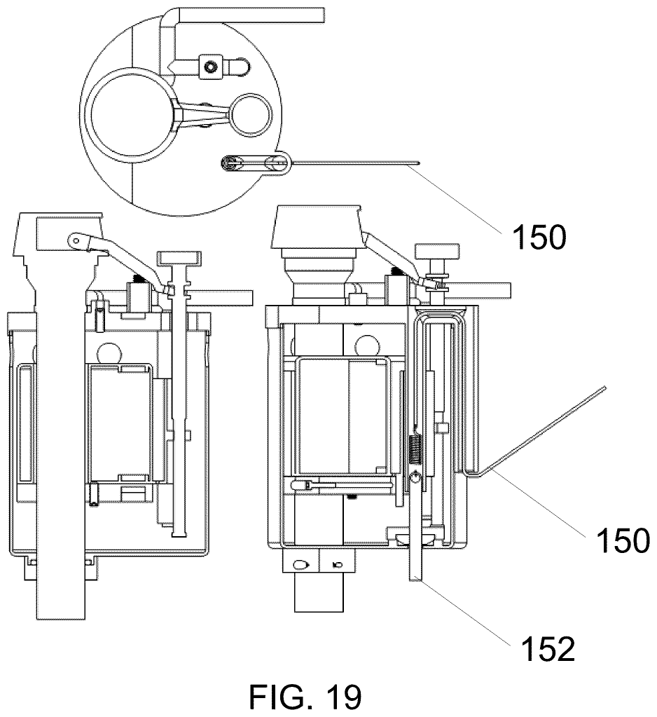

FIG. 19 illustrates an alternative embodiment of the device that incorporates a cord-actuated mechanism 150 that interfaces with the existing flushing mechanism of a toilet tank. In this configuration, a cord 150 or tether is mechanically linked to the toilet's flush handle or flushing actuator. Upon initiation of a flush cycle, the cord 150 pulls open a port 152 located at the base of the device, allowing fluid within the internal container to communicate directly with the surrounding fluid in the tank. Once the flush cycle concludes and the handle or actuator returns to its resting position, the port 152 closes, reestablishing the sealed condition of the internal container. This configuration enables precise coordination between the toilet's flush cycle and the device's operation, while maintaining compatibility with standard toilet hardware.

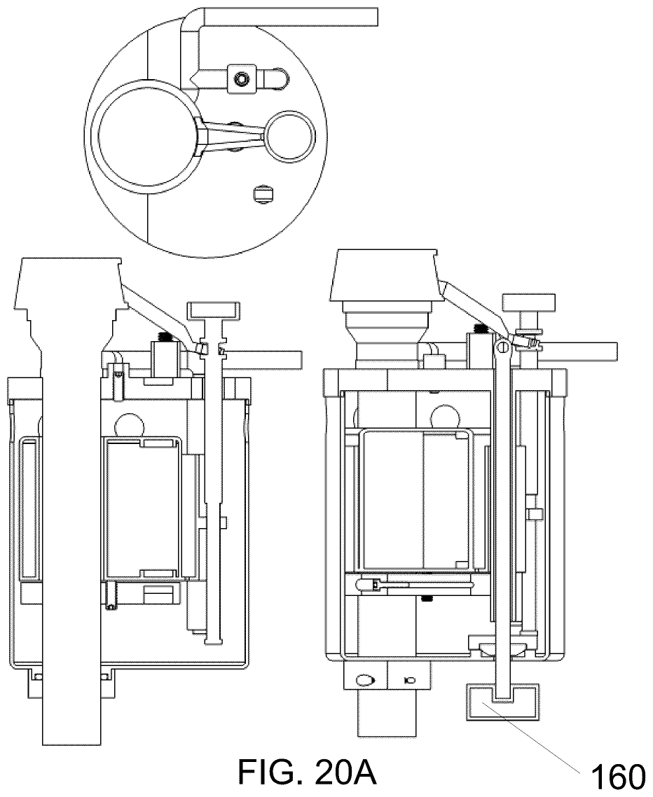

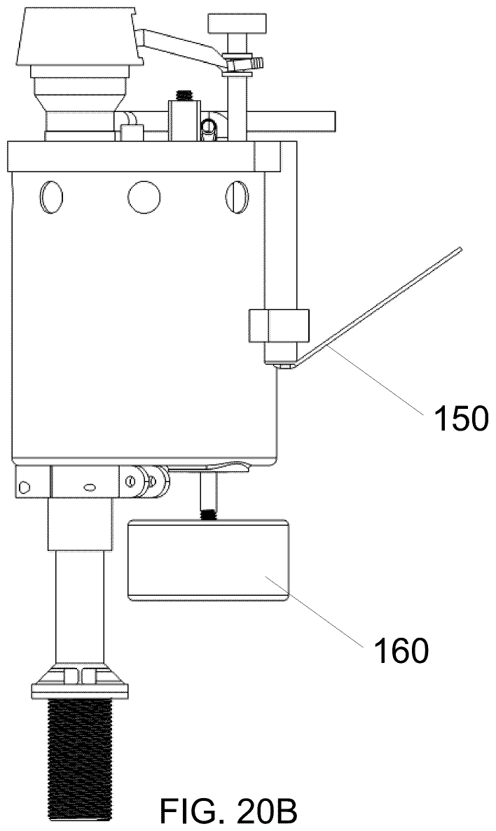

FIGS. 20A-20B illustrate an alternative embodiment of the device that includes an independent float mechanism 160 positioned at the base of the unit, configured to open and close a port that allows fluid communication between the internal container and the fluid surrounding it. This float 160 operates separately from the primary float responsible for activating the valve mechanism. As the fluid level surrounding the device rises, the independent base float 160 also rises, and upon reaching a predetermined level, it mechanically opens the port, allowing external fluid to enter or exit the internal container. Conversely, when the surrounding fluid level drops, the base float 160 descends, causing the port to close, thereby maintaining isolation between the internal fluid and external environment. This configuration allows for automatic fluid regulation in response to changing fluid levels without the need for external cords or sensors, offering a self-contained, passive control mechanism that enhances operational reliability and simplicity.

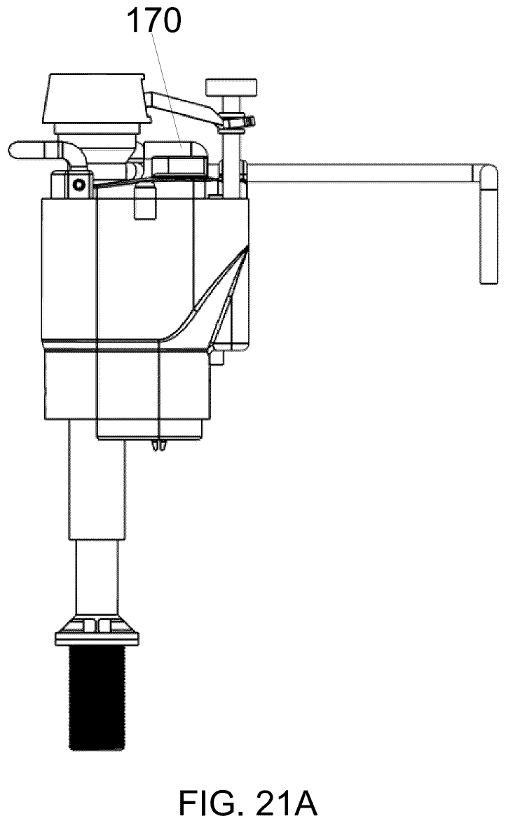

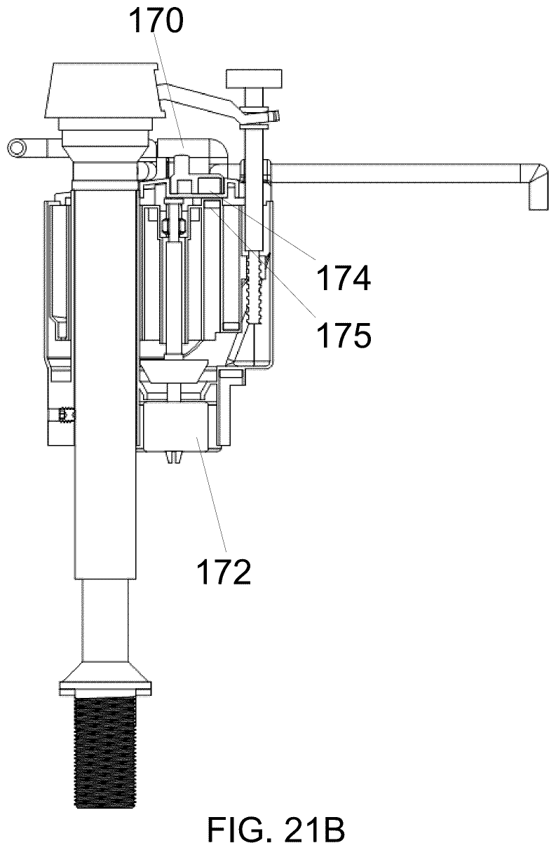

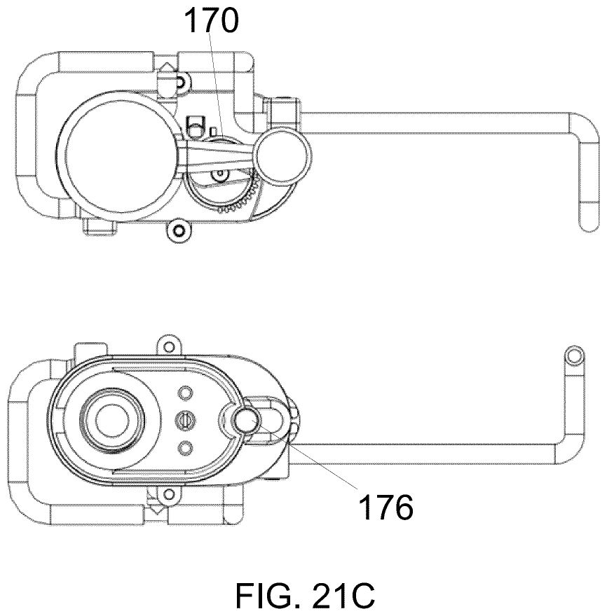

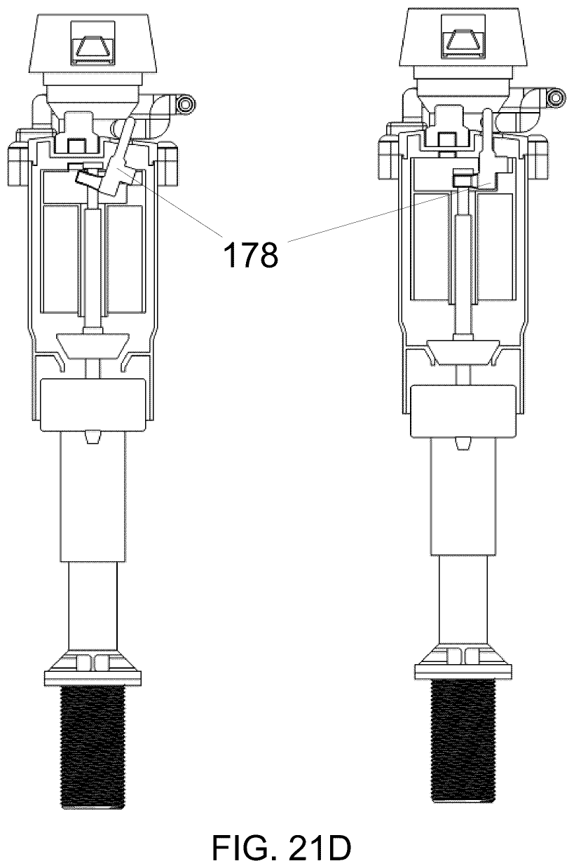

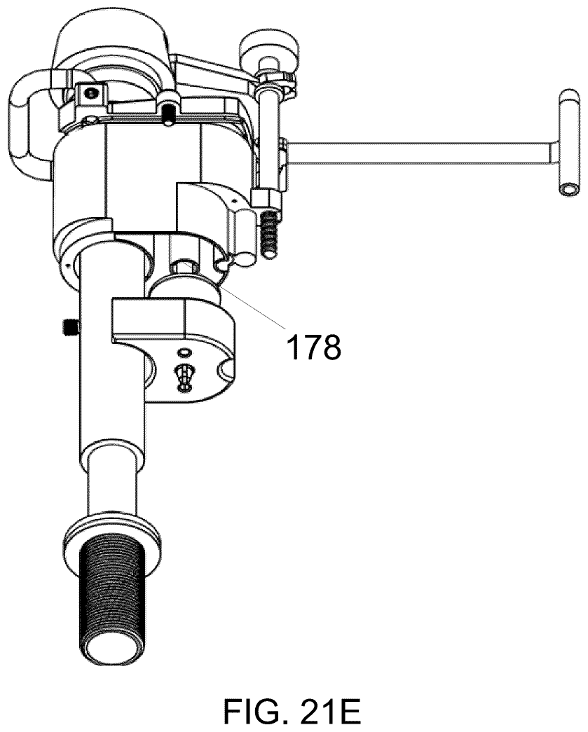

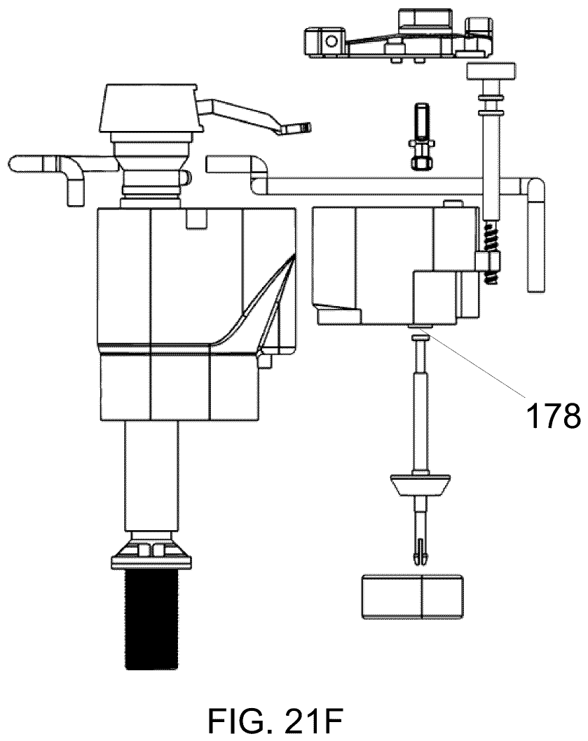

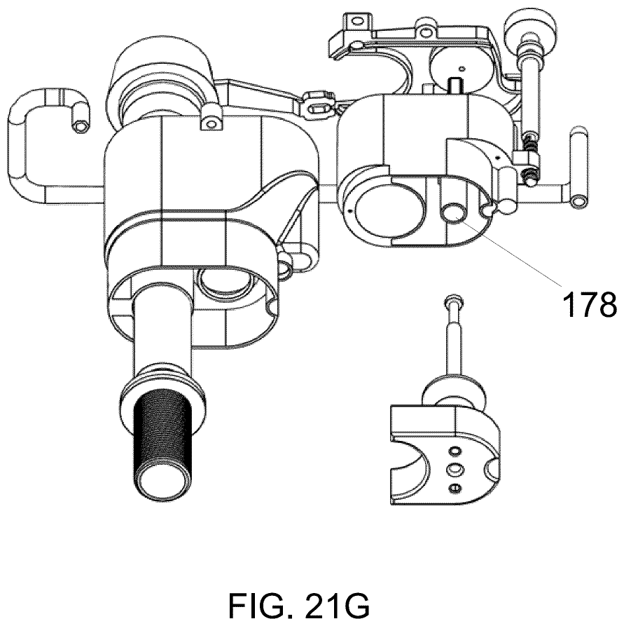

FIGS. 21A-21G illustrate an alternative configuration of the device that incorporates several features that collectively improve control, sensitivity, and adjustability. A manually operable ON/OFF knob 170 is provided at the top of the unit, enabling a user to deactivate or activate the device's core functional components, including the magnetic actuation system. The ON/OFF knob 170 also serves a dual purpose as a magnetic alignment adjuster, allowing for the adjustment of the magnetic coupling force between the top-position magnets by varying their alignment. This allows precise control over the amount of force required to maintain or break magnetic retention at the float's upper resting position. Indicator marks corresponding to alignment positions can be included on the housing for user reference.

The configuration further includes an independent float 172 at the base of the container which passively controls a port allowing fluid communication based on the level of external fluid, independent of the primary control float. An adjustable drip-feed mechanism is also included, allowing for control over the timing of fluid re-entry or evacuation, effectively functioning as a timed refill regulator. An adjustable output fluid flow control, implemented via a set screw on a discharge tube, further refines how quickly the internal fluid is evacuated, enhancing timing and response calibration. Additionally, the device may feature a magnetic retention system at the bottom of the float's travel path, allowing the float to remain in a lowered position until a sufficient external fluid level exerts upward buoyant force sufficient to overcome the magnetic hold.

In one embodiment, magnetic force is used to both assist and oppose buoyant movement. The device is capable of utilizing non-buoyant or neutrally buoyant floats that rely on magnetic attraction or repulsion to move in response to changes in fluid level or weight within the float's reservoir. This enables delayed or modulated float movement based on the timing and strength of magnetic forces and the changing mass of fluid retained or shed from the reservoir. The top resting position of the float can be fine-tuned by an adjustable threaded shaft connecting the float to the valve lever, giving users precise control over activation thresholds.

Moreover, in some applications, the drip-feed into the device can be eliminated entirely, with float reset achieved solely through reservoir-based refilling, offering a more self-contained and passive reset mechanism. These features collectively offer a high degree of functional customization, adaptability to a variety of fluid systems, and novel use of variable buoyancy and magnetically controlled float dynamics. Notably, these principles trace back to the inventor's previously disclosed concepts involving reservoir-equipped floats and magnetically influenced shedding of fluid weight, as seen in earlier filed sprinkler valve applications, see e.g., U.S. Pat. No. 12,228,216 , entitled FLOAT-OPERATED VALVE SYSTEM and issued Feb. 18, 2025, to Justin Sitz, incorporated herein by reference in its entirety.

In one embodiment, shown in FIG. 21B, the device includes an ON/OFF control knob 170 located at the top of the assembly, allowing manual activation or deactivation of the device. Adjacent to the knob are top-positioned magnets 174, which contribute to the magnetic control of the float's position. Additionally, a pair of lower magnets 175—one integrated into the float and the other positioned within the container—serve to retain the float in its lower position. This magnetic engagement is maintained until the surrounding fluid level rises sufficiently to enter the device through upper fluid intake ports, at which point the buoyant force acting on the float is adequate to overcome the magnetic hold, allowing upward movement and initiation of subsequent operational steps.

FIG. 21C illustrates a port 176 integrated into the body of the device, which serves as a fluid communication pathway. This port 176 allows fluid to enter or exit the container depending on the surrounding conditions and internal pressure differentials. In some configurations, this port 176 may be fitted with filtering or flow-restricting materials to regulate the speed and cleanliness of fluid transfer. The inclusion of such a port supports various operational functions, including controlled drainage, passive fluid exchange, or facilitating reset and refill processes during device operation.

In one embodiment, shown in FIG. 21D, a lever 178 is configured to release fluid from the container following the completion of the device's operational cycle. In one example, this is applicable in the event of an emergency shutoff where a flap or seal gets stuck open and the container fills with fluid, bringing the float to the top “off” position. The lever 178 releases the fluid in the container and resets the device once the problem is addressed. After the device deactivates, the container begins to refill with fluid, which initiates the reset process. Once sufficient fluid volume is restored within the container to prepare the device for its next activation cycle, the lever 178 can be engaged to discharge the collected fluid, thereby resetting the system and restoring it to its initial state for subsequent operation.

FIG. 21E-21G depicts the float reservoir ports 178 in isolation, with the main container removed for clarity. These ports 178 are strategically positioned to allow fluid to enter and exit the float reservoir, playing a crucial role in adjusting the buoyancy of the float. By controlling the rate and volume of fluid exchange, these ports 178 directly influence the float's weight and, consequently, its vertical movement within the device. This configuration supports timed activation or delayed response, depending on the surrounding fluid levels, and enables fine-tuned control of the device's operational cycle.

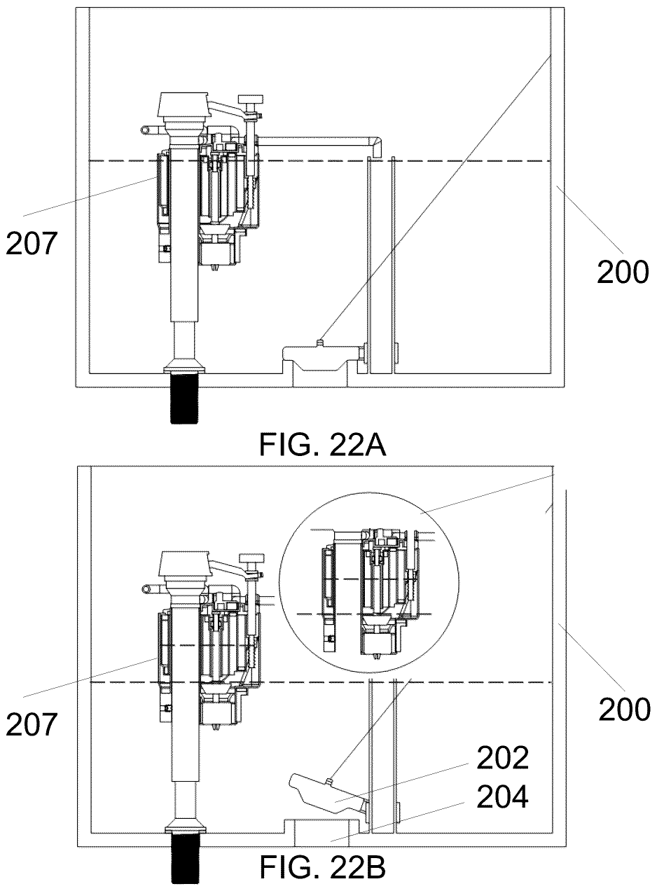

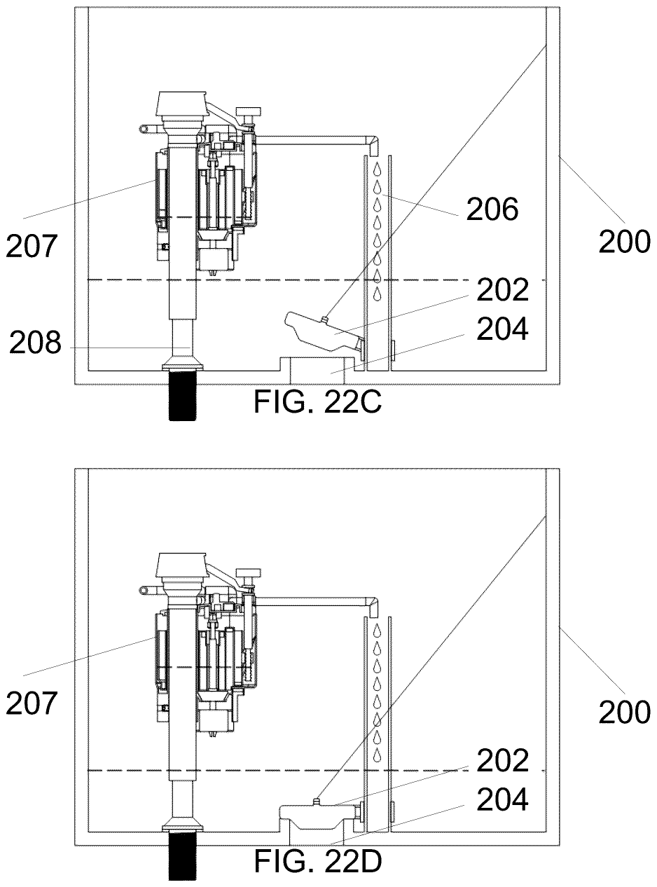

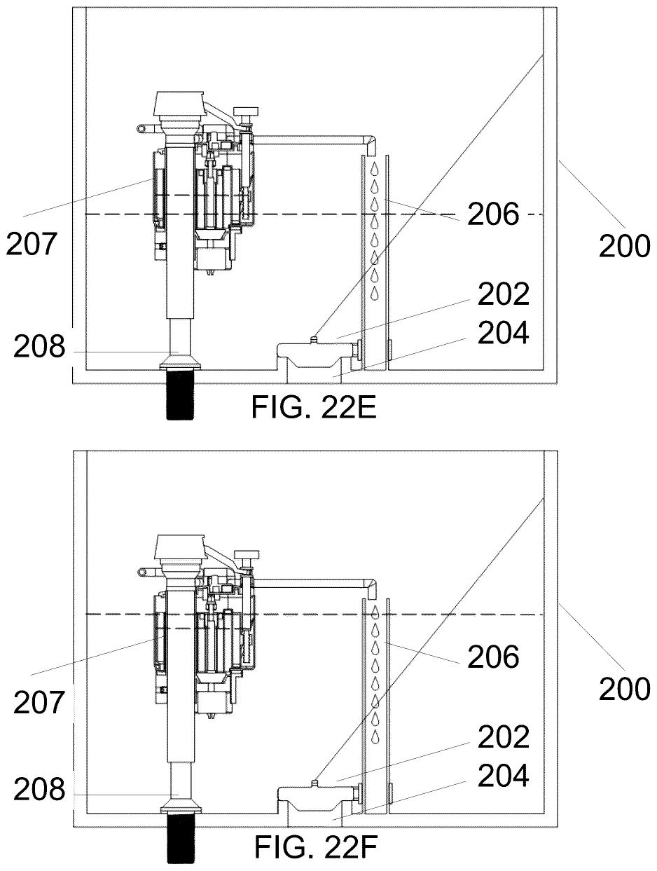

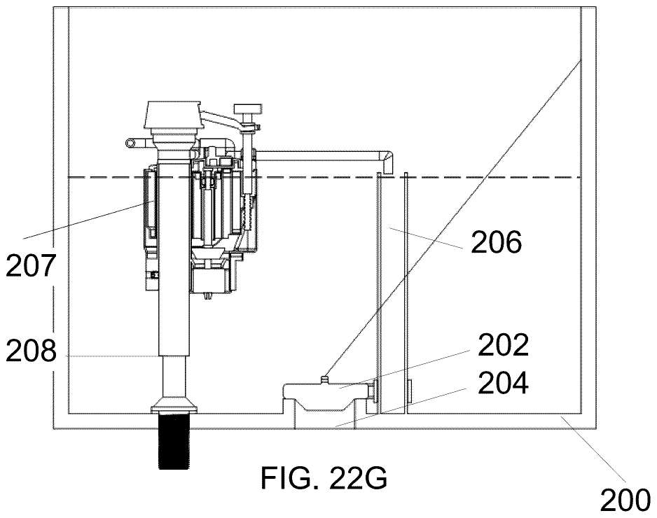

FIGS. 22A-22G illustrates a standard operating sequence for using the device. FIG. 22A illustrates the valve assembly fully submerged in a master tank 200, which is filled to its maximum fluid level. At this stage, the valve is in the off (closed) position, indicating that no fluid is being transferred.

In FIG. 22B, the drain from the master tank 200 has been opened, causing fluid to begin exiting. As this occurs, fluid within the holding tank 207 also starts to drain through the holding tank port. As a result, the water level in the holding tank 207 begins to drop. The dimensions of port can be adjusted to vary the rate at which the water level in holding tank 207 falls relative to the master tank 200 water level. The close-up view 205 of the fluid levels in both the master and holding tanks is shown, providing a detailed snapshot of the system's dynamic fluid changes.

In FIG. 22C, as fluid continues to drain from the holding tank 200, the remaining weight of the float, including the fluid retained in the main float reservoirs, applies increasing downward force. The top magnets are configured to attract one another and hold the float in the upper position. The user can adjust the strength of this magnetic connection by rotating the on/off knob, which misaligns the magnets to reduce their attraction. Full misalignment allows the float to move freely with the fluid level, effectively disabling the magnetic hold.

As the fluid level in the master tank 200 drops below the holding tank port seal float, the float descends and seals the port, isolating the holding tank. The main float moves downward, adding weight and pressure to the holding tank port seal. Any remaining fluid in the float reservoir drains through the reservoir ports into the holding tank 207. In this position, the valve opens, and fluid begins to flow through the water delivery tube 208, the holding tank drip feed tube, and out through the master tank fill ports.

In FIG. 22D, after the master tank 200 is nearly emptied, and its main port 204 has resealed, the valve is still open, delivering fluid to the master tank, initiating the refill cycle. Fluid also starts entering the holding tank at a slow rate via the holding tank drip feed tube 206, which can be regulated using the adjustment screw. Meanwhile, the main float remains in the down position due to the magnetic attraction between the bottom float magnet and the bottom tank magnet, maintaining pressure on the port seal.

Fluid begins to accumulate in both the master tank 200 and the holding tank 207. Despite the rising fluid levels, the main float does not yet ascend due to the magnetic retention at the base. Additional buoyant force from rising fluid is required to break this magnetic bond before upward motion can occur.

In FIG. 22E, fluid levels continue to rise in both tanks. The holding tank port seal float remains closed because the float is still applying downward pressure, assisted by the magnetic connection between the bottom float magnet and the bottom tank magnet.

In FIG. 22F, the fluid level in the master tank 200 now surpasses the level in the holding tank 207. At this point, fluid can only enter the holding tank 207 through two paths: the sealed port and the open holding tank top opening. Since the port is still sealed, fluid begins to enter from the top opening only.

In FIG. 22G, as fluid in the master tank 200 reaches and spills over the top opening, it floods holding tank 207. The surrounding fluid creates enough buoyancy to overcome the magnetic connection at the float's base, allowing the float to rise. This upward motion deactivates the valve and removes downward pressure from the holding tank port seal, enabling the port seal float to open port. This action restores fluid communication between the holding tank and the master tank, completing the cycle.

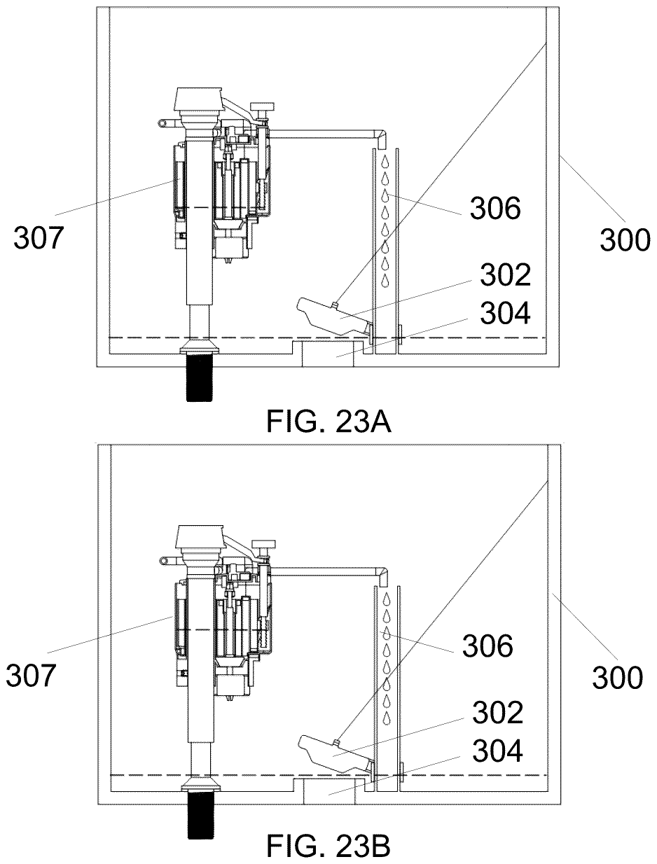

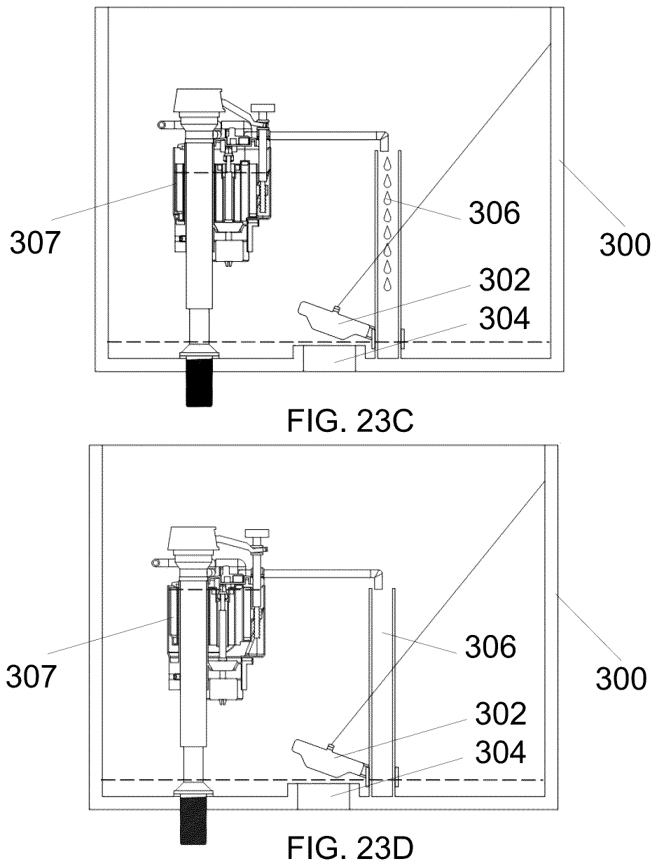

FIGS. 23A-D illustrate the operation sequence of the device if the flap doesn't close or there is a mass evacuation of fluid. FIG. 23A shows the beginning of the device's shut-off cycle. The shutdown is initiated due to a valve flap 302 in the master tank 300 remaining open, allowing fluid through the master tank port 304. At this stage, the device continues to deliver fluid to the master tank 300 through the water delivery tube 306 and to holding tank 307 via the holding tank drip feed tube.

In FIG. 23B, as fluid delivery continues, the fluid level in the holding tank 307 continues to rise, fed by the holding tank drip feed tube. The rate of this fluid transfer is adjustable via the holding tank drip feed tube adjustment screw, which allows users to set a variable run time before the device automatically shuts off.

In FIG. 23C, the fluid level in the holding tank 307 continues to increase, but the main float remains in its bottom position. This is due to the magnetic connection between the bottom float magnet and the bottom tank magnet, which holds the float down despite the increasing buoyant force.

In FIG. 23D, eventually, the fluid in the holding tank 307 rises to a level that provides enough buoyant force for the main float to overcome the magnetic connection at the base. Once this occurs, the float is propelled upward, turning off the valve. Despite this, the holding tank port seal float remains in the downward position, keeping the holding tank port sealed, as the fluid level in the master tank 300 is still too low to lift it.

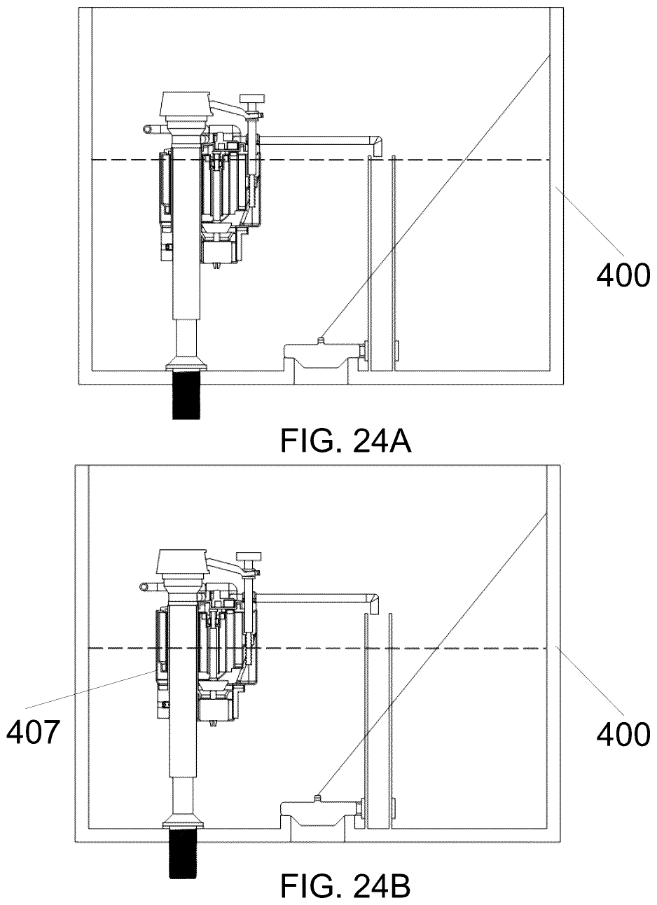

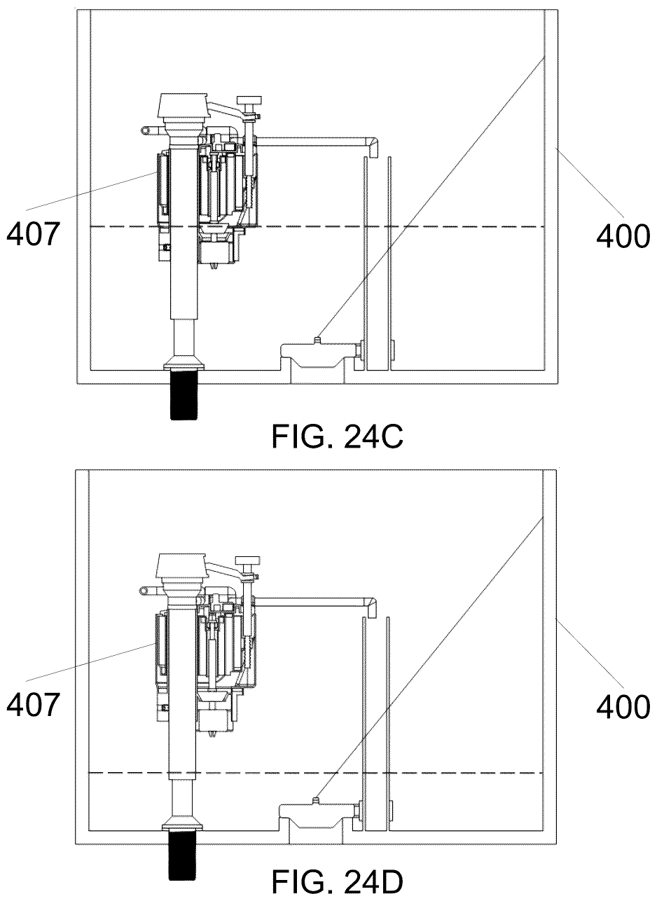

FIGS. 24A-D illustrate the operation sequence of the device in the event of a slow leak. FIG. 24A, illustrates the starting point of a slow leak within the master tank 400, with the valve in the off position. At this stage, the device is inactive, and no fluid is being delivered to the master tank.

In FIG. 24B, as the slow leak progresses, the fluid level in the master tank 400 gradually drops. Correspondingly, the fluid levels in both the holding tank 407 and the main float reservoirs also decrease. Despite the declining levels, the main float remains suspended in the upper position, and the valve stays closed due to the magnetic connection between the top lid magnet and the top float magnet.

In FIG. 24C, with the leak continuing, the master tank 400 and holding tank 407 fluid levels drop further. At this point, the holding tank 407 is nearly empty, and all the fluid in the main float reservoirs has been depleted. As a result, the main float no longer has enough weight to overcome the magnetic attraction between the top magnets, so it remains in the raised position, keeping the valve turned off.

In FIG. 24D, eventually, the master tank 400 and the holding tank 407 become completely depleted of fluid. However, the main float remains magnetically held in the upward position, maintaining the valve in the off state. This prevents the device from continuously cycling and attempting to refill a leaking master tank, which would otherwise waste water. Once the leak is repaired, the user can manually restart the device by using the activation lever, which disengages the float and allows it to fall, reactivating the valve and resuming normal operation.

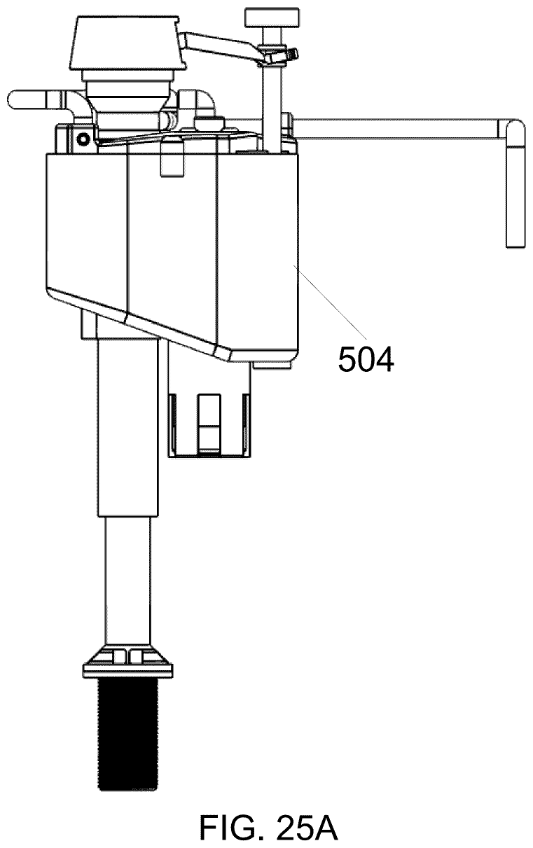

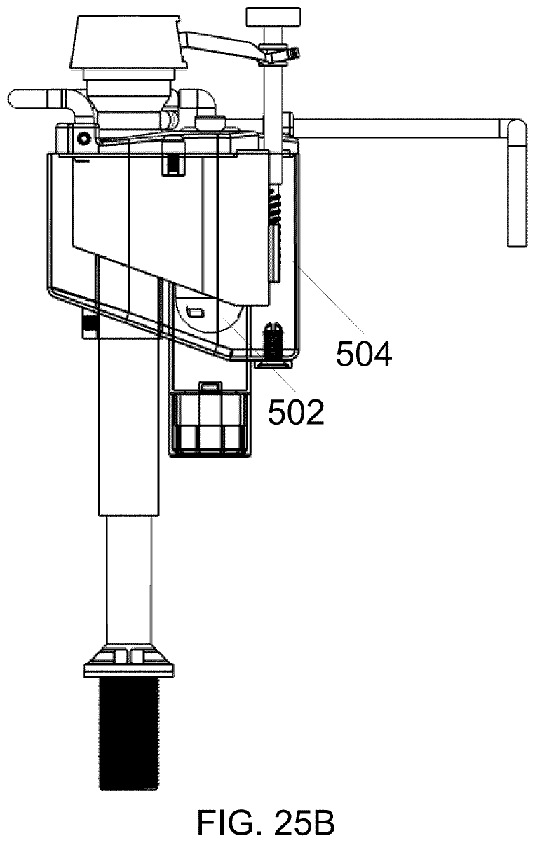

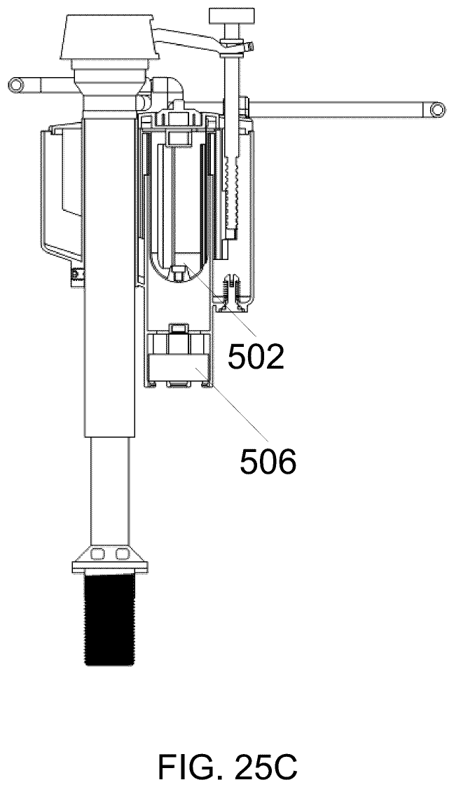

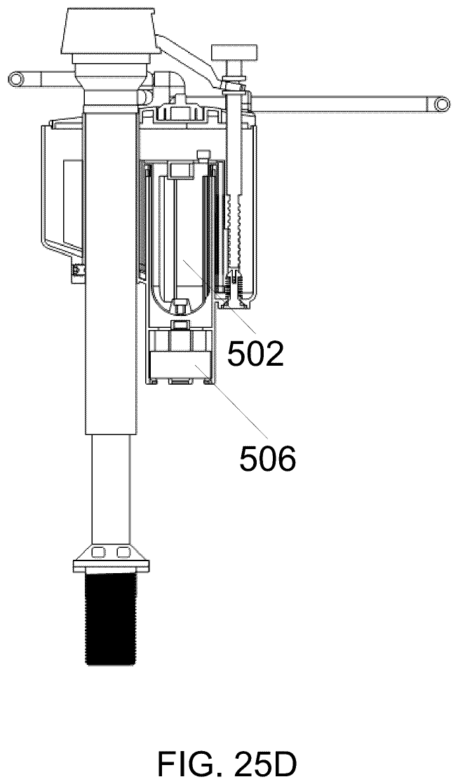

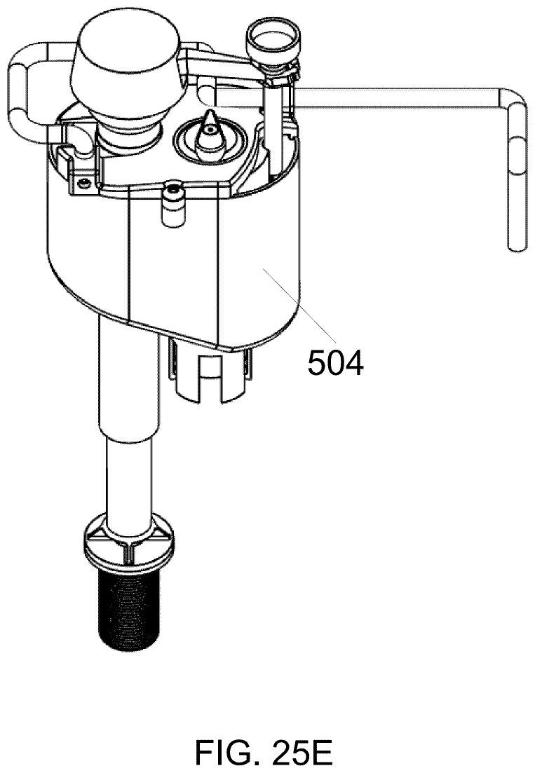

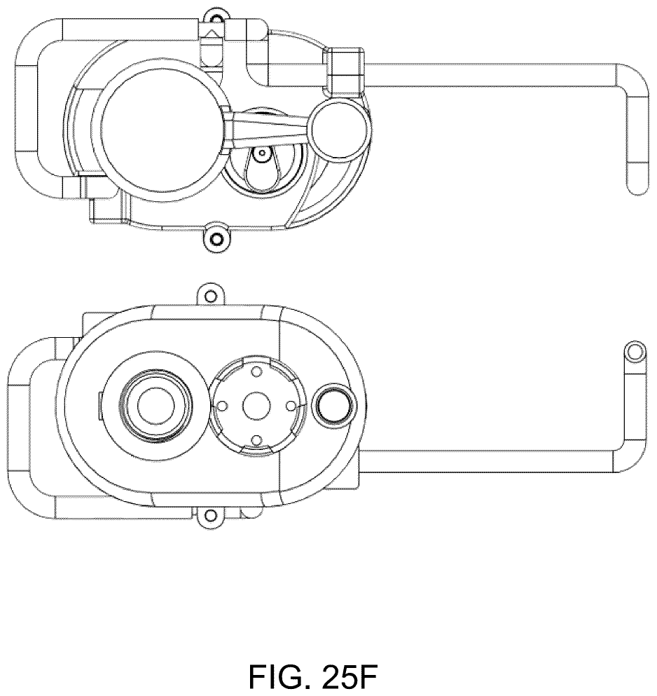

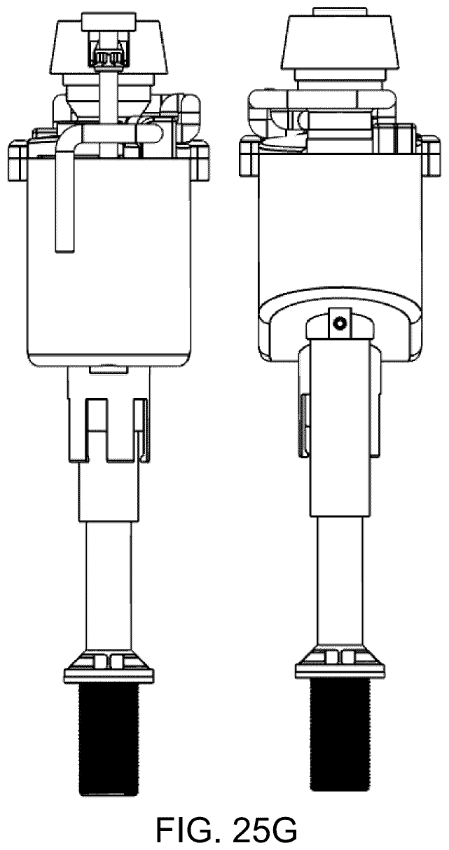

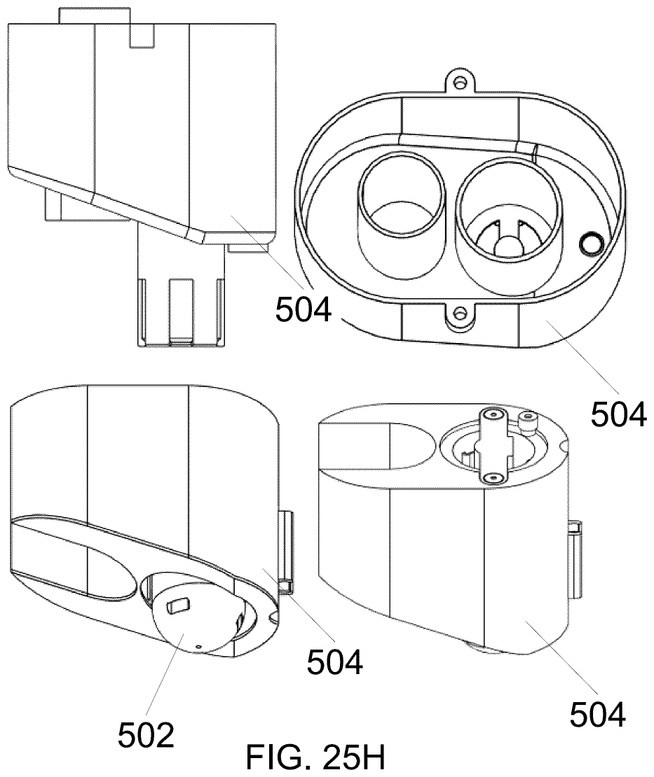

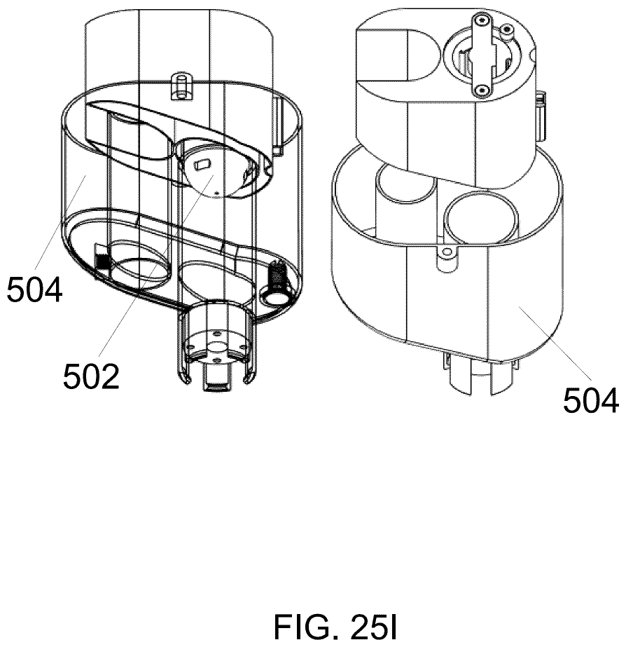

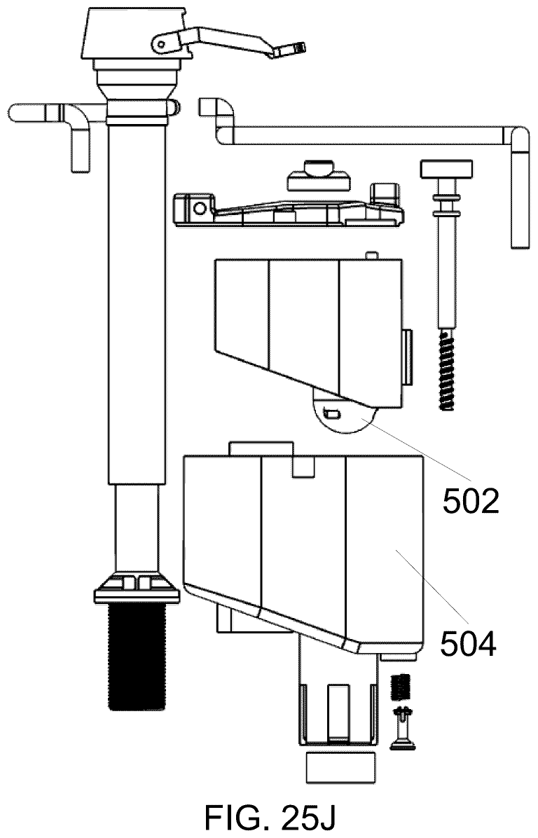

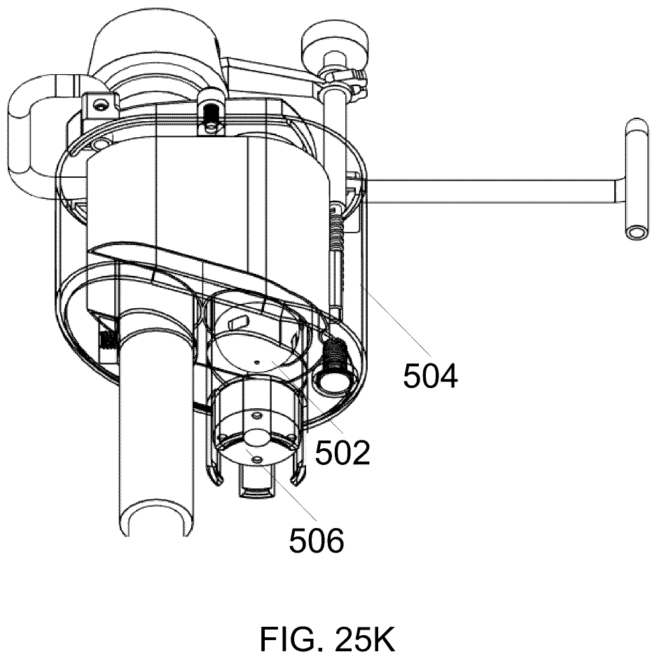

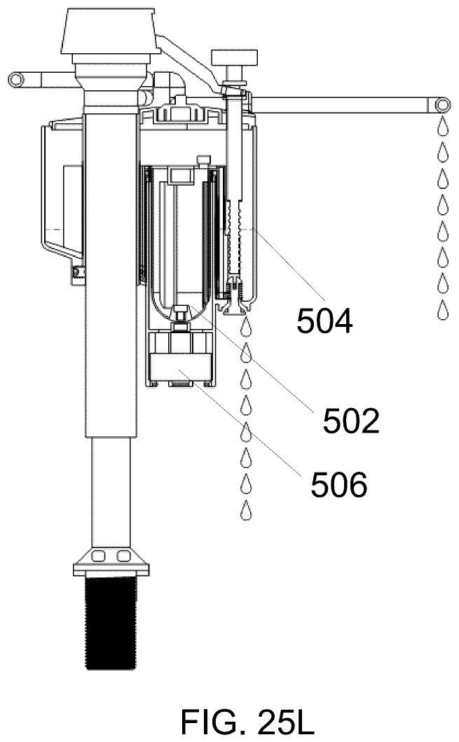

FIGS. 25A-25L illustrate an embodiment of the device where the float 502 and container 504 are configured to cooperatively form a bell siphon structure that facilitates the rapid evacuation of fluid once a predetermined level is reached. The internal geometry of the float reservoir and the surrounding container is designed to initiate and sustain siphon action without requiring external pumps or electronic components.

This embodiment further includes a spring-loaded plunger mechanism 506 accessible at the base of the device. When the user depresses the float, the plunger actuates a base port, allowing fluid to flow and resetting the siphon system for subsequent operation. This manual reset feature enables re-priming of the siphon following maintenance, inspection, or system interruption.

To facilitate proper siphon activation, the float also 502 incorporates an air-bleed check valve positioned at its upper end. This valve allows trapped air to escape from the float chamber during the priming phase, ensuring that siphon action is not impeded by airlocks and can begin reliably when fluid reaches the activation threshold.

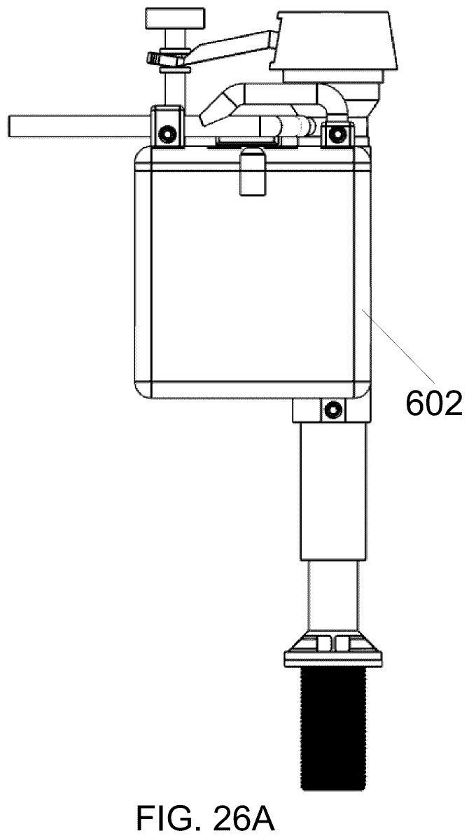

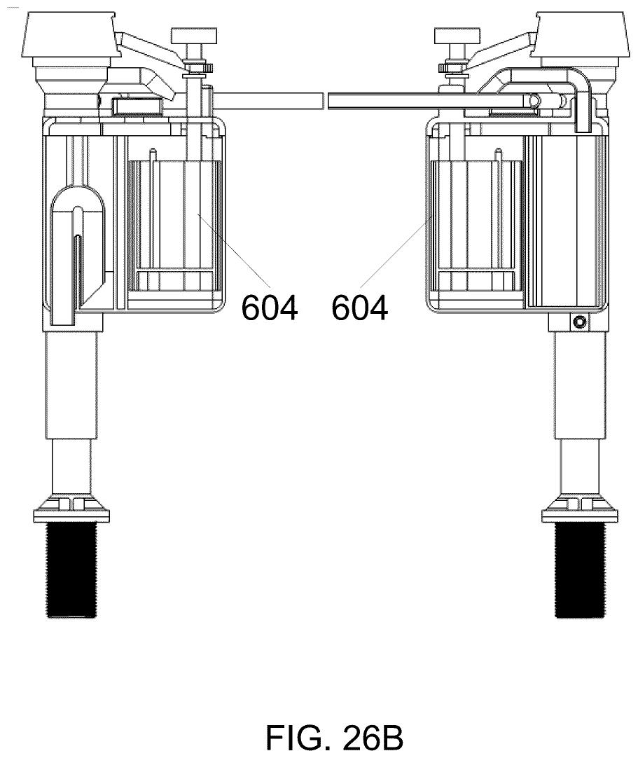

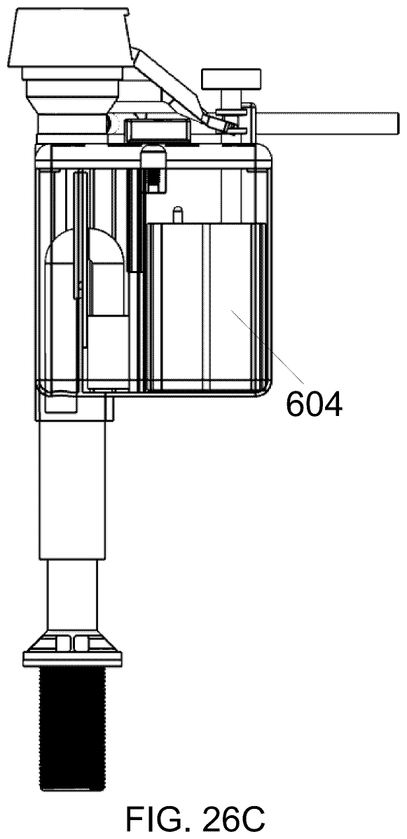

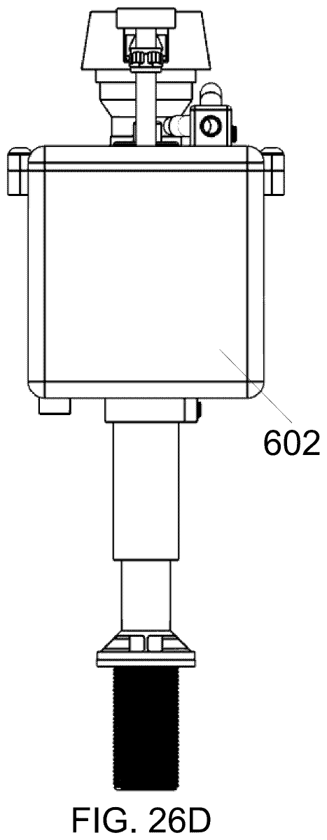

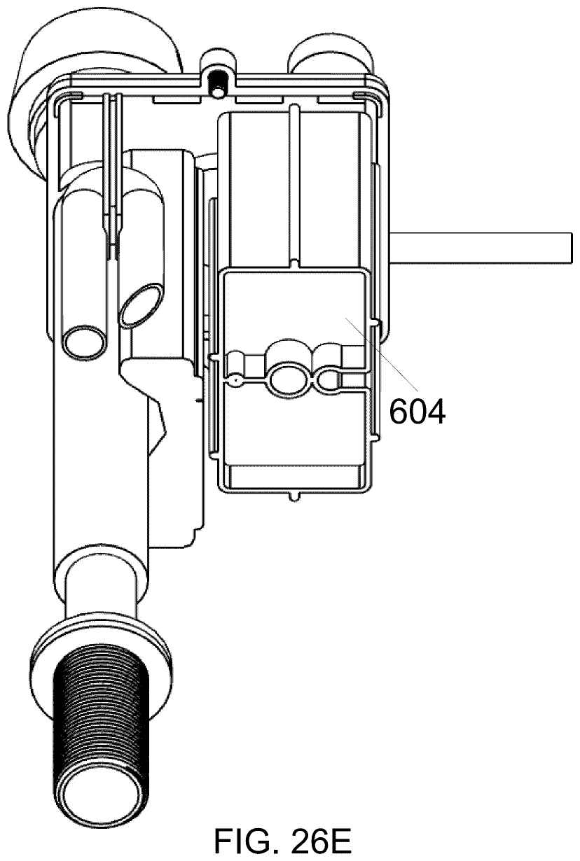

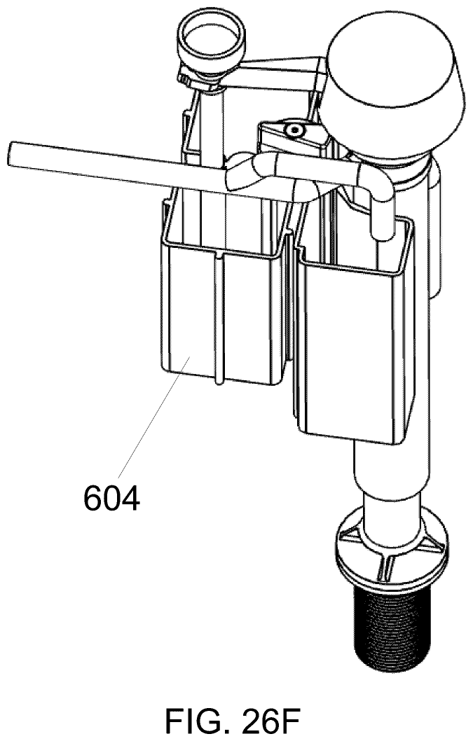

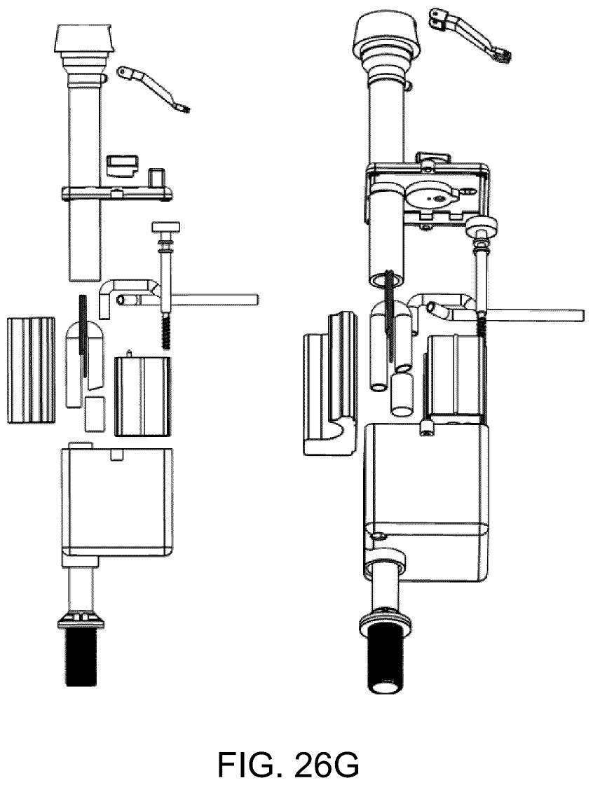

FIGS. 26A-26G illustrates an alternative embodiment where the device incorporates an internal reservoir 604 positioned within the container 602 to facilitate controlled redistribution of fluid into the float chamber. The purpose of this reservoir 604 is to ensure that, after each activation cycle-during which the float moves downward to initiate fluid discharge-the float is returned to its upper, inactive position in a consistent and reliable manner. As the float descends and activates the discharge mechanism, fluid within the container is directed into the reservoir.

Once the discharge cycle is complete and the external fluid level rises due to refilling, the fluid passively reenters the reservoir 604 via a port or channel positioned at or near the top of the device. This refilling action ensures that the reservoir 604 is primed for the next cycle. When the reservoir 604 reaches a predetermined volume, it releases fluid into the float chamber, creating enough buoyant force to elevate the float and reset the system. This mechanism provides a self-regulating method for float reset, eliminating the need for manual priming, electrical components, or external pressure sources, and enhancing the reliability and autonomy of the system over repeated cycles. Additionally, the timing and rate of fluid redistribution may be fine-tuned through the use of flow restrictors, baffles, or adjustable orifices to control the float's return characteristics.

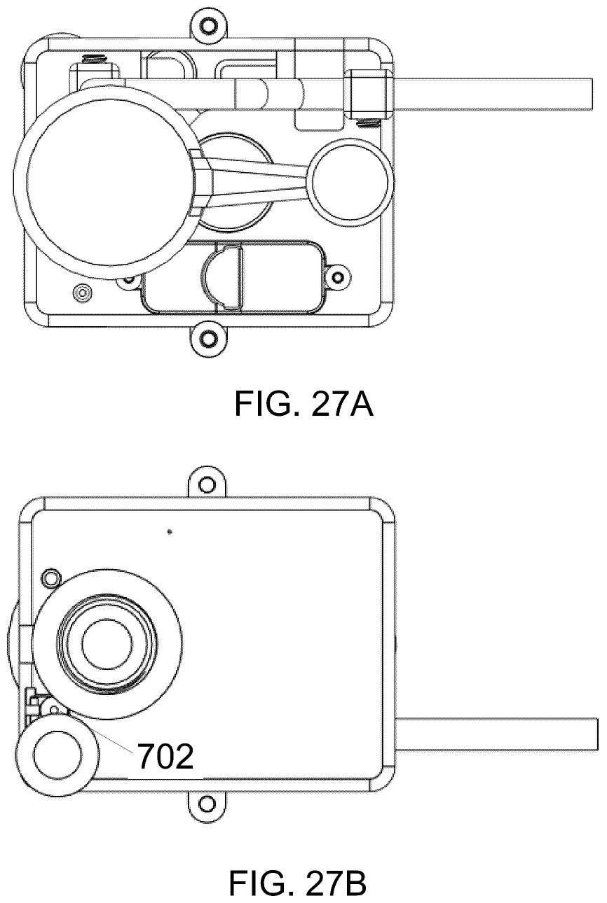

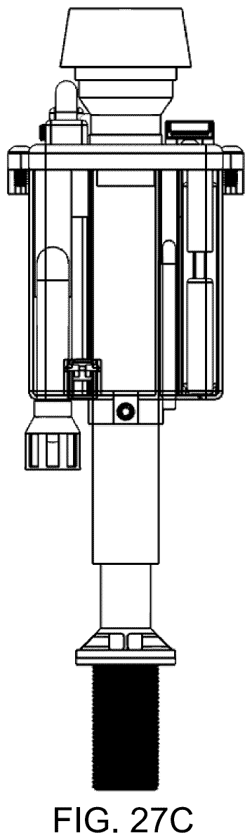

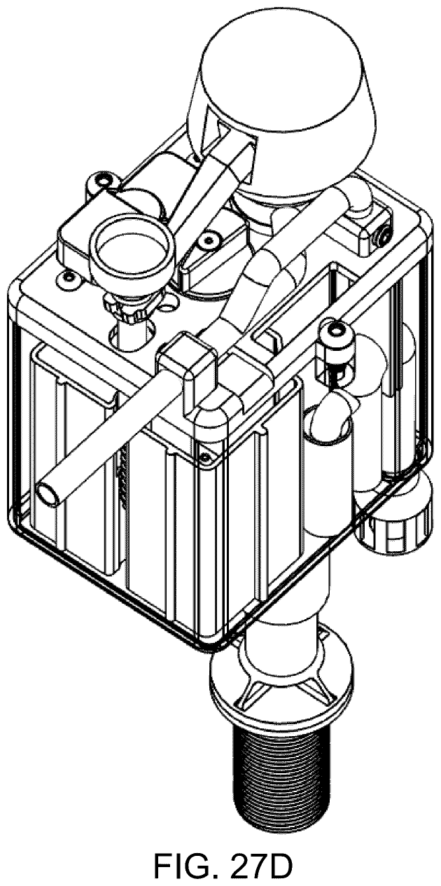

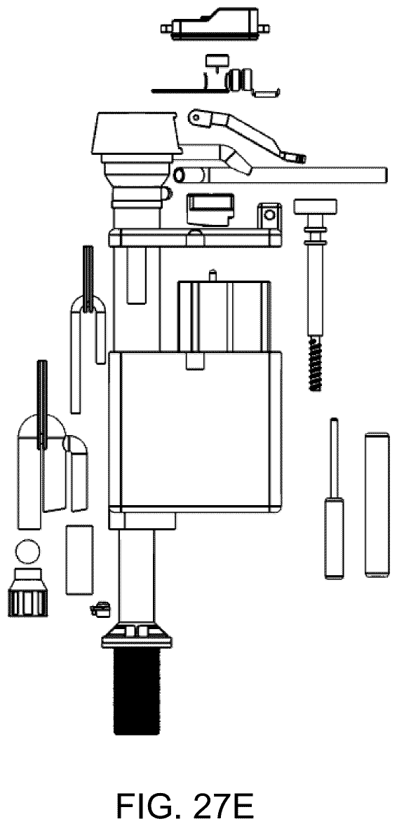

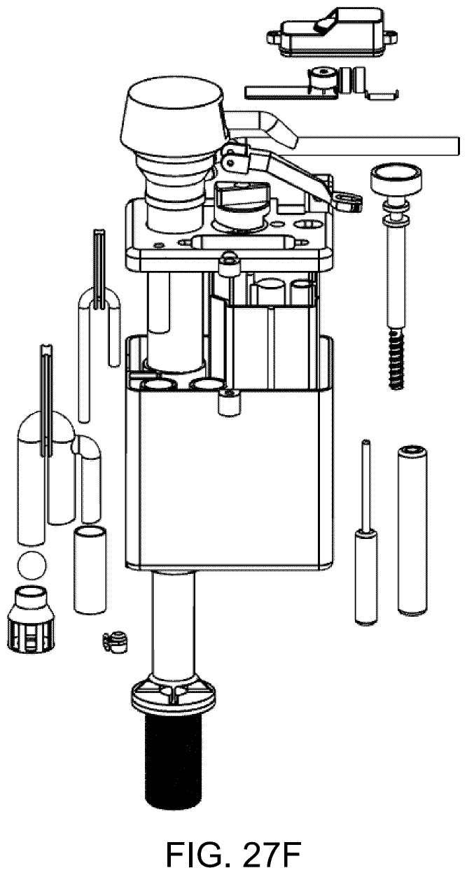

FIGS. 27A-27F depict a fluid control system that includes a container fitted with a one-way flow-regulating flap valve 702 positioned near or at the fluid intake. This flap 702 is a mechanically simple yet functionally important component designed to regulate the rate of fluid ingress into the internal reservoir of the container during operation. The flap 702 is biased—either by its geometry, material flexibility, or an integrated spring mechanism—to remain in a semi-closed or closed position under low to moderate external fluid pressures, thereby restricting the initial rate of fluid entry. This controlled filling process delays the rise of fluid within the container, preventing premature actuation of the float mechanism. The delayed activation helps ensure that the surrounding fluid reaches the top lid assembly of the device before the internal reservoir is sufficiently filled to initiate the float's upward movement, thereby enhancing the accuracy and reliability of the device's timing and refill cycle.

When fluid within the container is discharged, either by gravitational action or siphon effect, the pressure differential created within the container allows the flap 702 to fully open in the outward direction. This facilitates the rapid evacuation of fluid, effectively resetting the system without restriction. The flap 702 may be formed of a flexible elastomeric material, such as silicone or rubber, or may be a hinged plastic or metal element with an integrated torsion or compression spring to manage its default position and responsiveness to pressure differentials.

The use of this flap 702 thus serves two primary purposes: (1) it delays the reset timing by controlling the rate of fluid ingress into the container; and (2) it allows unimpeded fluid egress to ensure quick reset and readiness for the next cycle. This design eliminates the need for electronic timers or complex fluid control systems while improving mechanical durability and operational consistency across varying fluid pressures and environmental conditions.

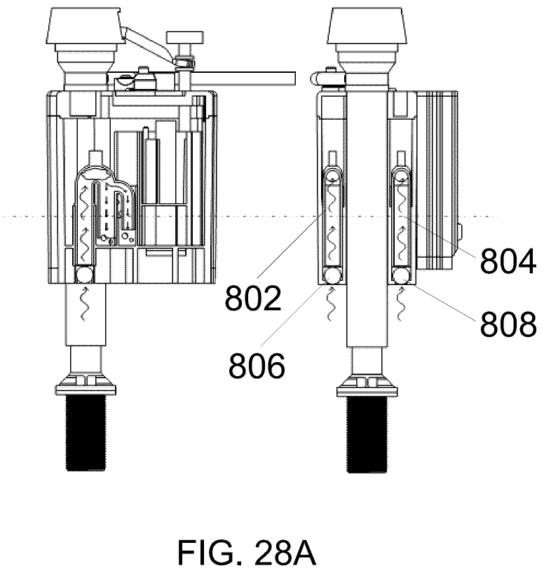

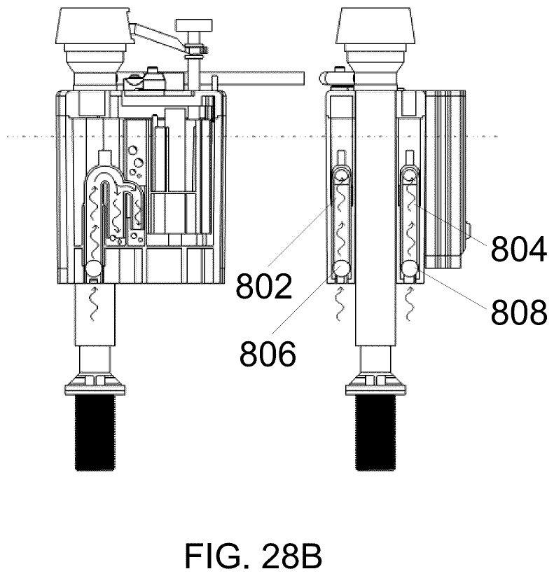

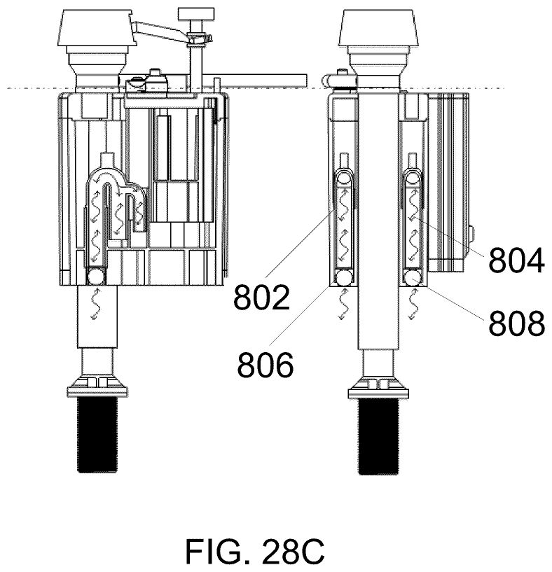

FIGS. 28A-28C illustrates sequence drawings showing the operational cycle of an embodiment utilizing non-floating balls 806, 808 positioned beneath large siphon tubes 802, 804 within the fluid control device. These non-buoyant balls 806, 808 are strategically located at the lower ends of the siphons 802, 804 and serve a critical function in managing air displacement and fluid entry during the device's refill cycle.

As shown in FIG. 28A, as the fluid level within the surrounding tank or container begins to rise following a flush or discharge event, the non-floating balls 806, 808 remain in their resting, downward positions due to the absence of buoyant force acting upon them. This configuration allows fluid to flow freely around the balls and into the outlet openings of the siphon tubes.

The descending position of the balls 806, 808 during this initial phase creates an open passage for incoming fluid, thereby facilitating the evacuation of residual air that may have been drawn into the siphon system during the previous cycle. This ensures that the siphon tubes 802, 804 are fully primed and air-free before the next activation, which is critical for the proper functioning of a siphon-based fluid control mechanism. By clearing trapped air and allowing continuous fluid ingress, this arrangement prevents siphon failure and supports consistent and reliable operation across multiple cycles.

The use of non-floating balls 806, 808 as passive air-clearing elements within the siphon architecture represents a mechanically simple yet effective solution to a common problem in fluid dynamics systems. This design improves the reliability and repeatability of the siphon initiation process without the need for electronic sensors, active valves, or user intervention.

In FIG. 28B, as the fluid continues to rise and displace the remaining air within the siphon system, a vacuum is formed inside the siphon tube 802, 804 once the air is fully cleared. This negative pressure condition actively draws the weighted, non-floating ball 806, 808 upward into sealing engagement with the exit port located at the base of the siphon 802, 804. The sealing action effectively terminates the flow of fluid into the siphon tube and, consequently, into the associated container or float chamber.

The formation of the vacuum not only assists in pulling the ball 806, 808 into its sealing position, but also maintains the seal by sustaining a pressure differential between the inside of the siphon and the surrounding fluid environment. Simultaneously, as the fluid level in the external reservoir or tank continues to rise, hydrostatic pressure is exerted against the exterior surface of the ball 806, 808 and the lower portion of the siphon 802, 804. This additional force further reinforces the seated position of the ball 806, 808 against the exit port, ensuring a secure and reliable seal that prevents unwanted ingress of fluid.

This self-sealing mechanism, which relies solely on fluid dynamics and the inherent weight of the non-floating ball, provides an effective means of regulating fluid intake into the system without the use of mechanical actuators, valves, or electrical components. It enhances the efficiency and operational longevity of the device by reducing moving parts and minimizing potential points of failure.

As shown in FIG. 28C, as the fluid level within the surrounding tank or reservoir continues to rise and eventually reaches the top of the device, it begins to pour into the internal container or float chamber. At this point, the weighted float balls 806, 808, previously held in a raised and sealed position by a combination of vacuum pressure and rising hydrostatic force, begin to descend. This descent is triggered once the surrounding fluid level stabilizes and ceases to exert upward pressure on the float balls 806, 808. The equilibrium of forces is reestablished—air has been fully evacuated from the siphon tubes, and the internal and external fluid levels have become balanced, effectively neutralizing the previously sustained vacuum and hydrostatic pressures.

As a result, the weighted float balls 806, 808 are no longer maintained in their sealed position and fall back into their default downward orientation due to gravity. This reset state leaves the exit ports unsealed, preparing the device for its next operational cycle. In this configuration, the siphons remain in a primed condition—with air fully removed and fluid continuity maintained—allowing them to function passively in response to minor fluctuations in fluid level.

Notably, under conditions where a slow leak or gradual loss of fluid occurs in the surrounding reservoir, the primed siphons 802, 804 enable controlled and automatic fluid release from the internal container back into the reservoir. This passive balancing response helps to maintain system equilibrium and prevents premature activation of any refill mechanism, thereby enhancing efficiency and reducing mechanical wear.

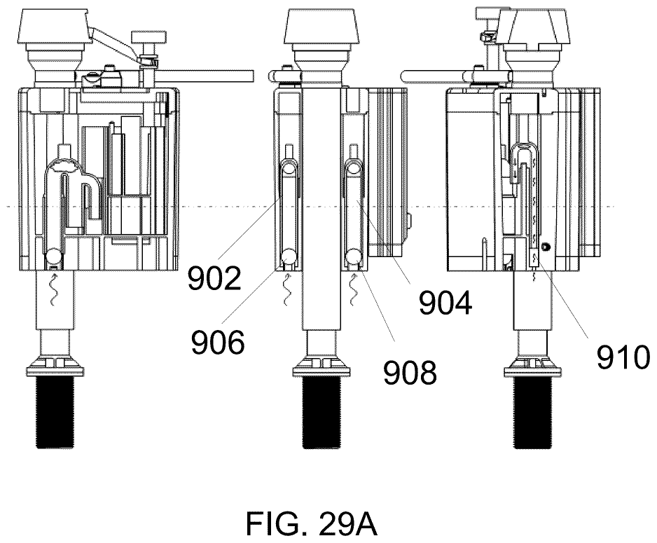

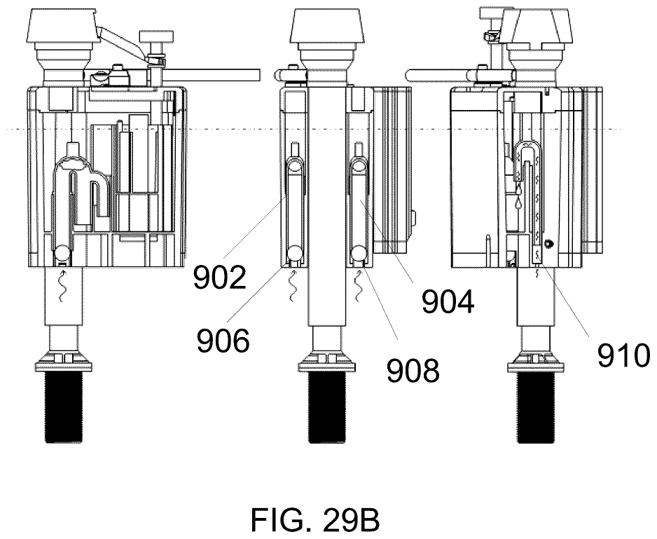

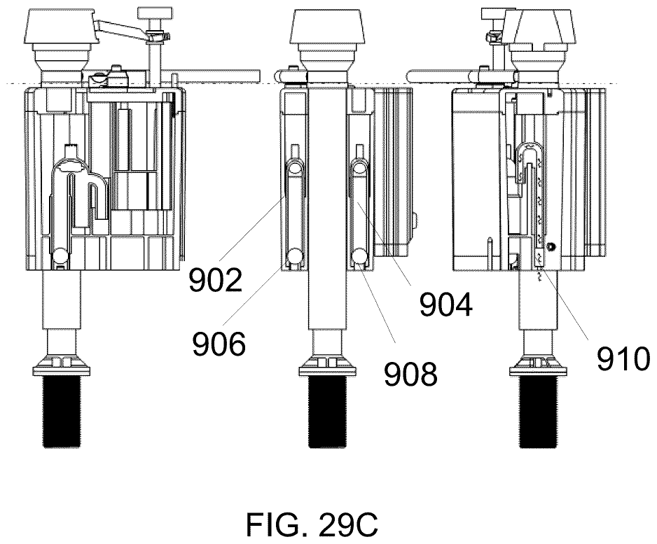

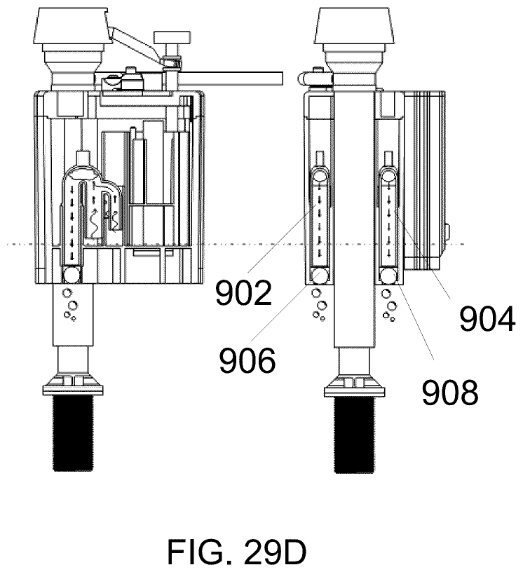

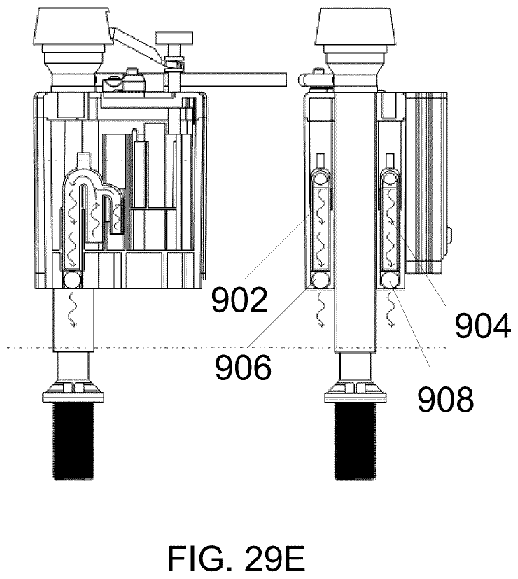

FIGS. 29A-29E illustrate the operational behavior of the device when buoyant (floating) balls 906, 908 are employed instead of weighted or non-floating variants. As shown in FIG. 29A, as the fluid level surrounding the device begins to rise, the floating balls 906, 908 are immediately lifted by buoyant force and move into position to seal or partially obstruct the exit ports located at the base of the large siphon tubes 902, 904. This action occurs prior to the full submersion of the siphon inlets and effectively prevents fluid from entering the siphon tubes during the initial stages of the fluid rise.

As a result, the upper portion or summit of each large siphon 902, 904 remains filled with air, thereby leaving the siphons in an unprimed state and unable to initiate fluid transfer. Under these conditions, if a slow leak occurs in the surrounding tank or reservoir, the unprimed large siphons 902, 904 are incapable of passively removing excess fluid to rebalance the system.

To address this limitation, a smaller siphon tube 910 (referred to as the “little siphon”) and/or an integrated wicking mechanism is employed. These secondary priming components operate independently of the floating balls 906, 908 and are designed to enable a gradual and consistent flow of fluid into their respective tubes or channels. As fluid enters the little siphon 910, it progressively displaces the air trapped at the summit, eventually establishing a continuous fluid column and thereby priming the siphon.

Once the small siphon 910 is successfully primed, it allows for controlled fluid transfer even during conditions of gradual fluid loss. In this manner, the little siphon 910 or wick serves a critical role in enabling the large siphons 902, 904 to eventually activate once sufficient fluid displacement has occurred, restoring proper balance and maintaining system functionality despite the presence of air initially retained due to the early sealing behavior of the floating balls 906, 908.

In FIG. 29B, as the trapped air is gradually expelled from the summit of the small siphon 910—either through gravitational flow or capillary action in the case of a wick-assisted design—the siphon 910 becomes fully primed and begins to permit fluid flow from the surrounding reservoir into the interior of the container. During this phase, the large siphons 902, 904 remain in a blocked state due to the floating balls 906, 908 maintaining their sealed position at the siphon exits. Consequently, fluid is restricted from entering the container through the large siphons 902, 904, ensuring that only the small siphon 910 contributes to the initial fluid transfer and system priming process.

In FIG. 29C, as the fluid level rises to reach the uppermost portion of the device, both the small siphon 910 and/or the wick element become fully immersed and establish fluid communication between the interior of the container and the surrounding fluid reservoir. In this configuration, these components function as passive drainage mechanisms, allowing fluid to slowly transfer from the container back into the surrounding environment. This slow drainage is particularly advantageous in scenarios involving minor or gradual leaks, where the small siphon 910 and/or wick act to relieve pressure and maintain fluid balance within the system without engaging the larger siphon mechanisms 902, 904.

As shown in FIGS. 29D and 29E, upon a rapid evacuation of fluid from the area surrounding the container—such as during a flush cycle—the relatively higher fluid level inside the container generates sufficient hydraulic pressure to overcome the air pocket retained at the summits of the large siphons 902, 904. This pressure differential forces the trapped air out through the siphon exits, thereby initiating fluid flow through the large siphon channels. Once primed, the large siphons 902, 904 effectively transfer fluid from the container to the surrounding environment. In contrast, if there is no substantial drop in the surrounding fluid level, the air pockets within the siphon summits remain intact, preventing the priming process and inhibiting fluid transfer through the large siphons 902, 904.

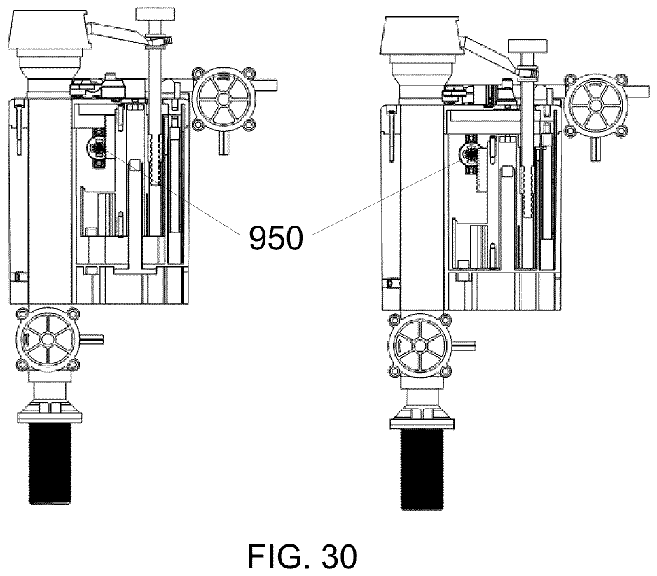

FIG. 30 depicts one embodiment of the device with a rotary damper 950. In one embodiment, the rotary damper 950 is operatively coupled to the float and configured to resist motion in both directions, thereby slowing the float's movement during both ascent and descent. This damping mechanism provides a controlled, gradual response to changes in fluid level, minimizing abrupt shifts that could interfere with the timing or accuracy of the system's operation. The incorporation of slow, controlled float movement is one aspect of the device's functionality, ensuring consistent interaction with associated components such as magnets, sensors, or valves. This controlled behavior enhances system reliability and makes the device a viable solution for applications requiring precise fluid level management and delayed actuation.

The description of elements in each figure may refer to elements of proceeding figures. Like numbers refer to like elements in all figures, including alternate embodiments of like elements.

In one embodiment, a fluid control system comprises a valve configured to regulate fluid flow into a tank. In one embodiment, the system includes a float configured to control actuation of the valve based on a detected fluid level. In one embodiment, an activation lever is adapted to modify the interaction between the valve and the float.

In one embodiment, the activation lever adjusts a magnetic coupling between a first magnet disposed on a housing and a second magnet integrated with the float.

In one embodiment, the system includes a drip feed assembly configured to deliver fluid into a float container. In one embodiment, the delivery rate of fluid into the float container determines the delay before the valve is closed.

In one embodiment, the float container comprises multiple inlet ports located at different vertical positions. In one embodiment, these ports enable sequential filling of separate internal chambers as the external fluid level rises.

In one embodiment, a siphon mechanism is located within the float container. In one embodiment, the siphon is configured to discharge accumulated fluid upon reaching a predefined level, thereby enabling the float to descend and reopen the valve.

In one embodiment, a selectively operable plug is positioned at the siphon's trigger point. In one embodiment, the plug is adapted to enable or disable siphon activation by controlling ingress of air.

In one embodiment, the system includes a sensor configured to detect anomalies in fluid flow. In one embodiment, a processor is operatively connected to the valve and the sensor. In one embodiment, the processor is configured to receive signals from the sensor and initiate valve shutoff in response to a detected anomaly.

In one embodiment, an electronic flow meter is coupled to an output line from the valve. In one embodiment, the flow meter is configured to transmit flow data to the processor.

In one embodiment, the processor is further configured to receive wireless communications from one or more remote sensors. In one embodiment, the processor is configured to actuate an electromagnet to shut off fluid flow upon detecting a leak condition.

In one embodiment, the sensor comprises an external leak detection sensor. In one embodiment, the sensor is configured for wireless communication with the processor to trigger emergency shutoff operations.

In one embodiment, the system includes a detachable sensor housing. In one embodiment, the housing contains electronic components such as the processor, memory, communication interface, and power supply. In one embodiment, the housing is configured to independently manage and control valve operation.

In one embodiment, the system includes a user alert mechanism. In one embodiment, the alert mechanism includes at least one of a visual indicator or an audible signal configured to notify a user of a flow anomaly.

In one embodiment, the processor is further configured to accept wireless input to modify operational parameters. In one embodiment, the processor is configured to initiate system diagnostics based on received signals.

In one embodiment, the float comprises a deployable weight adapted to adjust the float's buoyancy. In one embodiment, deployment of the weight is controlled by the activation lever.

In one embodiment, the activation lever includes a magnet. In one embodiment, the lever is rotatable between an “on” position, wherein the magnet attracts the float, and an “off” position, wherein the float is unaffected by the magnetic field.

In one embodiment, the float further comprises a secondary indicator float. In one embodiment, the secondary float is configured to signal whether shutoff was triggered by a minor leak or a significant fluid loss event.

In one embodiment, the system includes a manual actuator configured to open or close a port located at the bottom of the float container.

In one embodiment, the device includes a reservoir positioned within the container and configured to receive fluid from the container during the discharge cycle.

In one embodiment, the reservoir is fluidically connected to the float chamber and configured to release fluid into the float chamber after the discharge cycle is complete and the fluid level in the container has been restored, and wherein the released fluid creates a buoyant force sufficient to return the float to an upper position to reset the discharge mechanism.

In one embodiment, the float becomes more buoyant as fluid is released from the float chamber.

In one embodiment, a fluid level detection apparatus comprises a removable sensor housing configured to be mounted within or adjacent to a fluid-containing vessel. In one embodiment, the apparatus includes a float positioned within a chamber of the sensor housing and incorporating a magnet. In one embodiment, a magnetic switch is disposed in the housing and operatively coupled to a processor. In one embodiment, movement of the float in response to fluid level changes causes the magnet to interact with the magnetic switch, triggering one or more functions executed by the processor.

In one embodiment, the apparatus includes a wicking element positioned within the float chamber. In one embodiment, the wicking element is configured to gradually transfer fluid into or out of the chamber via capillary action, thereby introducing a time delay in the float's response to external fluid level changes.

In one embodiment, a fluid regulation system comprises a fluid control device including a valve configured to control fluid flow into a tank, a float operatively connected to the valve and responsive to fluid level, and an activation lever configured to modify the float's interaction with the valve. In one embodiment, the system further comprises a fluid level detection apparatus including a removable sensor housing mountable within or adjacent to a fluid container, a float with a magnet disposed within a chamber of the housing, and a magnetic switch positioned in the housing and operatively connected to a processor. In one embodiment, movement of the float in response to fluid level causes the magnet to activate the switch, initiating a function controlled by the processor.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flowchart diagrams and/or schematic block diagrams in the Figures illustrate the architecture, functionality, and operation of possible implementations. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment.

Reference to terms such as “left,” “right,” “top,” “bottom,” “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

This description uses examples to describe embodiments of the disclosure and to enable any person skilled in the art to practice the embodiments, including making and using any devices or systems and performing any incorporated methods. The patentable scope of the disclosure is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A fluid control device, comprising:
a valve configured to control a flow of fluid into a tank;
a float operatively connected to the valve and configured to actuate the valve based on fluid level within a container;
an activation lever configured to alter interaction with the float.

2. The device of claim 1, wherein the activation lever alters magnetic interaction with the float between a first magnet on a housing and a second magnet on the float.

3. The device of claim 1, further comprising a drip feed system configured to deliver fluid into a float container, wherein a rate of delivery affects a timing of valve shutoff.

4. The device of claim 3, wherein the float container includes ports at varying heights to allow staged filling of internal compartments as an external fluid level rises.

5. The device of claim 3, further comprising a siphon system within the float container.

6. The device of claim 5, further comprising a secondary intake to selectively enable or disable siphon operation by controlling air ingress.

7. The device of claim 1, further comprising:
a sensor configured to detect a flow anomaly; and
a processor operatively coupled to the valve and the sensor, the processor configured to receive input from the sensor and transmit a notification in response to the detected flow anomaly.

8. The device of claim 7, further comprising an electronic flow meter configured to monitor fluid flow through an output line coupled to the valve and to transmit flow data to the processor.

9. The device of claim 7, wherein a processor is configured to receive wireless signals from a remote sensor and activate an electromagnet to shut off fluid flow in response to detecting a leak.

10. The device of claim 7, wherein a sensor comprises a leak detection sensor external to the valve that wirelessly communicates with the processor to initiate emergency shutoff.

11. The device of claim 7, further comprising a removable electronic sensor housing comprising electronics, the electronics comprising the processor, memory, network interface, and power supply, wherein the electronics are configured for independent monitoring and control of valve operations.

12. The device of claim 7, further comprising a visual or auditory indicator configured to alert a user of the flow anomaly.

13. The device of claim 7, wherein the processor is configured to receive wireless transmissions that modify system parameters or trigger diagnostic routines.

14. The device of claim 1, wherein the float comprises a weight that modifies buoyancy of the float when released, the release controlled by the activation lever.

15. The device of claim 1, wherein the activation lever comprises a magnet and is rotatable between an “on” position, wherein the magnet attracts the float, and an “off” position, wherein the float is unaffected by the magnet.

16. The device of claim 1, further comprising a secondary indicator float configured to visually indicate a state of the device.

17. The device of claim 1, further comprising a manual lever configured to open or close a port at a bottom of the float container.

18. The device of claim 1, further comprising a reservoir within the container lid for distributing fluid back into the container.

19. The device of claim 18, wherein the float comprises an internal reservoir configured to release fluid to create a buoyant force to return the float to an upper position.

20. The device of claim 19, wherein magnetic force assists in the release of fluid.

21. A fluid level detection apparatus, comprising:
a removable sensor housing configured to be mounted within or adjacent to a fluid-containing vessel;
a float disposed within a chamber in the sensor housing, the float comprising a magnet;
a magnetic switch positioned within the housing and operatively coupled to a processor;
wherein movement of the float in response to fluid level changes causes the float magnet to interact with the magnetic switch, thereby activating or controlling one or more functions of the processor.

22. A system, comprising:
a fluid control device, comprising:
a valve configured to control a flow of fluid into a tank;
a float operatively connected to the valve and configured to actuate the valve based on fluid level within a container;
an activation lever configured to alter interaction with the float; and
a fluid level detection apparatus, comprising:
a removable sensor housing configured to be mounted within or adjacent to a fluid-containing vessel;
a float disposed within a chamber in the sensor housing, the float comprising a magnet;
a magnetic switch positioned within the housing and operatively coupled to a processor;
wherein movement of the float in response to fluid level changes causes the float magnet to interact with the magnetic switch, thereby activating or controlling one or more functions of the processor.
